(19) United States
(12) Patent Application Publication
(10) Pub. No.: US 2026/0204923 A1
(43) Pub. Date: Jul. 16, 2026

(54) SYSTEMS, DEVICES, AND METHODS FOR BALANCING MULTIPLE ENERGY SOURCES

(71) Applicant: TAE Technologies, Inc., Foothill Ranch, CA (US)

(72) Inventors: Edwin Fonkwe FONGANG, Moreno Valley, CA (US); Roozbeh NADERI, Foothill Ranch, CA (US); Ishita RAY, Foothill Ranch, CA (US); Mohammad MOUSAVI, Foothill Ranch, CA (US); Mikhail SLEPCHENKOV, Foothill Ranch, CA (US)

(21) Appl. No.: 19/136,475

(22) PCT Filed: Dec. 6, 2023
(86) PCT No.: PCT/US2023/082747

§ 371 Date: Jun. 6, 2025

Related U.S. Application Data
(60) Provisional application No. 63/430,983, filed on Dec. 7, 2022.

(51) Int. Cl. H02J 3/46; B60L 58/22; H01M 10/42; H01M 50/249; H02J 3/32

(52) U.S. Cl. CPC H02J 3/46; B60L 58/22; H01M 10/425; H01M 50/249; H02J 3/32; H01M 2010/4271; H01M 2220/20

(57) ABSTRACT

Systems, devices, and methods for controlling source current in systems having two or more energy sources. The source current can be controlled in a manner that seeks balance in one or more operating parameters of the sources while meeting load demand. Examples of operating parameters can include charge, temperature, voltage, state of health, current, and others. Example embodiments are described that control, for each module, respective tunable balance factors for operating parameters of the one or more energy sources of the module such that each operating parameter of each energy source converges towards a balanced target value for the operating parameter, and control, for each module, energy outputs of each of the one or more energy sources based on the respective tunable balance factors for the module.

### CROSS-REFERENCE TO RELATED APPLICATIONS

This patent application claims the benefit of U.S. Provisional Application No. 63/430,983, filed Dec. 7, 2022, which is incorporated by reference herein in its entirety and for all purposes.

### FIELD

The subject matter described herein relates generally to systems, devices, and methods for control of multiple energy sources, particularly current control to achieve and maintain balanced operating characteristics of the energy sources.

### BACKGROUND

Energy storage systems are becoming more prevalent due to the growing popularity of electric vehicles, the desire to buffer energy from renewable energy generation sources, and the integration of storage systems in residential, commercial, and industrial environments. These energy storage systems are typically a serial connection of identical storage elements, such as battery cells of the same electrochemistry and nominal voltage, that permit the system to store large amounts of energy for long periods of time. For discharging, electrical current output from the system as a whole can be routed through a single transformer, inverter, or other conversion device to produce the desired DC or AC output voltage. For example, in conventional electric vehicles the total DC voltage generated by the serially-connected cells within the battery pack is rapidly switched between two extremes, the positive DC voltage and the negative DC voltage, to generate the sinusoidal AC waveform that drives the motor.

While battery cells of identical type and voltage are used, these cells are not truly identical as variations in the manufacturing process introduce small variations in chemistry and structure. As the system is repeatedly discharged and charged, these variations are magnified and give rise to differing degrees of degradation of capacity and performance in each cell. This degradation imbalance is exacerbated as the cells or subjected to different thermal conditions due to cell-to-cell variations in ohmic resistance and placement within the overall system. While intricate cooling systems can be provided to mitigate thermal variation across cells, such cooling systems are complex and expensive and fail to wholly compensate for the degradation imbalance. Often the system is limited in performance to that of the weakest cell, and severe degradation imbalance rapidly ages the system, requiring premature replacement of the degraded cells or even the system as a whole.

As such, much effort is invested in tightening manufacturing tolerances for battery cells to limit variation. However, the use of identical cells limits performance of the system in another respect. Battery cells of various electrochemistries have different advantages and disadvantages. A cell of a first electrochemical type might have an energy density that is relatively higher than a cell of a second electrochemical type, but a power density that is relatively lower than the cell of the second electrochemical type. Use of cells of only one electrochemical type therefore limits performance of the overall system in those respects inherent to the cell type.

For these and other reasons, needs exist for systems, devices, and methods capable of operating multiple energy sources in a balanced fashion.

### SUMMARY

Example embodiments of systems, devices, and methods are described for controlling current in systems having two or more energy sources. The source current can be controlled in a manner that seeks balance in one or more operating parameters of the sources while meeting load demand. Examples of balanceable operating parameters can include charge, temperature, voltage, state of health, state of energy, state of power, current, and others. Example embodiments are described that utilize a balance factor for each operating parameter being balanced, where the balance factor can vary with the magnitude of the operating parameter being balanced, and/or based on tunable adjustment parameters. The tunable adjustment parameters can be used to adjust balance factors for respective operating parameters, e.g., to adjust a rate of balancing of the operating parameters based on, for example, a relative importance of balancing each operating parameter with respect to each other operating parameter.

The tunable adjustment parameters can include amplification modifiers to adjust normalized distributions of the operating parameters and/or priority modifiers to adjust a relative importance of balancing each operating parameter with respect to each other operating parameter. Tunable balance factors can be utilized to increase a rate of balancing of operating parameters to more quickly align the operating parameters of multiple sources of a system. Tunable balance factors can be utilized to adjust relative importance of different operating parameters, thereby prioritizing balancing of operating parameters that have higher impact on performance of sources or a system that includes the sources or prioritizing balancing operating parameters that are more relevant to meeting load demand.

The rate of balancing can be adjusted based on the operating state, or data indicative of the operating state, of an electric vehicle motor or other load being powered by the modules. For example, if an electric vehicle motor is operating at a high level, e.g., a high speed and/or high torque), the modules may be outputting a high current level, leaving little or no leeway to increase the current of a module for balancing purposes. In this example, the rate of balancing can be reduced to avoid unstable operation of the modules. If the electric vehicle motor is operating at a lower level, there may be more leeway to increase the current output by modules for balancing purposes. Feedback signals from a motor controller, e.g., signals that represent motor speed and/or torque, can be used to adjust the rate of balancing to account for the different operating states of a motor.

A reference current can be determined that is selected to satisfy the load demand while at the same time taking into account present offset values of the balanced operating parameters between the sources. The sources can be the same or different, and different characteristics of the sources can be utilized in the current control design. For example, embodiments are described that detect a transient condition and the load and because relatively more current to be provided from a source having a relatively higher power density in order to meet the transient demand. The embodiments applied to the system while in either a discharge or a charge state.

Other systems, devices, methods, features, and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIGS. 1A-1C are block diagrams depicting example embodiments of a modular energy system.

FIGS. 1D-1E are block diagrams depicting example embodiments of control devices for an energy system.

FIGS. 1F-1G are block diagrams depicting example embodiments of modular energy systems coupled with a load and a charge source.

FIGS. 2A-2B are block diagrams depicting example embodiments of a module and control system within an energy system.

FIG. 2C is a block diagram depicting an example embodiment of a physical configuration of a module.

FIG. 2D is a block diagram depicting an example embodiment of a physical configuration of a modular energy system.

FIGS. 3A-3C are block diagrams depicting example embodiments of modules having various electrical configurations.

FIGS. 4A-4F are schematic views depicting example embodiments of energy sources.

FIGS. 5A-5C are schematic views depicting example embodiments of energy buffers.

FIGS. 6A-6C are schematic views depicting example embodiments of converters.

FIGS. 7A-7E are block diagrams depicting example embodiments of modular energy systems having various topologies.

FIG. 8A is a plot depicting an example output voltage of a module.

FIG. 8B is a plot depicting an example multilevel output voltage of an array of modules.

FIG. 8C is a plot depicting an example reference signal and carrier signals usable in a pulse width modulation control technique.

FIG. 8D is a plot depicting example reference signals and carrier signals usable in a pulse width modulation control technique.

FIG. 8E is a plot depicting example switch signals generated according to a pulse width modulation control technique.

FIG. 8F as a plot depicting an example multilevel output voltage generated by superposition of output voltages from an array of modules under a pulse width modulation control technique.

FIGS. 9A-9B are block diagrams depicting example embodiments of controllers for a modular energy system.

FIG. 10A is a block diagram depicting an example embodiment of a multiphase modular energy system having interconnection module.

FIG. 10B is a schematic diagram depicting an example embodiment of an interconnection module in the multiphase embodiment of FIG. 10A.

FIG. 10C is a block diagram depicting an example embodiment of a modular energy system having two subsystems connected together by interconnection modules.

FIG. 10D is a block diagram depicting an example embodiment of a three-phase modular energy system having interconnection modules supplying auxiliary loads.

FIG. 10E is a schematic view depicting an example embodiment of the interconnection modules in the multiphase embodiment of FIG. 10D.

FIG. 10F is a block diagram depicting another example embodiment of a three-phase modular energy system having interconnection modules supplying auxiliary loads.

FIG. 11A is an illustration depicting an example route of an electric rail-based vehicle.

FIG. 11B is a block diagram depicting an example embodiment of an electrical layout of a modular energy system for an electric rail-based vehicle.

FIG. 11C is a side diagram depicting an example embodiment of an electrical layout of a modular energy system for an electric rail-based vehicle.

FIG. 11D is a block diagram depicting another example embodiment of an electrical layout of a modular energy system for an electric rail-based vehicle.

FIG. 11E is a side diagram depicting another example embodiment of an electrical layout of a modular energy system for an electric rail-based vehicle.

FIG. 11F is a block diagram depicting another example embodiment of an electrical layout of a modular energy system for an electric rail-based vehicle.

FIGS. 12A-12B are block diagrams depicting example embodiments of modules for use in a modular energy system.

FIGS. 13A-13C are schematic diagrams depicting example embodiments of modules for use in a modular energy system.

FIGS. 14A-14B are block diagrams depicting example embodiments of modular energy system topologies.

FIGS. 14C-14D are schematic diagrams depicting example embodiments of interconnection modules for use in a modular energy system.

FIG. 15 is a block diagram depicting an example embodiment of a modular energy system topology.

FIG. 16 is a schematic diagram depicting another example embodiment of an interconnection module.

FIGS. 17A-17C are block diagrams depicting example embodiments of source and current regulation circuitry configurations.

FIG. 18 is a schematic view depicting an example embodiment of a portion of a two source module.

FIGS. 19A-19B are block diagrams depicting example embodiments of a power management controller.

FIG. 20A is a schematic diagram depicting an example embodiment of a portion of a module carrying current to and from an energy source.

FIG. 20B is a schematic diagram depicting a time averaged of the circuit of FIG. 20A.

FIGS. 21A-21B are graphs depicting examples of linear and nonlinear relationships, respectively, between balance factors and SOC values.

FIGS. 22-27 are flow diagrams depicting example embodiments of methods related to current control.

FIGS. 28A-28D are graphs depicting example simulation results for an electric tram where SOC and temperature balancing are applied during current control.

FIGS. 29-31 are graphs depicting example results where tunable balancing methods are applied to a system.

FIGS. 32-33 are flow diagrams depicting example methods related to controlling outputs of modules.

FIG. 34 is a flow diagram depicting example methods related to controlling outputs of modules.

FIG. 35 is a flow diagram of an example method for determining an amplification modifier.

FIG. 36 is an example of a data flow between components of a system for determining balance factors.

### DETAILED DESCRIPTION

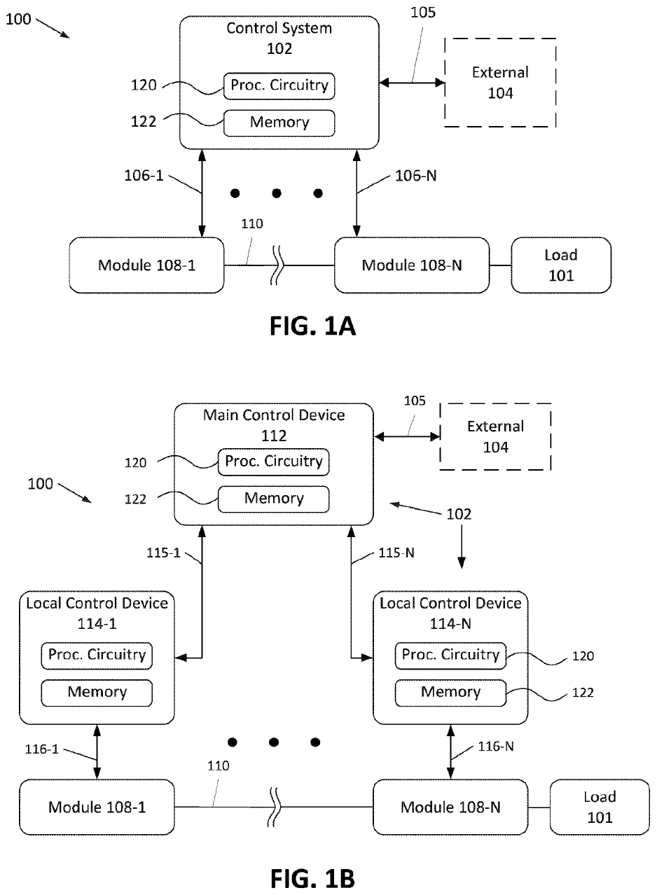

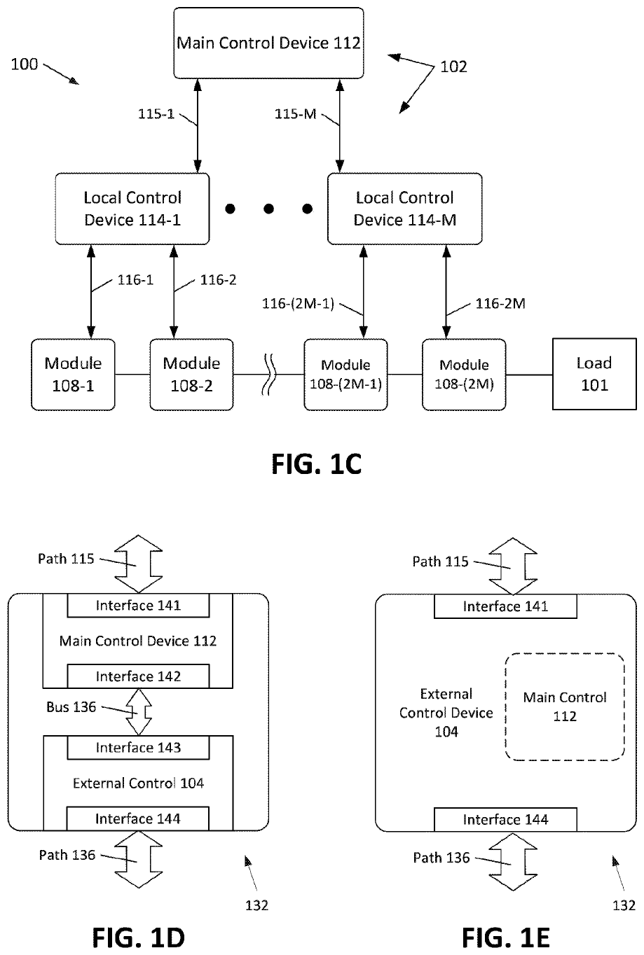

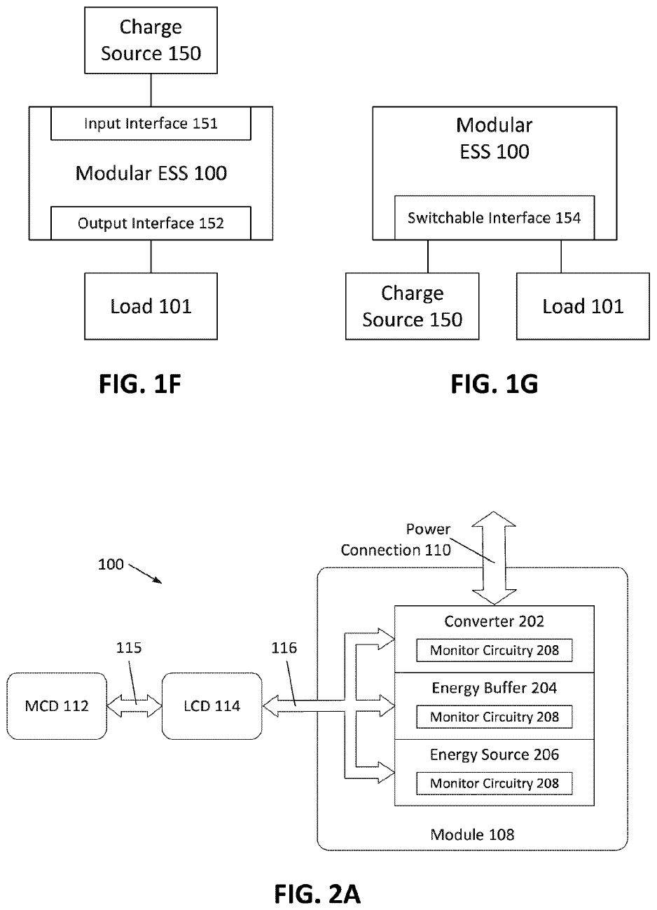

Before describing the example embodiments pertaining to energy source control, it is first useful to describe these underlying systems in greater detail. With reference to FIGS. 1A through 10F, the following sections describe various applications in which embodiments of the modular energy systems can be implemented, embodiments of control systems or devices for the modular energy systems, configurations of the modular energy system embodiments with respect to charging sources and loads, embodiments of individual modules, embodiments of topologies for arrangement of the modules within the systems, embodiments of control methodologies, embodiments of balancing operating characteristics of modules within the systems, and embodiments of the use of interconnection modules.

### Examples of Applications

Stationary applications are those in which the modular energy system is located in a fixed location during use, although it may be capable of being transported to alternative locations when not in use. The module-based energy system resides in a static location while providing electrical energy for consumption by one or more other entities, or storing or buffering energy for later consumption. Examples of stationary applications in which the embodiments disclosed herein can be used include, but are not limited to: energy systems for use by or within one or more residential structures or locales, energy systems for use by or within one or more industrial structures or locales, energy systems for use by or within one or more commercial structures or locales, energy systems for use by or within one or more governmental structures or locales including both military and non-military uses, energy systems for charging the mobile applications described below, e.g., a charge source or a charging station, and systems that convert solar power, wind, geothermal energy, fossil fuels, or nuclear reactions into electricity for storage. Stationary applications often supply loads such as grids and microgrids, motors, and data centers. A stationary energy system can be used in either a storage or non-storage role.

Mobile applications, sometimes referred to as traction applications, are generally ones where a module-based energy system is located on or within an entity, and stores and provides electrical energy for conversion into motive force by a motor to move or assist in moving that entity. Examples of mobile entities with which the embodiments disclosed herein can be used include, but are not limited to, electric and/or hybrid entities that move over or under land, over or under sea, above and out of contact with land or sea (e.g., flying or hovering in the air), or through outer space. Examples of mobile entities with which the embodiments disclosed herein can be used include, but are not limited to, vehicles, trains, trams, ships (both surface ships and submarines) vessels, aircraft, and spacecraft. Examples of mobile vehicles with which the embodiments disclosed herein can be used include, but are not limited to, those having only one wheel or track, those having only two-wheels or tracks, those having only three wheels or tracks, those having only four wheels or tracks, and those having five or more wheels or tracks. Examples of mobile entities with which the embodiments disclosed herein can be used include, but are not limited to, a car, a bus, a truck, a motorcycle, a scooter, an industrial vehicle, a mining vehicle, construction and utility vehicles, a flying vehicle (e.g., a plane, a helicopter, a drone, etc.), a maritime vessel (e.g., commercial shipping vessels, ships, yachts, boats, container ships, ferries, barges, or other watercraft), a submarine, a locomotive or rail-based vehicle (e.g., a train, a tram, etc.), a military vehicles (including land, sea and air craft), a spacecraft, and a satellite.

In some mobile applications for mobile entities, the systems herein can provide power for a single engine that provides power to one or multiple wheels or tracks of land based vehicles, or one or multiple propellers on surface ships and submarines, or one or multiple propellers or rotors on aircraft. In some mobile applications for mobile entities, the systems herein can provide power for multiple engines, where each engine of the multiple engines provides power to one or more individual tracks or wheels of a multi-tracked or multi-wheeled land based vehicle, one or more individual propellers on a multi-propeller surface ship or multi-propeller submarine, and one or more individual propellers or individual rotors on a multi-propeller or multi-rotor aircraft. The systems herein can provide power for other types of land, sea and air propulsions systems not listed above.

In some mobile applications for mobile entities, the systems herein can provide power for auxiliary systems in land based vehicles, surface ships and submarines, and aircraft. The power can, in some embodiments, be provided in addition to the power provided to the propulsion systems as described above. The auxiliary systems

The mobile applications described above include mobile applications for private mobile entities, commercial mobile entities, and military/government mobile entities. Examples of private mobile entities include personal conveyances, pleasure crafts, campers, planes, helicopters, utility vehicles, and other privately owned mobile entities. Examples of commercial mobile entities include vehicles for hire, fleet assets (including land, sea and air capable mobile entities), and other commercial mobile entities. Such commercial mobile entities may be used for passenger conveyance, cargo conveyance, passenger and cargo conveyance, construction, mining, etc. Examples of construction and mining vehicles include dump trucks, excavators, cranes, graders, forklifts, bulldozers, loaders, backhoes, compactors, mixers (e.g., concrete), tractors, haul trucks, mining transport trucks, and the like. Examples of military or government mobile entities government agency fleet assets (including land, sea and air mobile entities of all classes), military fleet assets (including land, sea and air mobile entities of all classes), and other government/military mobile entities. Such government/military mobile entities may be used for passenger conveyance, cargo conveyance, passenger and cargo conveyance, construction, first response activities, law enforcement activities, military activities, etc.

In describing embodiments herein, reference may be made to a particular stationary application, e.g., grid, micro-grid, data centers, cloud computing environments, or mobile application, e.g., an electric car. Such references are made for ease of explanation and do not mean that a particular embodiment is limited for use to only that particular mobile or stationary application. Embodiments of systems providing power to a motor can be used in both mobile and stationary applications. While certain configurations may be more suitable to some applications over others, all example embodiments disclosed herein are capable of use in both mobile and stationary applications unless otherwise noted.

### Module-Based Energy System Examples

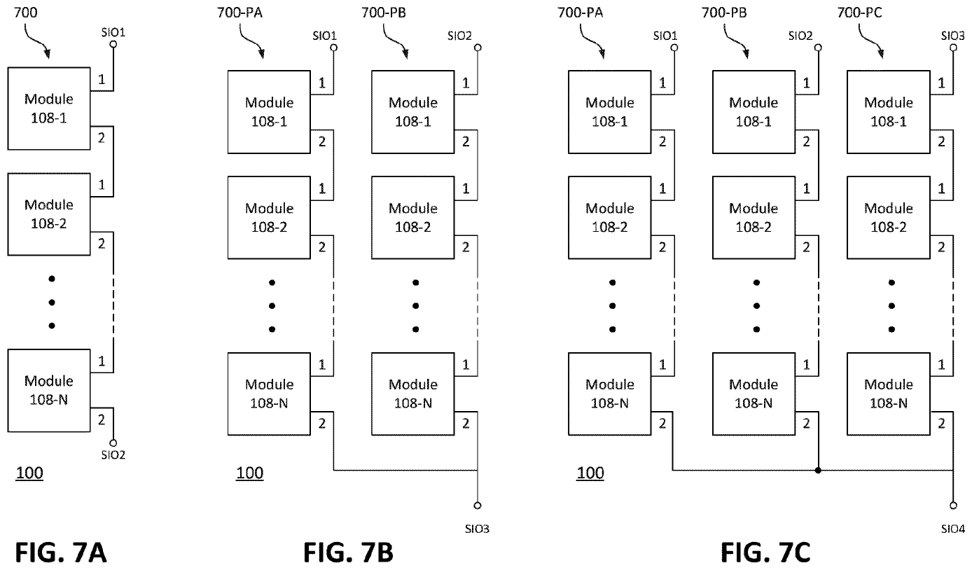

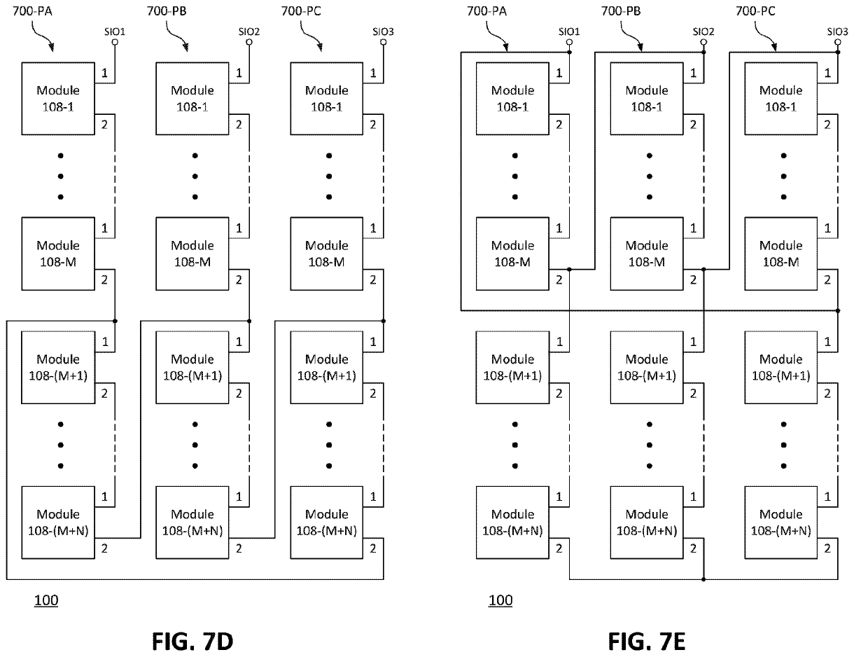

FIG. 1A is a block diagram depicts an example embodiment of a module-based energy system 100. Here, system 100 includes control system 102 communicatively coupled with N converter-source modules 108-1 through 108-N, over communication paths or links 106-1 through 106-N, respectively. Modules 108 are configured to store energy and output the energy as needed to a load 101, or other modules 108. In these embodiments, any number of two or more modules 108 can be used, e.g., N is greater than or equal to two. Modules 108 can be connected to each other in a variety of manners as will be described in more detail with reference to FIGS. 7A-7E. For ease of illustration, in FIGS. 1A-1C, modules 108 are shown connected in series, or as a one-dimensional array, where the Nth module is coupled to load 101.

System 100 is configured to supply power to load 101. Load 101 can be any type of load such as a motor or a grid. System 100 is also configured to store power received from a charge source. FIG. 1F is a block diagram depicting an example embodiment of system 100 with a power input interface 151 for receiving power from a charge source 150 and a power output interface for outputting power to load 101, e.g., to an electric vehicle motor coupled to system 100. In this embodiment system 100 can receive and store power over interface 151 at the same time as outputting power over interface 152. FIG. 1G is a block diagram depicting another example embodiment of system 100 with a switchable interface 154. In this embodiment, system 100 can select, or be instructed to select, between receiving power from charge source 150 and outputting power to load 101. System 100 can be configured to supply multiple loads 101, including both primary and auxiliary loads, and/or receive power from multiple charge sources 150, e.g., a utility-operated power grid and a local renewable energy source, e.g., solar.

FIG. 1B depicts another example embodiment of system 100. Here, control system 102 is implemented as a main control device (MCD) 112 communicatively coupled with N different local control devices (LCDs) 114-1 through 114-N over communication paths or links 115-1 through 115-N, respectively. Each LCD 114-1 through 114-N is communicatively coupled with one module 108-1 through 108-N over communication paths or links 116-1 through 116-N, respectively, such that there is a 1:1 relationship between LCDs 114 and modules 108.

FIG. 1C depicts another example embodiment of system 100. Here, MCD 112 is communicatively coupled with M different LCDs 114-1 to 114-M over communication paths or links 115-1 to 115-M, respectively. Each LCD 114 can be coupled with and control two or more modules 108. In the example shown here, each LCD 114 is communicatively coupled with two modules 108, such that M LCDs 114-1 to 114-M are coupled with 2M modules 108-1 through 108-2M over communication paths or links 116-1 to 116-2M, respectively.

Control system 102 can be configured as a single device, e.g., FIG. 1A, for the entire system 100 or can be distributed across or implemented as multiple devices, e.g., FIGS. 1B-1C. In some implementations, control subsystem can be distributed between LCDs 114 associated with the modules 108, such that no MCD 112 is necessary and can be omitted from system 100.

Control system 102 can be configured to execute control using software (instructions stored in memory that are executable by processing circuitry), hardware, or a combination thereof. The one or more devices of control system 102 can each include processing circuitry 120 and memory 122 as shown here. Example implementations of processing circuitry and memory are described further below.

Control system 102 can have a communicative interface for communicating with devices 104 external to system 100 over a communication link or path 105. For example, control system 102, e.g., MCD 112, can output data or information about system 100 to another control device 104, e.g., the Electronic Control Unit (ECU) or Motor Control Unit (MCU) of a vehicle in a mobile application, grid controller in a stationary application, etc. MCD 112 can also receive data or information, e.g., reference signals and/or status information, over communication link or path 105. For example, MCD 112 can receive, from external control device 104, a reference voltage that represents a setpoint voltage for a motor controlled by external control device 104, a speed value that represents a speed of the motor, a torque value that represents a torque of the motor, and/or other status information.

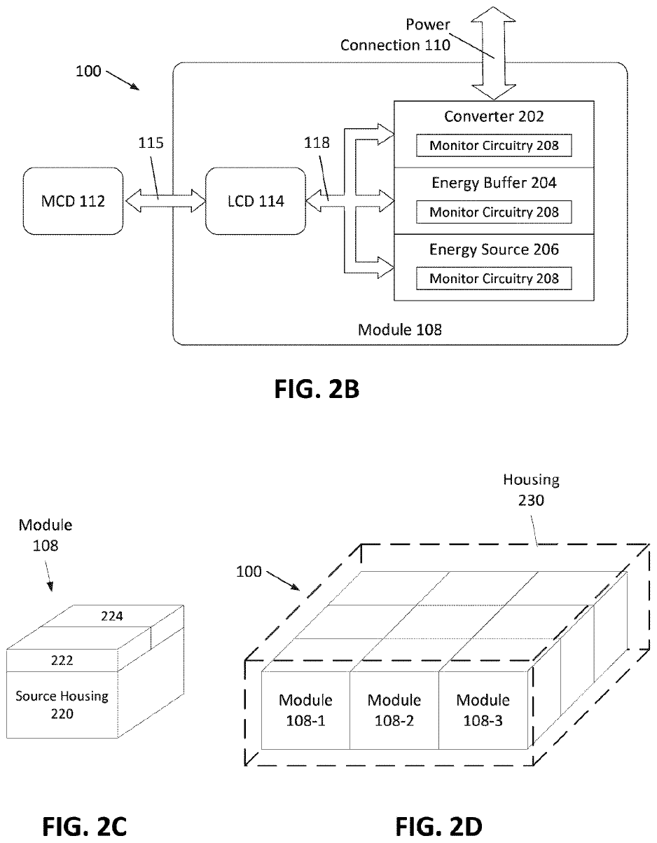

Communication paths or links 105, 106, 115, 116, and 118 (FIG. 2B) can each be wired, e.g., electrical, optical, or wireless communication paths that communicate data or information bidirectionally, in parallel or series fashion. Data can be communicated in a standardized, e.g., IEEE, ANSI, or custom, e.g., proprietary, format. In automotive applications, communication paths 115 can be configured to communicate according to FlexRay or CAN protocols. Communication paths 106, 115, 116, and 118 can also provide wired power to directly supply the operating power for subsystem 102 from one or more modules 108. For example, the operating power for each LCD 114 can be supplied only by the one or more modules 108 to which that LCD 114 is connected and the operating power for MCD 112 can be supplied indirectly from one or more of modules 108, e.g., such as through a car's power network.

Control system 102 is configured to control one or more modules 108 based on status information received from the same or different one or more of modules 108. Control can also be based on one or more other factors, such as requirements of load 101. The requirements of a load 101 can be represented by a reference voltage, e.g., an amplitude value or a voltage waveform. Controllable aspects include, but are not limited to, one or more of voltage, current, phase, and/or output power of each module 108.

Status information of every module 108 in system 100 can be communicated to control system 102, from which subsystem 102 can independently control every module 108-1 . . . 108-N. Other variations are possible. For example, a particular module 108 (or subset of modules 108) can be controlled based on status information of that particular module 108 (or subset), based on status information of a different module 108 that is not that particular module 108 (or subset), based on status information of all modules 108 other than that particular module 108 (or subset based on status information of that particular module 108 (or subset) and status information of at least one other module 108 that is not that particular module 108 (or subset), or based on status information of all modules 108 in system 100.

The status information can be information about one or more aspects, characteristics, or parameters of each module 108. Types of status information include, but are not limited to, the following aspects of a module 108 or one or more components thereof, e.g., energy source, energy buffer, converter, monitor circuitry): State of Charge (SOC), e.g., the level of available charge of an energy source relative to its capacity, such as a fraction or percent, of the one or more energy sources of the module, State of Health (SOH), e.g., a figure of merit of the physical condition, such as age, of an energy source compared to its ideal conditions, of the one or more energy sources of the module, temperature of the one or more energy sources or other components of the module, capacity of the one or more energy sources of the module, voltage of the one or more energy sources and/or other components of the module, current of the one or more energy sources and/or other components of the module, State of Power (SOP), e.g., the available power limitation of the energy source during discharge and/or charge), State of Energy (SOE), e.g., the present level of available energy of an energy source relative to the maximum available energy of the source), and/or the presence of absence of a fault in any one or more of the components of the module.

LCDs 114 can be configured to receive the status information from each module 108, or determine the status information from monitored signals or data received from or within each module 108, and communicate that information to MCD 112. In some implementations, each LCD 114 can communicate raw collected data to MCD 112, which then algorithmically determines the status information on the basis of that raw data. MCD 112 can then use the status information of modules 108 to make control determinations accordingly. The determinations may take the form of instructions, commands, or other information, e.g., a modulation index described herein, that can be utilized by LCDs 114 to either maintain or adjust the operation of each module 108.

For example, MCD 112 may receive status information and assess that information to determine a difference between at least one module 108, e.g., a component thereof, and at least one or more other modules 108, e.g., comparable components thereof. For example, MDC 112 may determine that a particular module 108 is operating with one of the following conditions as compared to one or more other modules 108: with a relatively lower or higher SOC, with a relatively lower or higher SOH, with a relatively lower or higher capacity, with a relatively lower or higher voltage, with a relatively lower or higher current, with a relatively lower or higher temperature, or with or without a fault. In such examples, MCD 112 can output control information that causes the relevant aspect, e.g., output voltage, current, power, temperature, of that particular module 108 to be reduced or increased, depending on the condition. In this manner, the utilization of an outlier module 108, e.g., operating with a relatively lower SOC or higher temperature), can be reduced so as to cause the relevant parameter of that module 108, e.g., SOC or temperature, to converge towards that of one or more other modules 108.

The determination of whether to adjust the operation of a particular module 108 can be made by comparison of the status information to predetermined thresholds, limits, or conditions, and not necessarily by comparison to statuses of other modules 108. The predetermined thresholds, limits, or conditions can be static thresholds, limits, or conditions, such as those set by the manufacturer that do not change during use. The predetermined thresholds, limits, or conditions can be dynamic thresholds, limits, or conditions, that are permitted to change, or that do change, during use. For example, MCD 112 can adjust the operation of a module 108 if the status information for that module 108 indicates it to be operating in violation, e.g., above or below, of a predetermined threshold or limit, or outside of a predetermined range of acceptable operating conditions. Similarly, MCD 112 can adjust the operation of a module 108 if the status information for that module 108 indicates the presence of an actual or potential fault, e.g., an alarm, or warning, or indicates the absence or removal of an actual or potential fault. Examples of a fault include, but are not limited to, an actual failure of a component, a potential failure of a component, a short circuit or other excessive current condition, an open circuit, an excessive voltage condition, a failure to receive a communication, the receipt of corrupted data, and the like. Depending on the type and severity of the fault, the faulty module's utilization can be decreased to avoid damaging the module, or the module's utilization can be ceased altogether.

MCD 112 can control modules 108 within system 100 to achieve or converge towards a desired target. The target can be, for example, operation of all modules 108 at the same or similar levels with respect to each other, or within predetermined thresholds limits, or conditions. This process is also referred to as balancing or seeking to achieve balance in the operation or operating characteristics of modules 108. The term “balance” as used herein does not require absolute equality between modules 108 or components thereof, but rather is used in a broad sense to convey that operation of system 100 can be used to actively reduce disparities in operation (or operative state) between modules 108 that would otherwise exist.

MCD 112 can communicate control information to LCD 114 for the purpose of controlling the modules 108 associated with the LCD 114. The control information can be, e.g., a modulation index and a reference signal as described herein, a modulated reference signal, or otherwise. Each LCD 114 can use, e.g., receive and process, the control information to generate switch signals that control operation of one or more components, e.g., a converter, within the associated module(s) 108. In some implementations, MCD 112 generates the switch signals directly and outputs them to LCD 114, which relays the switch signals to the intended module component.

All or a portion of control system 102 can be combined with a system external control device 104 that controls one or more other aspects of the mobile or stationary application. When integrated in this shared or common control device (or subsystem), control of system 100 can be implemented in any desired fashion, such as one or more software applications executed by processing circuitry of the shared device, with hardware of the shared device, or a combination thereof. Non-exhaustive examples of external control devices 104 include: a vehicular ECU or MCU having control capability for one or more other vehicular functions, e.g., motor control, driver interface control, traction control, etc.); a grid or micro-grid controller having responsibility for one or more other power management functions, e.g., load interfacing, load power requirement forecasting, transmission and switching, interface with charge sources, e.g., diesel, solar, wind), charge source power forecasting, back up source monitoring, asset dispatch, etc.); and a data center control subsystem, e.g., environmental control, network control, backup control, etc.,

FIGS. 1D and 1E are block diagrams depicting example embodiments of a shared or common control device or system 132 in which control system 102 can be implemented. In FIG. 1D, common control device 132 includes main control device 112 and external control device 104. Main control device 112 includes an interface 141 for communication with LCDs 114 over path 115, as well as an interface 142 for communication with external control device 104 over internal communication bus 136. External control device 104 includes an interface 143 for communication with main control device 112 over bus 136, and an interface 144 for communication with other entities, e.g., components of the vehicle or grid, of the overall application over communication path 136. In some implementations, common control device 132 can be integrated as a common housing or package with devices 112 and 104 implemented as discrete integrated circuit (IC) chips or packages contained therein.

In FIG. 1E, external control device 104 acts as common control device 132, with the main control functionality implemented as a component within device 104. This component 112 can be or include software or other program instructions stored and/or hardcoded within memory of device 104 and executed by processing circuitry thereof. The component can also contain dedicated hardware. The component can be a self-contained module or core, with one or more internal hardware and/or software interfaces, e.g., application program interface (API)) for communication with the operating software of external control device 104. External control device 104 can manage communication with LCDs 114 over interface 141 and other devices over interface 144. In various embodiments, device 104/132 can be integrated as a single IC chip, can be integrated into multiple IC chips in a single package, or integrated as multiple semiconductor packages within a common housing.

In the embodiments of FIGS. 1D and 1E, the main control functionality of subsystem 102 is shared in common device 132, however, other divisions of shared control or permitted. For example, part of the main control functionality can be distributed between common device 132 and a dedicated MCD 112. In another example, both the main control functionality and at least part of the local control functionality can be implemented in common device 132, e.g., with remaining local control functionality implemented in LCDs 114. In some implementations, all of control system 102 is implemented in common device or subsystem 132. In some implementations, local control functionality is implemented within a device shared with another component of each module 108, such as a Battery Management System (BMS).

Modules within Cascaded Energy System Examples

Module 108 can include one or more energy sources and a power electronics converter and, if desired, an energy buffer. FIGS. 2A-2B are block diagrams depicting additional example embodiments of system 100 with module 108 having a power converter 202, an energy buffer 204, and an energy source 206. Converter 202 can be a voltage converter or a current converter. The embodiments are described herein with reference to voltage converters, although the embodiments are not limited to such. Converter 202 can be configured to convert a direct current (DC) signal from energy source 204 into an alternating current (AC) signal and output it over power connection 110, e.g., an inverter. Converter 202 can also receive an AC or DC signal over connection 110 and apply it to energy source 204 with either polarity in a continuous or pulsed form. Converter 202 can be or include an arrangement of switches, e.g., power transistors, such as a half bridge of full bridge (H-bridge). In some implementations converter 202 includes only switches and the converter, and the module as a whole, does not include a transformer.

Converter 202 can be also or alternatively be configured to perform AC to DC conversion, e.g., a rectifier, such as to charge a DC energy source from an AC source, DC to DC conversion, and/or AC to AC conversion, e.g., in combination with an AC-DC converter. In some implementations, such as to perform AC-AC conversion, converter 202 can include a transformer, either alone or in combination with one or more power semiconductors, e.g., switches, diodes, thyristors, and the like. In other embodiments, such as those where weight and cost is a significant factor, converter 202 can be configured to perform the conversions with only power switches, power diodes, or other semiconductor devices and without a transformer.

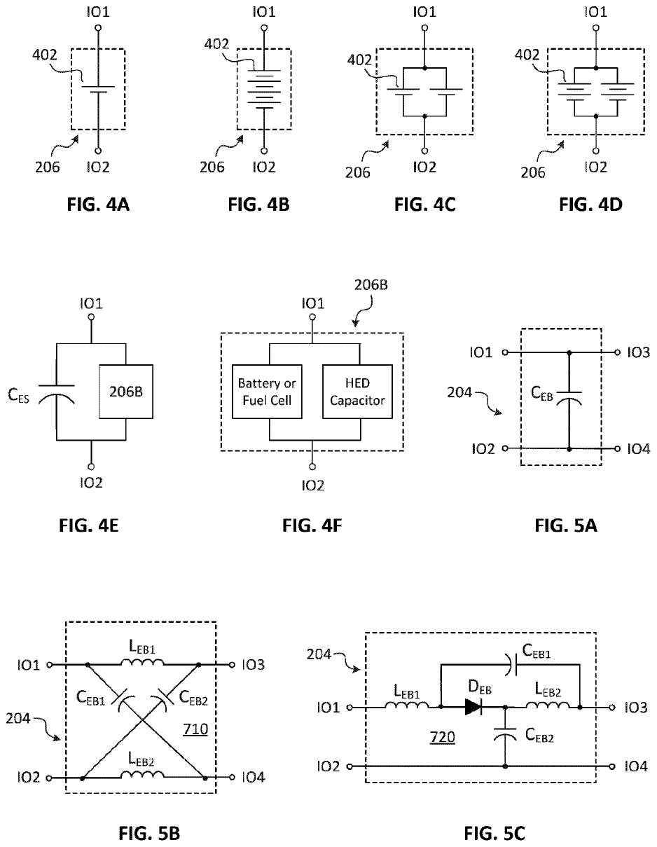

Energy source 206 is preferably a robust energy storage device capable of outputting direct current and having an energy density suitable for energy storage applications for electrically powered devices. Energy source 206 can be an electrochemical battery, such as a single battery cell or multiple battery cells connected together in a battery module or array, or any combination thereof. FIGS. 4A-4D are schematic diagrams depicting example embodiments of energy source 206 configured as a single battery cell 402 (FIG. 4A), a battery module with a series connection of four cells 402 (FIG. 4B), a battery module with a parallel connection of single cells 402 (FIG. 4C), and a battery module with a parallel connection with legs having two cells 402 each (FIG. 4D). A non-exhaustive list of examples of battery types suitable for use with the present subject matter include solid state batteries, liquid electrotype-based batteries, liquid phase batteries as well as flow batteries such as lithium (Li) metal batteries, Li ion batteries, Li air batteries, sodium ion batteries, potassium ion batteries, magnesium ion batteries, alkaline batteries, nickel metal hydride batteries, nickel sulfate batteries, lead acid batteries, zinc-air batteries, and others. Some examples of Li ion battery types include Li cobalt oxide (LCO), Li manganese oxide (LMO), Li nickel manganese cobalt oxide (NMC), Li iron phosphate (LFP), Li nickel cobalt aluminum oxide (NCA), and Li titanate (LTO).

Energy source 206 can also be a high energy density (HED) capacitor, such as an ultracapacitor or supercapacitor. An HED capacitor can be configured as a double layer capacitor (electrostatic charge storage), pseudocapacitor (electrochemical charge storage), hybrid capacitor (electrostatic and electrochemical), or otherwise, as opposed to a solid dielectric type of a typical electrolytic capacitor. The HED capacitor can have an energy density of 10 to 100 times (or higher) that of an electrolytic capacitor, in addition to a higher capacity. For example, HED capacitors can have a specific energy greater than 1.0 watt hours per kilogram (Wh/kg), and a capacitance greater than 10-100 farads (F). As with the batteries described with reference to FIGS. 4A-4D, energy source 206 can be configured as a single HED capacitor or multiple HED capacitors connected together in an array, e.g., series, parallel, or a combination thereof.

Energy source 206 can also be a fuel cell. The fuel cell can be a single fuel cell, multiple fuel cells connected in series or parallel, or a fuel cell module. Examples of fuel cell types include proton-exchange membrane fuel cells (PEMFC), phosphoric acid fuel cells (PAFC), solid acid fuel cells, alkaline fuel cells, high temperature fuel cells, solid oxide fuel cells, molten electrolyte fuel cells, and others. As with the batteries described with reference to FIGS. 4A-4D, energy source 206 can be configured as a single fuel cell or multiple fuel cells connected together in an array, e.g., series, parallel, or a combination thereof. The aforementioned examples of source classes, e.g., batteries, capacitors, and fuel cells, and types, e.g., chemistries and/or structural configurations within each class, are not intended to form an exhaustive list, and those of ordinary skill in the art will recognize other variants that fall within the scope of the present subject matter.

Energy buffer 204 can dampen or filter fluctuations in current across the DC line or link, e.g., +V_{DCL} and −V_{DCL} as described below), to assist in maintaining stability in the DC-link voltage. These fluctuations can be relatively low, e.g., kilohertz, or high, e.g., megahertz, frequency fluctuations or harmonics caused by the switching of converter 202, or other transients. These fluctuations can be absorbed by buffer 204 instead of being passed to source 206 or to ports IO3 and IO4 of converter 202.

Power connection 110 is a connection for transferring energy or power to, from and through module 108. Module 108 can output energy from energy source 206 to power connection 110, where it can be transferred to other modules of the system or to a load. Module 108 can also receive energy from other modules 108 or a charging source (DC charger, single phase charger, multi-phase charger. Signals can also be passed through module 108 bypassing energy source 206. The routing of energy or power into and out of module 108 is performed by converter 202 under the control of LCD 114 (or another entity of subsystem 102.

In the embodiment of FIG. 2A, LCD 114 is implemented as a component separate from module 108, e.g., not within a shared module housing, and is connected to and capable of communication with converter 202 via communication path 116. In the embodiment of FIG. 2B, LCD 114 is included as a component of module 108 and is connected to and capable of communication with converter 202 via internal communication path 118, e.g., a shared bus or discrete connections. LCD 114 can also be capable of receiving signals from, and transmitting signals to, energy buffer 204 and/or energy source 206 over paths 116 or 118.

Module 108 can also include monitor circuitry 208 configured to monitor, e.g., collect, sense, measure, and/or determine, one or more aspects of module 108 and/or the components thereof, such as voltage, current, temperature or other operating parameters that constitute status information (or can be used to determine status information by, e.g., LCD 114. A main function of the status information is to describe the state of the one or more energy sources 206 of the module 108 to enable determinations as to how much to utilize the energy source in comparison to other sources in system 100, although status information describing the state of other components, e.g., voltage, temperature, and/or presence of a fault in buffer 204, temperature and/or presence of a fault in converter 202, presence of a fault elsewhere in module 108, etc., can be used in the utilization determination as well. Monitor circuitry 208 can include one or more sensors, shunts, dividers, fault detectors, Coulomb counters, controllers or other hardware and/or software configured to monitor such aspects. Monitor circuitry 208 can be separate from the various components 202, 204, and 206, or can be integrated with each component 202, 204, and 206 (as shown in FIGS. 2A-2B), or any combination thereof. In some implementations, monitor circuitry 208 can be part of or shared with a Battery Management System (BMS) for a battery energy source 204. Discrete circuitry is not needed to monitor each type of status information, as more than one type of status information can be monitored with a single circuit or device, or otherwise algorithmically determined without the need for additional circuits.

LCD 114 can receive status information or raw data about the module components over communication paths 116, 118. LCD 114 can also transmit information to module components over paths 116, 118. Paths 116 and 118 can include diagnostics, measurement, protection, and control signal lines. The transmitted information can be control signals for one or more module components. The control signals can be switch signals for converter 202 and/or one or more signals that request the status information from module components. For example, LCD 114 can cause the status information to be transmitted over paths 116, 118 by requesting the status information directly, or by applying a stimulus, e.g., voltage, to cause the status information to be generated, in some cases in combination with switch signals that place converter 202 in a particular state.

The physical configuration or layout of module 108 can take various forms. In some implementations, module 108 can include a common housing in which all module components, e.g., converter 202, buffer 204, and source 206, are housed, along with other optional components such as an integrated LCD 114. In other embodiments, the various components can be separated in discrete housings that are secured together. FIG. 2C is a block diagram depicting an example embodiment of a module 108 having a first housing 220 that holds an energy source 206 of the module and accompanying electronics such as monitor circuitry, a second housing 222 that holds module electronics such as converter 202, energy buffer 204, and other accompany electronics such as monitor circuitry, and a third housing 224 that holds LCD 114 for the module 108. Electrical connections between the various module components can proceed through the housings 220, 222, 224 and can be exposed on any of the housing exteriors for connection with other devices such as other modules 108 or MCD 112.

Modules 108 of system 100 can be physically arranged with respect to each other in various configurations that depend on the needs of the application and the number of loads. For example, in a stationary application where system 100 provides power for a microgrid, modules 108 can be placed in one or more racks or other frameworks. Such configurations may be suitable for larger mobile applications as well, such as maritime vessels. Alternatively, modules 108 can be secured together and located within a common housing, referred to as a pack. A rack or a pack may have its own dedicated cooling system shared across all modules. Pack configurations are useful for smaller mobile applications such as electric cars. System 100 can be implemented with one or more racks, e.g., for parallel supply to a microgrid, or one or more packs, e.g., serving different motors of the vehicle), or combination thereof. FIG. 2D is a block diagram depicting an example embodiment of system 100 configured as a pack with nine modules 108 electrically and physically coupled together within a common housing 230.

Examples of these and further configurations are described in Int'l. Appl. No. PCT/US20/25366, filed Mar. 27, 2020 and titled Module-Based Energy Systems Capable of Cascaded and Interconnected Configurations, and Methods Related Thereto, which is incorporated by reference herein in its entirety for all purposes.

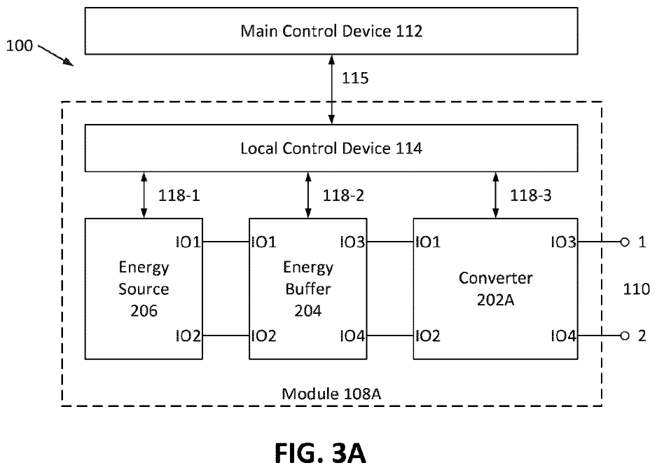

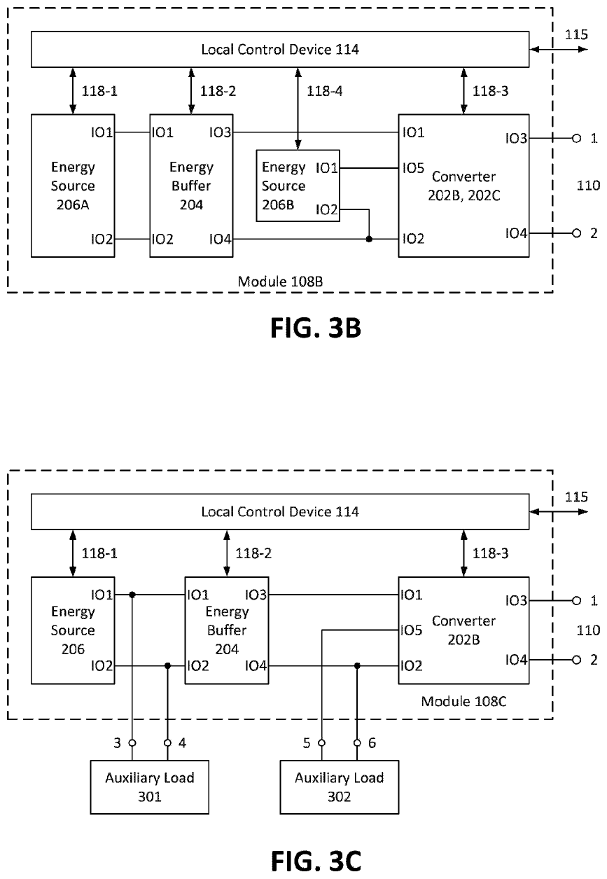

FIGS. 3A-3C are block diagrams depicting example embodiments of modules 108 having various electrical configurations. These embodiments are described as having one LCD 114 per module 108, with the LCD 114 housed within the associated module, but can be configured otherwise as described herein. FIG. 3A depicts a first example configuration of a module 108A within system 100. Module 108A includes energy source 206, energy buffer 204, and converter 202A. Each component has power connection ports, e.g., terminals, connectors, into which power can be input and/or from which power can be output, referred to herein as IO ports. Such ports can also be referred to as input ports or output ports depending on the context.

Energy source 206 can be configured as any of the energy source classes described herein, e.g., a battery as described with reference to FIGS. 4A-4D, an HED capacitor, a fuel cell, or otherwise. Ports IO1 and IO2 of energy source 206 can be connected to ports IO1 and IO2, respectively, of energy buffer 204. Energy buffer 204 can be configured to buffer or filter high and low frequency energy pulsations arriving at buffer 204 through converter 202, which can otherwise degrade the performance of module 108. The topology and components for buffer 204 are selected to accommodate the maximum permissible amplitude of these high frequency voltage pulsations. Several, non-exhaustive, example embodiments of energy buffer 204 are depicted in the schematic diagrams of FIGS. 5A-5C. In FIG. 5A, buffer 204 is an electrolytic and/or film capacitor C_{EB}, in FIG. 5B buffer 204 is a Z-source network 710, formed by two inductors L_{EB1} and L_{EB2} and two electrolytic and/or film capacitors C_{EB1} and C_{EB2}, and in FIG. 5C buffer 204 is a quasi Z-source network 720, formed by two inductors L_{EB1} and L_{EB2}, two electrolytic and/or film capacitors C_{EB1} and C_{EB2} and a diode D_{EB}.

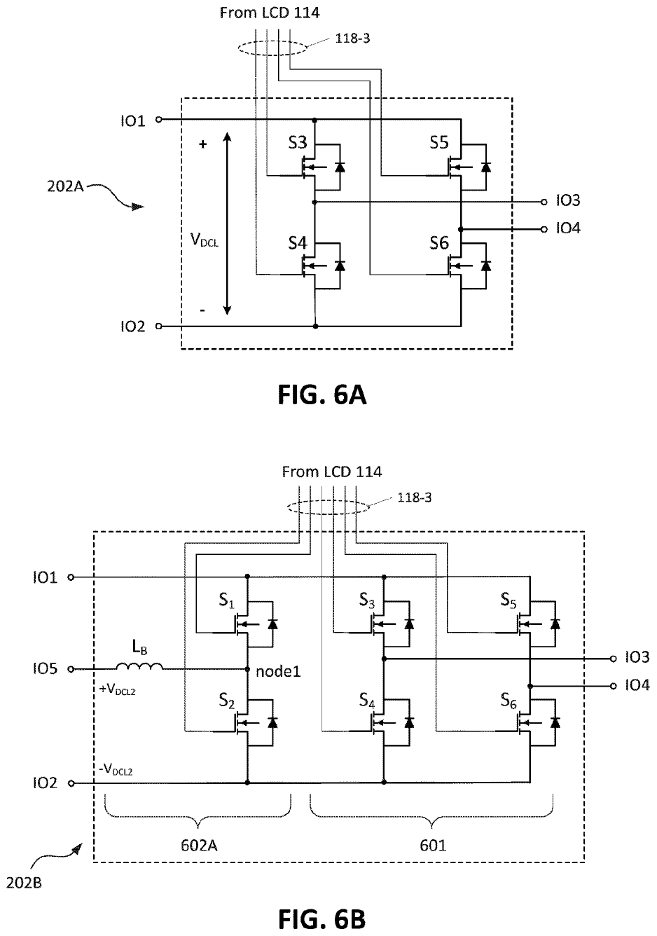

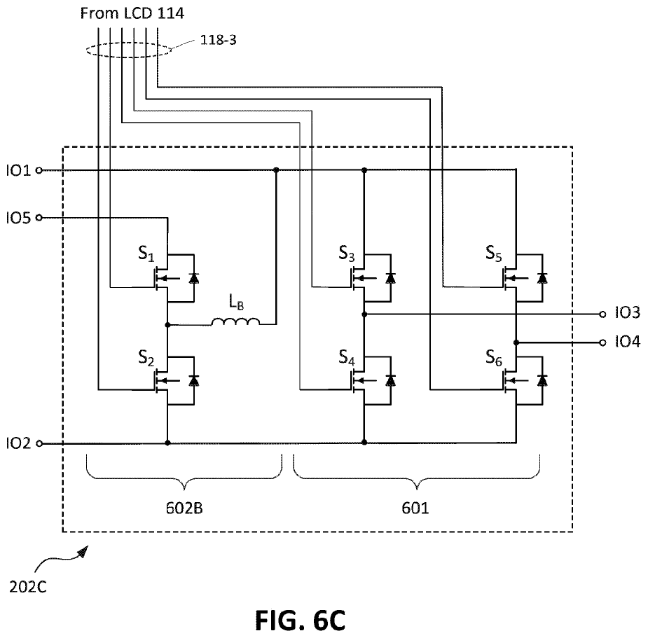

Ports IO3 and IO4 of energy buffer 204 can be connected to ports IO1 and IO2, respectively, of converter 202A, which can be configured as any of the power converter types described herein. FIG. 6A is a schematic diagram depicting an example embodiment of converter 202A configured as a DC-AC converter that can receive a DC voltage at ports IO1 and IO2 and switch to generate pulses at ports IO3 and IO4. Converter 202A can include multiple switches, and here converter 202A includes four switches S3, S4, S5, S6 arranged in a full bridge configuration. Control system 102 or LCD 114 can independently control each switch via control input lines 118-3 to each gate.

The switches can be any suitable switch type, such as power semiconductors like the metal-oxide-semiconductor field-effect transistors (MOSFETs) shown here, insulated gate bipolar transistors (IGBTs), or gallium nitride (GaN) transistors. Semiconductor switches can operate at relatively high switching frequencies, thereby permitting converter 202 to be operated in pulse-width modulated (PWM) mode if desired, and to respond to control commands within a relatively short interval of time. This can provide a high tolerance of output voltage regulation and fast dynamic behavior in transient modes.

In this embodiment, a DC line voltage V_{DCL} can be applied to converter 202 between ports IO1 and IO2. By connecting V_{DCL} to ports IO3 and IO4 by different combinations of switches S3, S4, S5, S6, converter 202 can generate three different voltage outputs at ports IO3 and IO4: +V_{DCL}, 0, and −V_{DCL}. A switch signal provided to each switch controls whether the switch is on (closed) or off (open). To obtain +V_{DCL}, switches S3 and S6 are turned on while S4 and S5 are turned off, whereas −V_{DCL} can be obtained by turning on switches S4 and S5 and turning off S3 and S6. The output voltage can be set to zero, including near zero, or a reference voltage by turning on S3 and S5 with S4 and S6 off, or by turning on S4 and S6 with S3 and S5 off. These voltages can be output from module 108 over power connection 110. Ports IO3 and IO4 of converter 202 can be connected to, or form, module IO ports 1 and 2 of power connection 110, so as to generate the output voltage for use with output voltages from other modules 108.

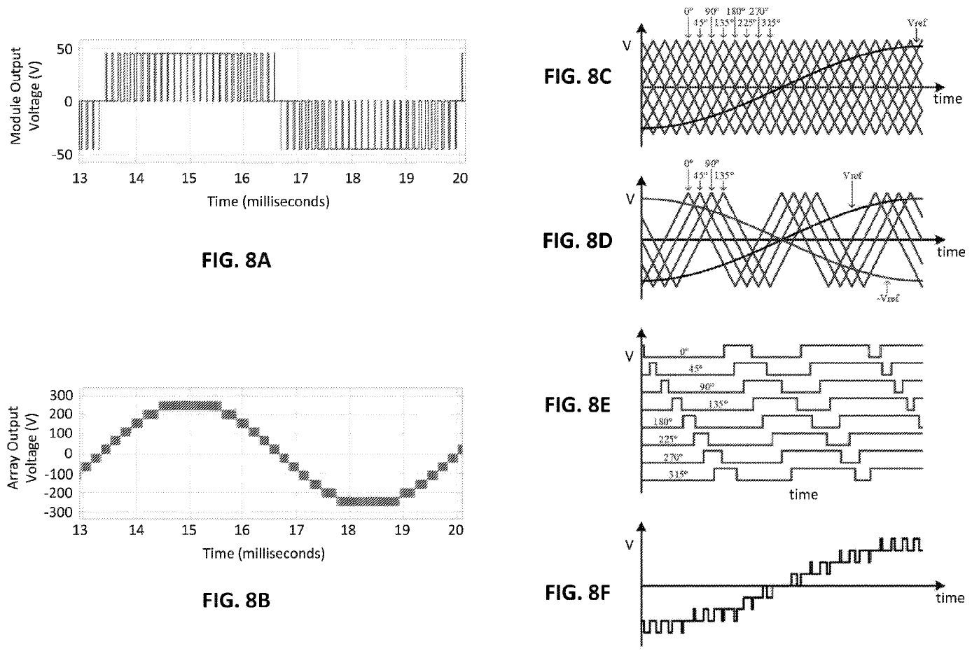

The control or switch signals for the embodiments of converter 202 described herein can be generated in different ways depending on the control technique utilized by system 100 to generate the output voltage of converter 202. In some implementations, the control technique is a PWM technique such as space vector pulse-width modulation (SVPWM) or sinusoidal pulse-width modulation (SPWM), or variations thereof. FIG. 8A is a graph of voltage versus time depicting an example of an output voltage waveform 802 of converter 202. For ease of description, the embodiments herein will be described in the context of a PWM control technique, although the embodiments are not limited to such. Other classes of techniques can be used. One alternative class is based on hysteresis, examples of which are described in Int'l Publ. Nos. WO 2018/231810A1, WO 2018/232403A1, and WO 2019/183553A1, which are incorporated by reference herein for all purposes.

Each module 108 can be configured with multiple energy sources 206, e.g., two, three, four, or more. Each energy source 206 of module 108 can be controllable, e.g., switchable, to supply power to connection 110, or receive power from a charge source, independent of the other sources 206 of the module. For example, all sources 206 can output power to connection 110 or be charged at the same time, or only one or a subset of sources 206 can supply power or be charged at any one time. In some implementations, the sources 206 of the module can exchange energy between them, e.g., one source 206 can charge another source 206. Each of the sources 206 can be configured as any energy source described herein, e.g., battery, HED capacitor, fuel cell. Each of the sources 206 can be the same class, e.g., each can be a battery, each can be an HED capacitor, or each can be a fuel cell), or a different class, e.g., a first source can be a battery and a second source can be an HED capacitor or fuel cell, or a first source can be an HED capacitor and a second source can be a fuel cell.

FIG. 3B is a block diagram depicting an example embodiment of a module 108B in a dual energy source configuration with a primary energy source 206A and secondary energy source 206B. Ports IO1 and IO2 of primary source 202A can be connected to ports IO1 and IO2 of energy buffer 204. Module 108B includes a converter 202B having an additional IO port. Ports IO3 and IO4 of buffer 204 can be connected ports IO1 and IO2, respectively, of converter 202B. Ports IO1 and IO2 of secondary source 206B can be connected to ports IO5 and IO2, respectively, of converter 202B (also connected to port IO4 of buffer 204.

In this example embodiment of module 108B, primary energy source 202A, along with the other modules 108 of system 100, supplies the average power needed by the load. Secondary source 202B can serve the function of assisting energy source 202 by providing additional power at load power peaks, or absorbing excess power, or otherwise.

As mentioned both primary source 206A and secondary source 206B can be utilized simultaneously or at separate times depending on the switch state of converter 202B. If at the same time, an electrolytic and/or a film capacitor (CES) can be placed in parallel with source 206B as depicted in FIG. 4E to act as an energy buffer for the source 206B, or energy source 206B can be configured to utilize an HED capacitor in parallel with another energy source, e.g., a battery or fuel cell, as depicted in FIG. 4F.

FIGS. 6B and 6C are schematic views depicting example embodiments of converters 202B and 202C, respectively. Converter 202B includes switch circuitry portions 601 and 602A. Portion 601 includes switches S3 through S6 configured as a full bridge in similar manner to converter 202A, and is configured to selectively couple IO1 and IO2 to either of IO3 and IO4, thereby changing the output voltages of module 108B. Portion 602A includes switches S1 and S2 configured as a half bridge and coupled between ports IO1 and IO2. A coupling inductor L_{B} is connected between port IO5 and a node1 present between switches S1 and S2 such that switch portion 602A is a bidirectional converter that can regulate, i.e., boost or buck, voltage or inversely current. Switch portion 602A can generate two different voltages at node1, which are +V_{DCL2} and 0, referenced to port IO2, which can be at virtual zero potential. The current drawn from or input to energy source 202B can be controlled by regulating the voltage on coupling inductor L_{B}, using, for example, a pulse-width modulation technique or a hysteresis control method for commutating switches S1 and S2. Other techniques can also be used.

Converter 202C differs from that of 202B as switch portion 602B includes switches S1 and S2 configured as a half bridge and coupled between ports 105 and IO2. A coupling inductor L_{B} is connected between port IO1 and a node1 present between switches S1 and S2 such that switch portion 602B is configured to regulate voltage.

Control system 102 or LCD 114 can independently control each switch of converters 202B and 202C via control input lines 118-3 to each gate. In these embodiments and that of FIG. 6A, LCD 114 (not MCD 112) generates the switching signals for the converter switches. Alternatively, MCD 112 can generate the switching signals, which can be communicated directly to the switches, or relayed by LCD 114.

In embodiments where a module 108 includes three or more energy sources 206, converters 202B and 202C can be scaled accordingly such that each additional energy source 206B is coupled to an additional IO port leading to an additional switch circuitry portion 602A or 602B, depending on the needs of the particular source. For example a dual source converter 202 can include both switch portions 202A and 202B.

Modules 108 with multiple energy sources 206 are capable of performing additional functions such as energy sharing between sources 206, energy capture from within the application, e.g., regenerative braking), charging of the primary source by the secondary source even while the overall system is in a state of discharge, and active filtering of the module output. The active filtering function can also be performed by modules having a typical electrolytic capacitor instead of a secondary energy source. Examples of these functions are described in more detail in Int'l. Appl. No. PCT/US20/25366, filed Mar. 27, 2020 and titled Module-Based Energy Systems Capable of Cascaded and Interconnected Configurations, and Methods Related Thereto, and Int'l. Publ. No. WO 2019/183553, filed Mar. 22, 2019, and titled Systems and Methods for Power Management and Control, both of which are incorporated by reference herein in their entireties for all purposes.

Each module 108 can be configured to supply one or more auxiliary loads with its one or more energy sources 206. Auxiliary loads are loads that require lower voltages than the primary load 101. Examples of auxiliary loads can be, for example, an on-board electrical network of an electric vehicle, or an HVAC system of an electric vehicle. The load of system 100 can be, for example, one of the phases of the electric vehicle motor or electrical grid. This embodiment can allow a complete decoupling between the electrical characteristics, e.g., terminal voltage and current, of the energy source and those of the loads.

FIG. 3C is a block diagram depicting an example embodiment of a module 108C configured to supply power to a first auxiliary load 301 and a second auxiliary load 302, where module 108C includes an energy source 206, energy buffer 204, and converter 202B coupled together in a manner similar to that of FIG. 3B. First auxiliary load 301 requires a voltage equivalent to that supplied from source 206. Load 301 is coupled to IO ports 3 and 4 of module 108C, which are in turn coupled to ports IO1 and IO2 of source 206. Source 206 can output power to both power connection 110 and load 301. Second auxiliary load 302 requires a constant voltage lower than that of source 206. Load 302 is coupled to IO ports 5 and 6 of module 108C, which are coupled to ports IO5 and IO2, respectively, of converter 202B. Converter 202B can include switch portion 602 having coupling inductor L_{B} coupled to port IO5 (FIG. 6B). Energy supplied by source 206 can be supplied to load 302 through switch portion 602 of converter 202B. It is assumed that load 302 has an input capacitor (a capacitor can be added to module 108C if not), so switches S1 and S2 can be commutated to regulate the voltage on and current through coupling inductor L_{B} and thus produce a stable constant voltage for load 302. This regulation can step down the voltage of source 206 to the lower magnitude voltage is required by load 302.

Module 108C can thus be configured to supply one or more first auxiliary loads in the manner described with respect to load 301, with the one or more first loads coupled to IO ports 3 and 4. Module 108C can also be configured to supply one or more second auxiliary loads in the manner described with respect to load 302. If multiple second auxiliary loads 302 are present, then for each additional load 302 module 108C can be scaled with additional dedicated module output ports (like 5 and 6), an additional dedicated switch portion 602, and an additional converter IO port coupled to the additional portion 602.

Energy source 206 can thus supply power for any number of auxiliary loads, e.g., 301 and 302), as well as the corresponding portion of system output power needed by primary load 101. Power flow from source 206 to the various loads can be adjusted as desired.

Module 108 can be configured as needed with two or more energy sources 206 (FIG. 3B) and to supply first and/or second auxiliary loads (FIG. 3C) through the addition of a switch portion 602 and converter port IO5 for each additional source 206B or second auxiliary load 302. Additional module IO ports, e.g., 3, 4, 5, 6, can be added as needed. Module 108 can also be configured as an interconnection module to exchange energy, e.g., for balancing, between two or more arrays, two or more packs, or two or more systems 100 as described further herein. This interconnection functionality can likewise be combined with multiple source and/or multiple auxiliary load supply capabilities.

Control system 102 can perform various functions with respect to the components of modules 108A, 108B, and 108C. These functions can include management of the utilization, i.e., amount of use, of each energy source 206, protection of energy buffer 204 from over-current, over-voltage and high temperature conditions, and control and protection of converter 202.

For example, to manage, e.g., adjust by increasing, decreasing, or maintaining, utilization of each energy source 206, LCD 114 can receive one or more monitored voltages, temperatures, and currents from each energy source 206, or monitor circuitry. The monitored voltages can be at least one of, preferably all, voltages of each elementary component independent of the other components, e.g., each individual battery cell, HED capacitor, and/or fuel cell, of the source 206, or the voltages of groups of elementary components as a whole, e.g., voltage of the battery array, HED capacitor array, and/or fuel cell array. Similarly the monitored temperatures and currents can be at least one of, preferably all, temperatures and currents of each elementary component independent of the other components of the source 206, or the temperatures and currents of groups of elementary components as a whole, or any combination thereof. The monitored signals can be status information, with which LCD 114 can perform one or more of the following: calculation or determination of a real capacity, actual State of Charge (SOC) and/or State of Health (SOH) of the elementary components or groups of elementary components; set or output a warning or alarm indication based on monitored and/or calculated status information; and/or transmission of the status information to MCD 112. LCD 114 can receive control information, e.g., a modulation index, synchronization signal, from MCD 112 and use this control information to generate switch signals for converter 202 that manage the utilization of the source 206.

To protect energy buffer 204, LCD 114 can receive one or more monitored voltages, temperatures, and currents from energy buffer 204, or monitor circuitry. The monitored voltages can be at least one of, preferably all, voltages of each elementary component of buffer 204, e.g., of C_{EB}, C_{EB1}, C_{EB2}, L_{EB1}, L_{EB2}, D_{EB}, independent of the other components, or the voltages of groups of elementary components or buffer 204 as a whole, e.g., between IO1 and IO2 or between IO3 and IO4. Similarly the monitored temperatures and currents can be at least one of, preferably all, temperatures and currents of each elementary component of buffer 204 independent of the other components, or the temperatures and currents of groups of elementary components or of buffer 204 as a whole, or any combination thereof. The monitored signals can be status information, with which LCD 114 can perform one or more of the following: set or output a warning or alarm indication; communicate the status information to MCD 112; or control converter 202 to adjust, e.g., increase or decrease, the utilization of source 206 and module 108 as a whole for buffer protection.

To control and protect converter 202, LCD 114 can receive the control information from MCD 112, e.g., a modulated reference signal, or a reference signal and a modulation index), which can be used with a PWM technique in LCD 114 to generate the control signals for each switch, e.g., S1 through S6. LCD 114 can receive a current feedback signal from a current sensor of converter 202, which can be used for overcurrent protection together with one or more fault status signals from driver circuits (not shown) of the converter switches, which can carry information about fault statuses, e.g., short circuit or open circuit failure modes, of all switches of converter 202. Based on this data, LCD 114 can make a decision on which combination of switching signals to be applied to manage utilization of module 108, and potentially bypass or disconnect converter 202 and the entire module 108 from system 100.

If controlling a module 108C that supplies a second auxiliary load 302, LCD 114 can receive one or more monitored voltages, e.g., the voltage between IO ports 5 and 6, and one or more monitored currents, e.g., the current in coupling inductor L_{B}, which is a current of load 302, in module 108C. Based on these signals, LCD 114 can adjust the switching cycles, e.g., by adjustment of modulation index or reference waveform, of S1 and S2 to control and stabilize the voltage for load 302.

### Cascaded Energy System Topology Examples

Two or more modules 108 can be coupled together in a cascaded array that outputs a voltage signal formed by a superposition of the discrete voltages generated by each module 108 within the array. FIG. 7A is a block diagram depicting an example embodiment of a topology for system 100 where N modules 108-1, 108-2 . . . 108-N are coupled together in series to form a serial array 700. In this and all embodiments described herein, N can be any integer greater than one. Array 700 includes a first system IO port SIO1 and a second system IO port SIO2 across which is generated an array output voltage. Array 700 can be used as a DC or single phase AC energy source for DC or AC single-phase loads, which can be connected to SIO1 and SIO2 of array 700. FIG. 8A is a plot of voltage versus time depicting an example output signal 801 produced by a single module 108 having a 48 volt energy source. FIG. 8B is a plot of voltage versus time depicting an example single phase AC output signal 802 generated by array 700 having six 48V modules 108 coupled in series.

System 100 can be arranged in a broad variety of different topologies to meet varying needs of the applications. System 100 can provide multi-phase power, e.g., two-phase, three-phase, four-phase, five-phase, six-phase, etc., to a load by use of multiple arrays 700, where each array can generate an AC output signal having a different phase angle.

FIG. 7B is a block diagram depicting system 100 with two arrays 700-PA and 700-PB coupled together. Each array 700 is one-dimensional, formed by a series connection of N modules 108. The two arrays 700-PA and 700-PB can each generate a single-phase AC signal, where the two AC signals have different phase angles PA and PB, e.g., 180 degrees apart. IO port 1 of module 108-1 of each array 700-PA and 700-PB can form or be connected to system IO ports SIO1 and SIO2, respectively, which in turn can serve as a first output of each array that can provide two phase power to a load (not shown). Or alternatively ports SIO1 and SIO2 can be connected to provide single phase power from two parallel arrays. IO port 2 of module 108-N of each array 700-PA and 700-PB can serve as a second output for each array 700-PA and 700-PB on the opposite end of the array from system IO ports SIO1 and SIO2, and can be coupled together at a common node and optionally used for an additional system IO port SIO3 if desired, which can serve as a neutral. This common node can be referred to as a rail, and IO port 2 of modules 108-N of each array 700 can be referred to as being on the rail side of the arrays.

FIG. 7C is a block diagram depicting system 100 with three arrays 700-PA, 700-PB, and 700-PC coupled together. Each array 700 is one-dimensional, formed by a series connection of N modules 108. The three arrays 700-1 and 700-2 can each generate a single-phase AC signal, where the three AC signals have different phase angles PA, PB, PC, e.g., 120 degrees apart. IO port 1 of module 108-1 of each array 700-PA, 700-PB, and 700-PC can form or be connected to system IO ports SIO1, SIO2, and SIO3, respectively, which in turn can provide three phase power to a load (not shown). IO port 2 of module 108-N of each array 700-PA, 700-PB, and 700-PC can be coupled together at a common node and optionally used for an additional system IO port SIO4 if desired, which can serve as a neutral.

The concepts described with respect to the two-phase and three-phase embodiments of FIGS. 7B and 7C can be extended to systems 100 generating still more phases of power. For example, a non-exhaustive list of additional examples includes: system 100 having four arrays 700, each of which is configured to generate a single phase AC signal having a different phase angle, e.g., 90 degrees apart; system 100 having five arrays 700, each of which is configured to generate a single phase AC signal having a different phase angle, e.g., 72 degrees apart; and system 100 having six arrays 700, each array configured to generate a single phase AC signal having a different phase angle, e.g., 60 degrees apart.

System 100 can be configured such that arrays 700 are interconnected at electrical nodes between modules 108 within each array. FIG. 7D is a block diagram depicting system 100 with three arrays 700-PA, 700-PB, and 700-PC coupled together in a combined series and delta arrangement. Each array 700 includes a first series connection of M modules 108, where M is two or greater, coupled with a second series connection of N modules 108, where N is two or greater. The delta configuration is formed by the interconnections between arrays, which can be placed in any desired location. In this embodiment, IO port 2 of module 108-(M+N) of array 700-PC is coupled with IO port 2 of module 108-M and IO port 1 of module 108-(M+1) of array 700-PA, IO port 2 of module 108-(M+N) of array 700-PB is coupled with IO port 2 of module 108-M and IO port 1 of module 108-(M+1) of array 700-PC, and IO port 2 of module 108-(M+N) of array 700-PA is coupled with IO port 2 of module 108-M and IO port 1 of module 108-(M+1) of array 700-PB.

FIG. 7E is a block diagram depicting system 100 with three arrays 700-PA, 700-PB, and 700-PC coupled together in a combined series and delta arrangement. This embodiment is similar to that of FIG. 7D except with different cross connections. In this embodiment, IO port 2 of module 108-M of array 700-PC is coupled with IO port 1 of module 108-1 of array 700-PA, IO port 2 of module 108-M of array 700-PB is coupled with IO port 1 of module 108-1 of array 700-PC, and IO port 2 of module 108-M of array 700-PA is coupled with IO port 1 of module 108-1 of array 700-PB. The arrangements of FIGS. 7D and 7E can be implemented with as little as two modules in each array 700. Combined delta and series configurations enable an effective exchange of energy between all modules 108 of the system, e.g., inter-phase balancing, and phases of power grid or load, and also allows reducing the total number of modules 108 in an array 700 to obtain the desired output voltages.

In the embodiments described herein, although it is advantageous for the number of modules 108 to be the same in each array 700 within system 100, such is not required and different arrays 700 can have differing numbers of modules 108. Further, each array 700 can have modules 108 that are all of the same configuration, e.g., all modules are 108A, all modules are 108B, all modules are 108C, or others, or different configurations, e.g., one or more modules are 108A, one or more are 108B, and one or more are 108C, or otherwise. As such, the scope of topologies of system 100 covered herein is broad.

### Control Methodology Examples

As mentioned, control of system 100 can be performed according to various methodologies, such as hysteresis or PWM. Several examples of PWM include space vector modulation and sine pulse width modulation, where the switching signals for converter 202 are generated with a phase shifted carrier technique that continuously rotates utilization of each module 108 to equally distribute power among them.

FIGS. 8C-8F are plots depicting an example embodiment of a phase-shifted PWM control methodology that can generate a multilevel output PWM waveform using incrementally shifted two-level waveforms. An X-level PWM waveform can be created by the summation of (X−1)/2 two-level PWM waveforms. These two-level waveforms can be generated by comparing a reference waveform Vref to carriers incrementally shifted by 360°/(X−1). The carriers are triangular, but the embodiments are not limited to such. A nine-level example is shown in FIG. 8C using four modules 108. The carriers are incrementally shifted by 360°/(9-1)=45° and compared to Vref. The resulting two-level PWM waveforms are shown in FIG. 8E. These two-level waveforms may be used as the switching signals for semiconductor switches, e.g., S1 though S6, of converters 202. As an example with reference to FIG. 8E, for a one-dimensional array 700 including four modules 108 each with a converter 202, the 0° signal is for control of S3 and the 180° signal for S6 of the first module 108-1, the 45° signal is for S3 and the 225° signal for S6 of the second module 108-2, the 90 signal is for S3 and the 270 signal is for S6 of the third module 108-3, and the 135 signal is for S3 and the 315 signal is for S6 of the fourth module 108-4. The signal for S3 is complementary to S4 and the signal for S5 is complementary to S6 with sufficient dead-time to avoid shoot through of each half-bridge. FIG. 8F depicts an example single phase AC waveform produced by superposition, e.g., summation, of output voltages from the four modules 108.

An alternative is to utilize both a positive and a negative reference signal with the first (N−1)/2 carriers. A nine-level example is shown in FIG. 8D. In this example, the 0° to 135° switching signals (FIG. 8E) are generated by comparing +Vref to the 0° to 135° carriers of FIG. 8D and the 180° to 315° switching signals are generated by comparing-Vref to the 0° to 135° carriers of FIG. 8D. However, the logic of the comparison in the latter case is reversed. Other techniques such as a state machine decoder may also be used to generate gate signals for the switches of converter 202.

In multi-phase system embodiments, the same carriers can be used for each phase, or the set of carriers can be shifted as a whole for each phase. For example, in a three phase system with a single reference voltage (Vref), each array 700 can use the same number of carriers with the same relative offsets as shown in FIGS. 8C and 8D, but the carriers of the second phase are shift by 120 degrees as compared to the carriers of the first phase, and the carriers of the third phase are shifted by 240 degrees as compared to the carriers of the first phase. If a different reference voltage is available for each phase, then the phase information can be carried in the reference voltage and the same carriers can be used for each phase. In many cases the carrier frequencies will be fixed, but in some example embodiments, the carrier frequencies can be adjusted, which can help to reduce losses in EV motors under high current conditions.

The appropriate switching signals can be provided to each module by control system 102. For example, MCD 112 can provide Vref and the appropriate carrier signals to each LCD 114 depending upon the module or modules 108 that LCD 114 controls, and the LCD 114 can then generate the switching signals. Or all LCDs 114 in an array can be provided with all carrier signals and the LCD can select the appropriate carrier signals.

The relative utilizations of each module 108 can adjusted based on status information to perform balancing or of one or more parameters as described herein. Balancing of parameters can involve adjusting utilization to minimize parameter divergence over time as compared to a system where individual module utilization adjustment is not performed. The utilization can be the relative amount of time a module 108 is discharging when system 100 is in a discharge state, or the relative amount of time a module 108 is charging when system 100 is in a charge state.

As described herein, modules 108 can be balanced with respect to other modules in an array 700, which can be referred to as intra-array or intraphase balancing, and different arrays 700 can be balanced with respect to each other, which can be referred to as interarray or interphase balancing. Arrays 700 of different subsystems can also be balanced with respect to each other. Control system 102 can simultaneously perform any combination of intraphase balancing, interphase balancing, utilization of multiple energy sources within a module, active filtering, and auxiliary load supply.

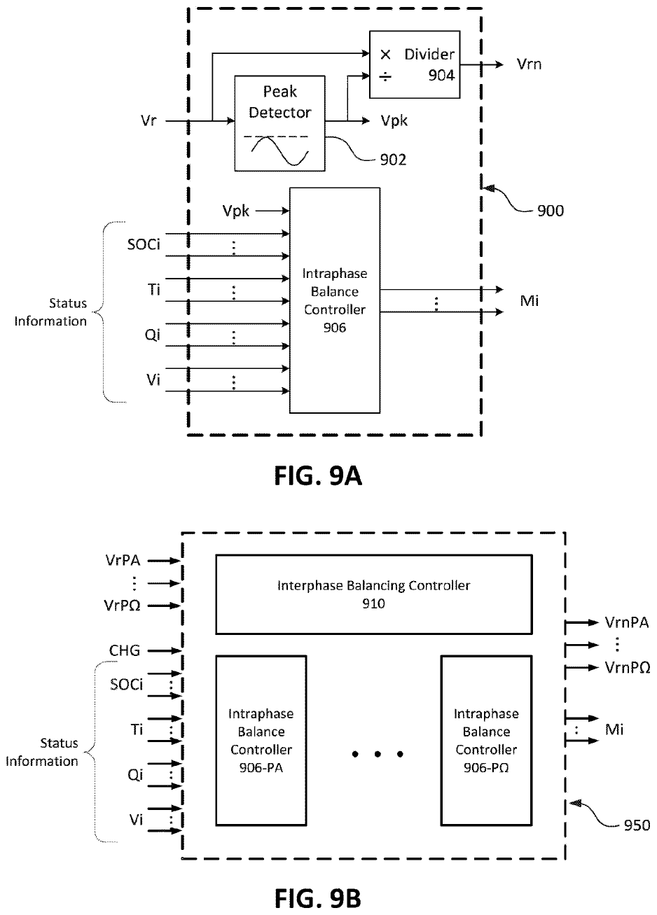

FIG. 9A is a block diagram depicting an example embodiment of an array controller 900 of control system 102 for a single-phase AC or DC array. Array controller 900 can include a peak detector 902, a divider 904, and an intraphase or intra-array balance controller 906. Array controller 900 can receive a reference voltage waveform (Vr) and status information about each of the N modules 108 in the array, e.g., state of charge (SOCi), temperature (Ti), capacity (Qi), and voltage (Vi), as inputs, and generate a normalized reference voltage waveform (Vrn) and modulation indexes (Mi) as outputs. Peak detector 902 detects the peak (Vpk) of Vr, which can be specific to the phase that controller 900 is operating with and/or balancing. Divider 904 generates Vrn by dividing Vr by its detected Vpk. Intraphase balance controller 906 uses Vpk along with the status information, e.g., SOCi, Ti, Qi, Vi, etc., to generate modulation indexes Mi for each module 108 within the array 700 being controlled.

The modulation indexes and Vrn can be used to generate the switching signals for each converter 202. The modulation index can be a number between zero and one, inclusive of zero and one. For a particular module 108, the normalized reference Vrn can be modulated or scaled by Mi, and this modulated reference signal (Vrnm) can be used as Vref (or −Vref) according to the PWM technique described with reference to FIGS. 8C-8F, or according to other techniques. In this manner, the modulation index can be used to control the PWM switching signals provided to the converter switching circuitry, e.g., S3-S6 or S1-S6), and thus regulate the operation of each module 108. For example, a module 108 being controlled to maintain normal or full operation may receive an Mi of one, while a module 108 being controlled to less than normal or full operation may receive an Mi less than one, and a module 108 controlled to cease power output may receive an Mi of zero. This operation can be performed in various ways by control system 102, such as by MCD 112 outputting Vrn and Mi to the appropriate LCDs 114 for modulation and switch signal generation, by MCD 112 performing modulation and outputting the modulated Vrnm to the appropriate LCDs 114 for switch signal generation, or by MCD 112 performing modulation and switch signal generation and outputting the switch signals to the LCDs or the converters 202 of each module 108 directly. Vrn can be sent continually with Mi sent at regular intervals, such as once for every period of the Vrn, or one per minute, etc.

Controller 906 can generate an Mi for each module 108 using any type or combination of types of status information, e.g., SOC, temperature (T), Q, SOH, voltage, current, described herein. For example, when using SOC and T, a module 108 can have a relatively high Mi if SOC is relatively high and temperature is relatively low as compared to other modules 108 in array 700. If either SOC is relatively low or T is relatively high, then that module 108 can have a relatively low Mi, resulting in less utilization than other modules 108 in array 700. Controller 906 can determine Mi such that the sum of module voltages does not exceed Vpk. For example, Vpk can be the sum of the products of the voltage of each module's source 206 and Mi for that module, e.g., Vpk=M₁V₁+M₂V₂+M₃V₃ . . . +M_{N}V_{N}, etc. A different combination of modulation indexes, and thus respective voltage contributions by the modules, may be used but the total generated voltage should remain the same.

In some implementations, controller 906 can generate a modulation index Mi for each module 108 based on a combination of multiple types of status information, e.g., SOC, T, Q, SOH, voltage, current, of modules 108 as well as on feedback, e.g., status information, from a load 101 coupled to system 100. For example, a modulation index Mi can be selected for a module 108 based on the status information, e.g., a low SOC, as well as an operating state of a motor coupled to system 100, e.g., high speed and/or high torque, where the utilization of the module 108 can be adjusted based on an operating state of the motor.

Controller 900 can control operation, to the extent it does not prevent achieving the power output requirements of the system at any one time, e.g., such as during maximum acceleration of an EV), such that SOC of the energy source(s) in each module 108 remains balanced or converges to a balanced condition if they are unbalanced, and/or such that temperature of the energy source(s) or other component, e.g., energy buffer, in each module remains balanced or converges to a balanced condition if they are unbalanced. Power flow in and out of the modules can be regulated such that a capacity difference between sources does not cause an SOC deviation. Balancing of SOC and temperature can indirectly cause some balancing of SOH. Voltage and current can be directly balanced if desired, but in many embodiments the main goal of the system is to balance SOC and temperature, and balancing of SOC can lead to balance of voltage and current in a highly symmetric systems where modules are of similar capacity and impedance.

Since balancing all parameters may not be possible at the same time, e.g., balancing of one parameter may further unbalance another parameter), a combination of balancing any two or more parameters (SOC, T, Q, SOH, V, I) may be applied with priority given to either one depending on the requirements of the application. Priority in balancing can be given to SOC over other parameters (T, Q, SOH, V, I), with exceptions made if one of the other parameters (T, Q, SOH, V, I) reaches a severe unbalanced condition outside a threshold.

Balancing between arrays 700 of different phases, or arrays of the same phase, e.g., if parallel arrays are used, can be performed concurrently with intra-phase balancing. FIG. 9B depicts an example embodiment of an Ω-phase or Ω-array controller 950 configured for operation in an Ω-phase system 100, having at least Ω arrays 700, where Ω is any integer greater than one. Controller 950 can include one inter-phase or inter-array controller 910 and Ω intraphase balance controllers 906-PA . . . 906-PΩ for phases PA through PΩ, as well as peak detector 902 and divider 904 (FIG. 9A) for generating normalized references VrnPA through VrnPΩ from each phase-specific reference VrPA through VrPΩ. Intraphase controllers 906 can generate Mi for each module 108 of each array 700 as described with reference to FIG. 9A. Interphase balance controller 910 is configured or programmed to balance aspects of modules 108 across the entire multi-dimensional system, for example, between arrays of different phases. This may be achieved through injecting common mode to the phases, e.g., neutral point shifting, or through the use of interconnection modules (described herein) or through both. Common mode injection involves introducing a phase and amplitude shift to the reference signals VrPA through VrPΩ to generate normalized waveforms VrnPA through VrnPΩ to compensate for unbalance in one or more arrays, and is described further in Int'l. Appl. No. PCT/US20/25366 incorporated herein.

Controllers 900 and 950, as well as balance controllers 906 and 910, can be implemented in hardware, software or a combination thereof within control system 102. Controllers 900 and 950 can be implemented within MCD 112, distributed partially or fully among LCDs 114, or may be implemented as discrete controllers independent of MCD 112 and LCDs 114.

### Interconnection (IC) Module Examples

Modules 108 can be connected between the modules of different arrays 700 for the purposes of exchanging energy between the arrays, acting as a source for an auxiliary load, or both. Such modules are referred to herein as interconnection (IC) modules 108IC. IC module 108IC can be implemented in any of the already described module configurations (108A, 108B, 108C) and others to be described herein. IC modules 108IC can include any number of one or more energy sources, an optional energy buffer, switch circuitry for supplying energy to one or more arrays and/or for supplying power to one or more auxiliary loads, control circuitry, e.g., a local control device), and monitor circuitry for collecting status information about the IC module itself or its various loads, e.g., SOC of an energy source, temperature of an energy source or energy buffer, capacity of an energy source, SOH of an energy source, voltage and/or current measurements pertaining to the IC module, voltage and/or current measurements pertaining to the auxiliary load(s), etc.,

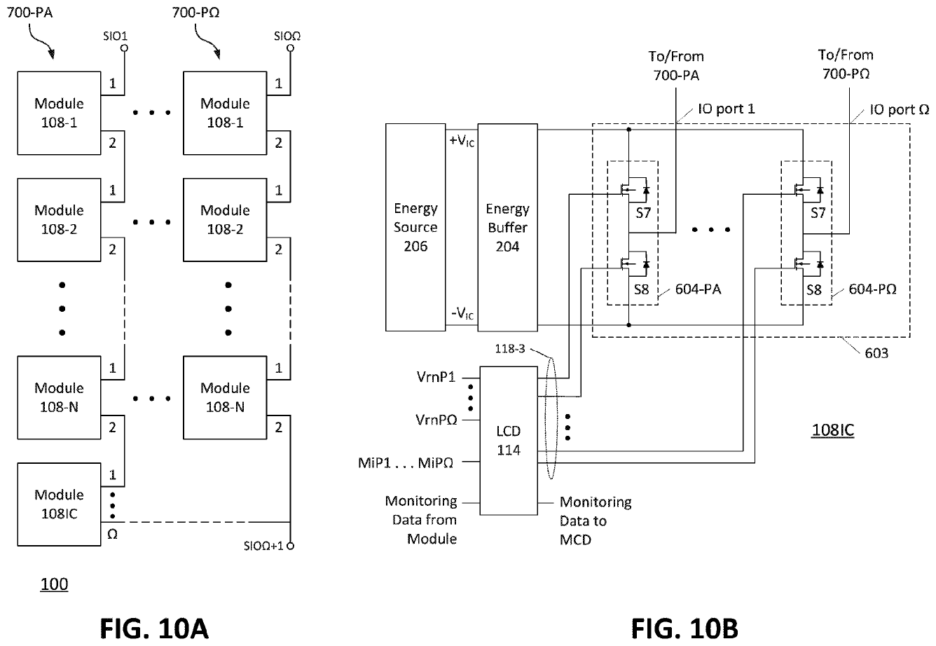

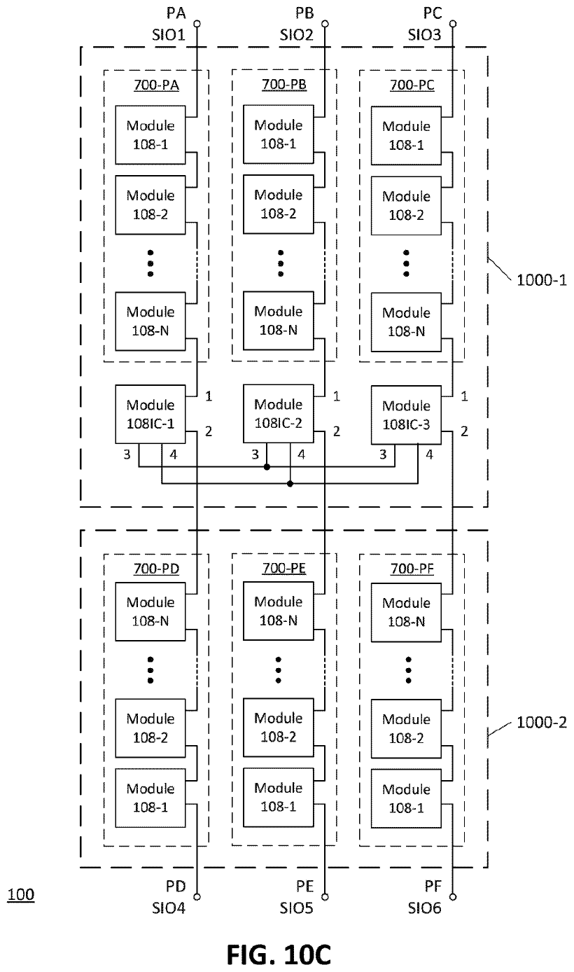

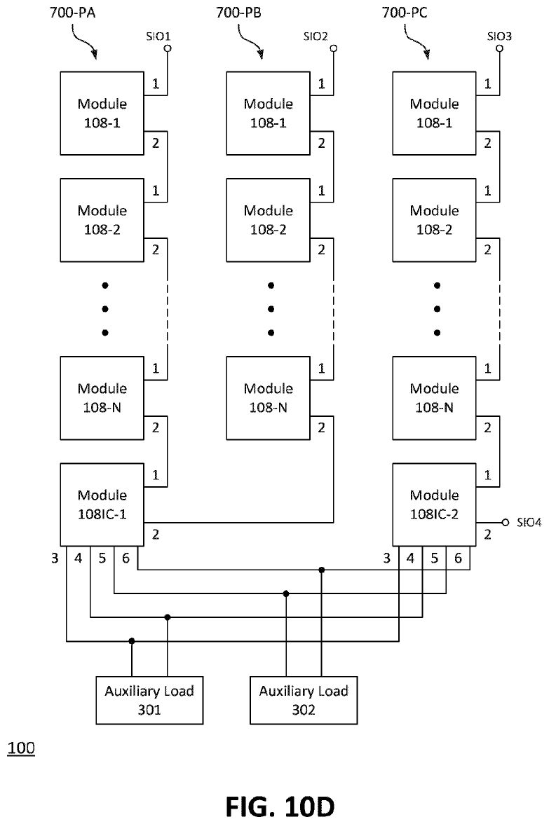

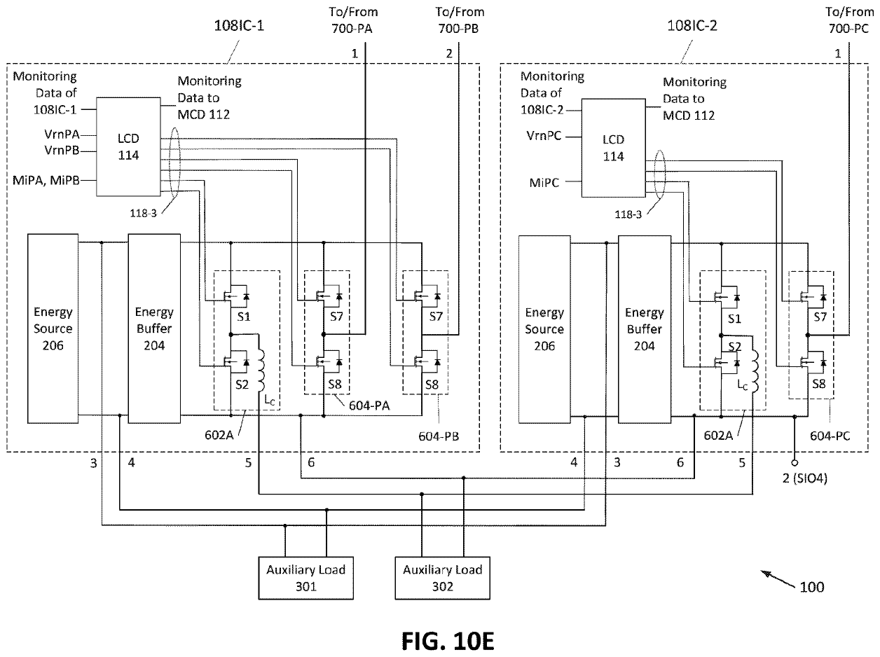

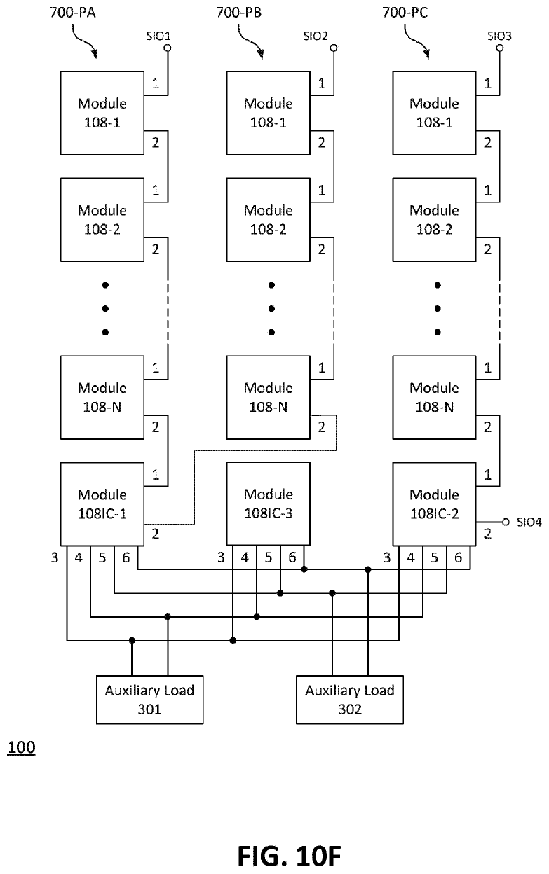

FIG. 10A is a block diagram depicting an example embodiment of a system 100 capable of producing Ω-phase power with Ω arrays 700-PA through 700-PΩ, where Ω can be any integer greater than one. In this and other embodiments, IC module 108IC can be located on the rail side of arrays 700 such the arrays 700 to which module 108IC are connected, e.g., arrays 700-PA through 700-PΩ in this embodiment, are electrically connected between module 108IC and outputs, e.g., SIO1 through SIOΩ, to the load. Here, module 108IC has Ω IO ports for connection to IO port 2 of each module 108-N of arrays 700-PA through 700-PQ. In the configuration depicted here, module 108IC can perform interphase balancing by selectively connecting the one or more energy sources of module 108IC to one or more of the arrays 700-PA through 700-PΩ (or to no output, or equally to all outputs, if interphase balancing is not required. System 100 can be controlled by control system 102 (not shown, see FIG. 1A).

FIG. 10B is a schematic diagram depicting an example embodiment of module 108IC. In this embodiment module 108IC includes an energy source 206 connected with energy buffer 204 that in turn is connected with switch circuitry 603. Switch circuitry 603 can include switch circuitry units 604-PA through 604-PΩ for independently connecting energy source 206 to each of arrays 700-PA through 700-PΩ, respectively. Various switch configurations can be used for each unit 604, which in this embodiment is configured as a half-bridge with two semiconductor switches S7 and S8. Each half bridge is controlled by control lines 118-3 from LCD 114. This configuration is similar to module 108A described with reference to FIG. 3A. As described with respect to converter 202, switch circuitry 603 can be configured in any arrangement and with any switch types, e.g., MOSFET, IGBT, Silicon, GaN, etc., suitable for the requirements of the application.

Switch circuitry units 604 are coupled between positive and negative terminals of energy source 206 and have an output that is connected to an IO port of module 108IC. Units 604-PA through 604-PQ can be controlled by control system 102 to selectively couple voltage +V_{IC} or −V_{IC} to the respective module I/O ports 1 through Ω. Control system 102 can control switch circuitry 603 according to any desired control technique, including the PWM and hysteresis techniques mentioned herein. Here, control circuitry 102 is implemented as LCD 114 and MCD 112 (not shown). LCD 114 can receive monitoring data or status information from monitor circuitry of module 108IC. This monitoring data and/or other status information derived from this monitoring data can be output to MCD 112 for use in system control as described herein. LCD 114 can also receive timing information (not shown) for purposes of synchronization of modules 108 of the system 100 and one or more carrier signals (not shown), such as the sawtooth signals used in PWM (FIGS. 8C-8D).

For inter-phase balancing, proportionally more energy from source 206 can be supplied to any one or more of arrays 700-PA through 700-PΩ that is relatively low on charge as compared to other arrays 700. Supply of this supplemental energy to a particular array 700 allows the energy output of those cascaded modules 108-1 thru 108-N in that array 700 to be reduced relative to the unsupplied phase array(s).

For example, in some example embodiments applying PWM, LCD 114 can be configured to receive the normalized voltage reference signal (Vrn) (from MCD 112) for each of the one or more arrays 700 that module 108IC is coupled to, e.g., VrnPA through VrnPΩ. LCD 114 can also receive modulation indexes MiPA through MiPΩ for the switch units 604-PA through 604-PΩ for each array 700, respectively, from MCD 112. LCD 114 can modulate, e.g., multiply, each respective Vrn with the modulation index for the switch section coupled directly to that array, e.g., VrnA multiplied by MiA, and then utilize a carrier signal to generate the control signal(s) for each switch unit 604. In other embodiments, MCD 112 can perform the modulation and output modulated voltage reference waveforms for each unit 604 directly to LCD 114 of module 108IC. In still other embodiments, all processing and modulation can occur by a single control entity that can output the control signals directly to each unit 604.

This switching can be modulated such that power from energy source 206 is supplied to the array(s) 700 at appropriate intervals and durations. Such methodology can be implemented in various ways.

Based on the collected status information for system 100, such as the present capacity (Q) and SOC of each energy source in each array, MCD 112 can determine an aggregate charge for each array 700, e.g., aggregate charge for an array can be determined as the sum of capacity times SOC for each module of that array. MCD 112 can determine whether a balanced or unbalanced condition exists, e.g., through the use of relative difference thresholds and other metrics described herein, and generate modulation indexes MiPA through MiPΩ accordingly for each switch unit 604-PA through 604-PQ.

During balanced operation, Mi for each switch unit 604 can be set at a value that causes the same or similar amount of net energy over time to be supplied by energy source 206 and/or energy buffer 204 to each array 700. For example, Mi for each switch unit 604 could be the same or similar, and can be set at a level or value that causes the module 108IC to perform a net or time average discharge of energy to the one or more arrays 700-PA through 700-PQ during balanced operation, so as to drain module 108IC at the same rate as other modules 108 in system 100. In some implementations, Mi for each unit 604 can be set at a level or value that does not cause a net or time average discharge of energy during balanced operation (causes a net energy discharge of zero. This can be useful if module 108IC has a lower aggregate charge than other modules in the system.

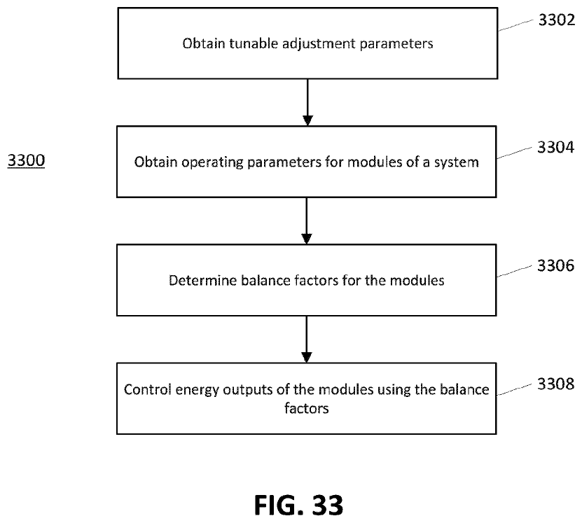

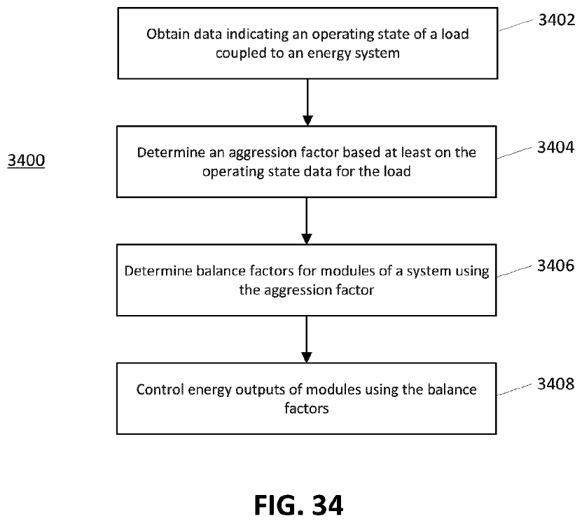

When an unbalanced condition occurs between arrays 700, then the modulation indexes of system 100 can be adjusted to cause convergence towards a balanced condition or to minimize further divergence. For example, control system 102 can cause module 108IC to discharge more to the array 700 with low charge than the others, and can also cause modules 108-1 through 108-N of that low array 700 to discharge relatively less, e.g., on a time average basis. The relative net energy contributed by module 108IC increases as compared to the modules 108-1 through 108-N of the array 700 being assisted, and also as compared to the amount of net energy module 108IC contributes to the other arrays. This can be accomplished by increasing Mi for the switch unit 604 supplying that low array 700, and by decreasing the modulation indexes of modules 108-1 through 108-N of the low array 700 in a manner that maintains Vout for that low array at the appropriate or required levels, and maintaining the modulation indexes for other switch units 604 supplying the other higher arrays relatively unchanged (or decreasing them. The modulation indexes of system 100 can be further adjusted to modify a rate of convergence towards a balanced condition. For example, the modulation indexes can be adjusted to modify a rate of convergence towards a balanced condition based in part on a draw of power, e.g., an operating state, of a load 101 connected to the system. For example, as described in further detail below with reference to FIGS. 33-34, a rate of convergence of the arrays 700 towards a balanced condition or to minimize further divergence can be modified based on how a motor coupled to system 100 is operating, e.g., based on a speed value and/or torque value for the motor.

The configuration of module 108IC in FIGS. 10A-10B can be used alone to provide interphase or interarray balancing for a single system, or can be used in combination with one or more other modules 108IC each having an energy source and one or more switch portions 604 coupled to one or more arrays. For example, a module 108IC with Q switch portions 604 coupled with Ω different arrays 700 can be combined with a second module 108IC having one switch portion 604 coupled with one array 700 such that the two modules combine to service a system 100 having Ω+1 arrays 700. Any number of modules 108IC can be combined in this fashion, each coupled with one or more arrays 700 of system 100.

Furthermore, IC modules can be configured to exchange energy between two or more subsystems of system 100. FIG. 10C is a block diagram depicting an example embodiment of system 100 with a first subsystem 1000-1 and a second subsystem 1000-2 interconnected by IC modules. Specifically, subsystem 1000-1 is configured to supply three-phase power, PA, PB, and PC, to a first load (not shown) by way of system I/O ports SIO1, SIO2, and SIO3, while subsystem 1000-2 is configured to supply three-phase power PD, PE, and PF to a second load (not shown) by way of system I/O ports SIO4, SIO5, and SIO06, respectively. For example, subsystems 1000-1 and 1000-2 can be configured as different packs supplying power for different motors of an EV or as different racks supplying power for different microgrids.

In this embodiment each module 108IC is coupled with a first array of subsystem 1000-1 (via IO port 1) and a first array of subsystem 1000-2 (via IO port 2), and each module 108IC can be electrically connected with each other module 108IC by way of I/O ports 3 and 4, which are coupled with the energy source 206 of each module 108IC as described with respect to module 108C of FIG. 3C. This connection places sources 206 of modules 108IC-1, 108IC-2, and 108IC-3 in parallel, and thus the energy stored and supplied by modules 108IC is pooled together by this parallel arrangement. Other arrangements such as serious connections can also be used. Modules 108IC are housed within a common enclosure of subsystem 1000-1, however the interconnection modules can be external to the common enclosure and physically located as independent entities between the common enclosures of both subsystems 1000.

Each module 108IC has a switch unit 604-1 coupled with IO port 1 and a switch unit 604-2 coupled with I/O port 2, as described with reference to FIG. 10B. Thus, for balancing between subsystems 1000, e.g., inter-pack or inter-rack balancing), a particular module 108IC can supply relatively more energy to either or both of the two arrays to which it is connected, e.g., module 108IC-1 can supply to array 700-PA and/or array 700-PD. The control circuitry can monitor relative parameters, e.g., SOC and temperature, of the arrays of the different subsystems and adjust the energy output of the IC modules to compensate for imbalances between arrays or phases of different subsystems in the same manner described herein as compensating for imbalances between two arrays of the same rack or pack. Because all three modules 108IC are in parallel, energy can be efficiently exchanged between any and all arrays of system 100. In this embodiment, each module 108IC supplies two arrays 700, but other configurations can be used including a single IC module for all arrays of system 100 and a configuration with one dedicated IC module for each array 700, e.g., six IC modules for six arrays, where each IC module has one switch unit 604. In all cases with multiple IC modules, the energy sources can be coupled together in parallel so as to share energy as described herein.

In systems with IC modules between phases, interphase balancing can also be performed by neutral point shifting, or common mode injection, as described above. Such a combination allows for more robust and flexible balancing under a wider range of operating conditions. System 100 can determine the appropriate circumstances under which to perform interphase balancing with neutral point shifting alone, inter-phase energy injection alone, or a combination of both simultaneously.

IC modules can also be configured to supply power to one or more auxiliary loads 301 at the same voltage as source 206, and/or one or more auxiliary loads 302 at voltages stepped down from source 302. FIG. 10D is a block diagram depicting an example embodiment of a three-phase system 100 A with two modules 108IC connected to perform interphase balancing and to supply auxiliary loads 301 and 302. FIG. 10E is a schematic diagram depicting this example embodiment of system 100 with emphasis on modules 108IC-1 ad 108IC-2. Here, control circuitry 102 is again implemented as LCD 114 and MCD 112 (not shown). The LCDs 114 can receive monitoring data from modules 108IC, e.g., SOC of ES1, temperature of ES1, Q of ES1, voltage of auxiliary loads 301 and 302, etc., and can output this and/or other monitoring data to MCD 112 for use in system control as described herein. Each module 108IC can include a switch portion 602A, or 602B described with reference to FIG. 6C, for each load 302 being supplied by that module, and each switch portion 602 can be controlled to maintain the requisite voltage level for load 302 by LCD 114 either independently or based on control input from MCD 112. In this embodiment, each module 108IC includes a switch portion 602A connected together to supply the one load 302, although such is not required.

FIG. 10F is a block diagram depicting another example embodiment of a three-phase system configured to supply power to one or more auxiliary loads 301 and 302 with modules 108IC-1, 108IC-2, and 108IC-3. In this embodiment, modules 108IC-1 and 108IC-2 are configured in the same manner as described with reference to FIGS. 10D-10E. Module 108IC-3 is configured in a purely auxiliary role and does not actively inject voltage or current into any array 700 of system 100. In this embodiment, module 108IC-3 can be configured like module 108C of FIG. 3B, having a converter 202B,C (FIGS. 6B-6C) with one or more auxiliary switch portions 602A, but omitting switch portion 601. As such, the one or more energy sources 206 of module 108IC-3 are interconnected in parallel with those of modules 108IC-1 and 108IC-2, and thus this embodiment of system 100 is configured with additional energy for supplying auxiliary loads 301 and 302, and for maintaining charge on the sources 206A of modules 108IC-1 and 108IC-2 through the parallel connection with the source 206 of module 108IC-3.

The energy source 206 of each IC module can be at the same voltage and capacity as the sources 206 of the other modules 108-1 through 108-N of the system, although such is not required. For example, a relatively higher capacity can be desirable in an embodiment where one module 108IC applies energy to multiple arrays 700 (FIG. 10A) to allow the IC module to discharge at the same rate as the modules of the phase arrays themselves. If the module 108IC is also supplying an auxiliary load, then an even greater capacity may be desired so as to permit the IC module to both supply the auxiliary load and discharge at relatively the same rate as the other modules.

### Second Life Energy Source Examples

Energy sources 206 described herein can be used in systems 100 described herein in both first life and second life applications. A first life of a source 206 is an original application in which source 206 is used. For example, the first life application is the first implementation in which sources 206 are put to use by the first customer of sources 206 after their original manufacture (and not refurbishment). The user of sources 206 in their first life will typically have received sources 206 from the manufacturer, distributor, or original equipment manufacturer (OEM). Batteries 206 used in a first life application will typically have the same electrochemistry (e.g., will have the same variant of lithium ion electrochemistry (e.g., LFP, NMC)) and will have the same nominal voltage and will have a capacity variation across the pack or system that is minimal (e.g., 5% or less). Use of an energy storage system with batteries 206 in their first life application will result in batteries 206 having a longer lifespan in that first life application, and upon removal from that first life application, the batteries 206 will be more similar in terms of capacity degradation than batteries from a first life application not using the energy storage system.

As used herein, a “second life” application is any application or implementation after the first life application (e.g., a second implementation, third implementation, fourth implementation, etc.) of source 206. A second life energy source refers to any energy source (e.g., battery or HED capacitor) implemented in that source's second life application.

An example of a first life application for batteries 206 is within an energy storage system for an EV. Then, at the end of that life (e.g., after 100,000 miles of driving, or after degradation of the batteries within that battery pack by a threshold amount), the batteries 206 can be removed from the battery pack, optionally subjected to refurbishing and testing, and then implemented in a second life application that can be, e.g., used within a stationary energy storage system (e.g., residential, commercial, or industrial energy buffering, EV charging station energy buffering, renewable source (e.g., wind, solar, hydroelectric), energy buffering, and the like) or another mobile energy storage system (e.g., battery pack for an electric car, bus, train, or truck). Similarly, the first life application can be a first stationary application and the second life application can be a stationary or mobile application.

For the second life application, sources 206 can be selected and/or utilized by system 100 to minimize (or at least reduce) any differences in initial capacity and nominal voltage. For example, sources 206 having a capacity difference of 5% or more can be included within system 100 and operated to provide energy for a load. In another example, an operator or automated system can select sources 206 for system 100 that have a capacity difference within a threshold amount, e.g., to reduce the initial capacity differences between sources of system 206. If modules 108 are compatible with both the first and second life application (e.g., with or without reconfiguration), modules 108 can be selected for the second life application based on the capacity difference of sources 206 of modules 108.

System 100 can adjust utilization of each source 206 individually such that sources 206 within system 100 or packs of system 100 are relatively balanced in terms of SOC or total charge (SOC times capacity) as the pack or system 100 is discharged, even though the sources 206 in system 100 can have widely varying capacities. Similarly, system 100 can maintain balance as the pack or system 100 is charged. Sources 206 can vary not only in terms of capacity but also in nominal voltage, power rating, electrochemical type (e.g., a combination of LFP and NMC batteries) and the like. Thus, system 100 can be used such that all modules 206 within system 100 or each pack of system 100 are second life energy sources (or such that a combination of first life and second life energy sources are used), having various combinations of different characteristics.

In one example, system 100 can include second life energy sources 206 (and optionally one or more first life energy sources 206) having energy capacity variations of 2% or more, 5% or more, 10% or more, 15% or more, 20% or more, or 25% or more, 30% or more, 5-30%, 10-30%, and/or 20-30%.

In another example, system 100 can include second energy life sources 206 (and optionally one or more first life energy sources 206) having energy capacity per mass density variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having peak power per mass density variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having nominal voltage variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having operating voltage range variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having maximum specified current rise time variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having specified peak current variations of 2% or more, 5% or more, 10% or more, 15% or more, 20% or more, or 25% or more, 30% or more, 5-30%, 10-30%, and/or 20-30%.

A variation of X % (e.g., 5% or more, or 5 to 30%) can be met by a variation between the module 108 having the highest value for that parameter and the module 108 having the lowest value for that parameter within system 100. For example, a variation of 5% or more in capacity can be met by a system 100 where the module 108 with the lowest capacity source 206 has a capacity that is 95% or less than that of the module 108 with the highest capacity source 206. For each and every embodiment and parameter disclosed herein, the time at which the system 100 having one or more second life sources satisfies the X % variation condition in that parameter can be at installation of the system 100, at commissioning of the system 100, after replacement of one source 206 with another source 206, after operation of system 100 for 10 hours or more, after operation of system 100 for 100 hours or more, after operation of system 100 for 1000 hours or more, and/or after operation of system 100 for 10,000 hours or more. For example, a variation of capacity of 5% or more can occur after system 100 is operated for 1000 hours, even though the variation in capacity was not present at the time of commissioning. This reflects the capability of the embodiments of system 100 to continue to operate with and account for capacity differences between sources 206 that grow over time of operation.

In another example, system 100 can include second life energy sources 206 (and optionally one or more first life energy sources 206) having variations of electrochemical type (e.g., lithium ion batteries with non-lithium ion batteries, or different lithium ion batteries (e.g., any combination of NMC, LFP, LTO, or other lithium ion battery types).

System 100 can include second life energy sources 206 (and optionally one or more first life energy sources 206) having any combination of the characteristics provides in the preceding examples.

Topology Examples for Applications with Intermittent Charging

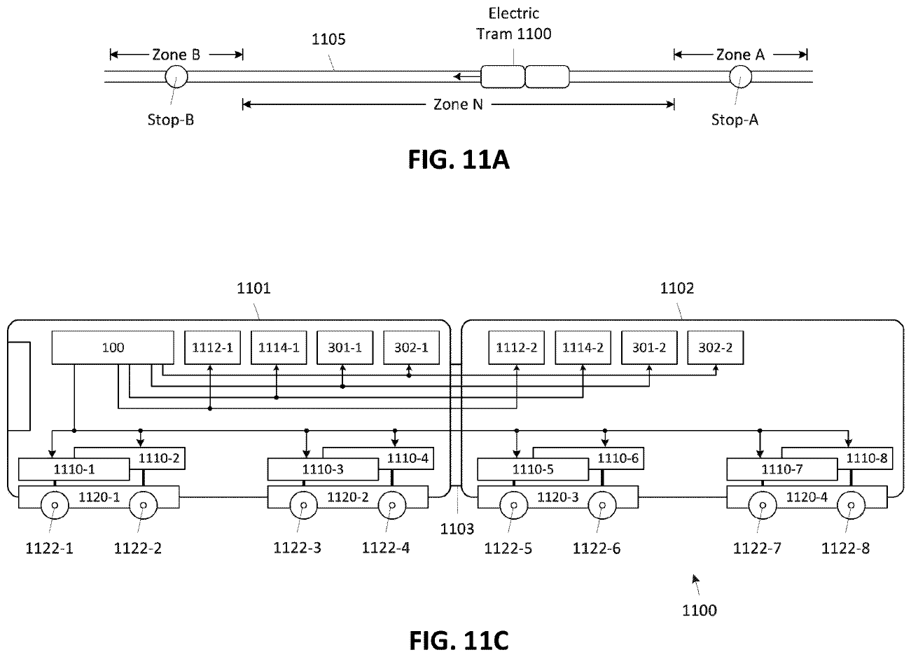

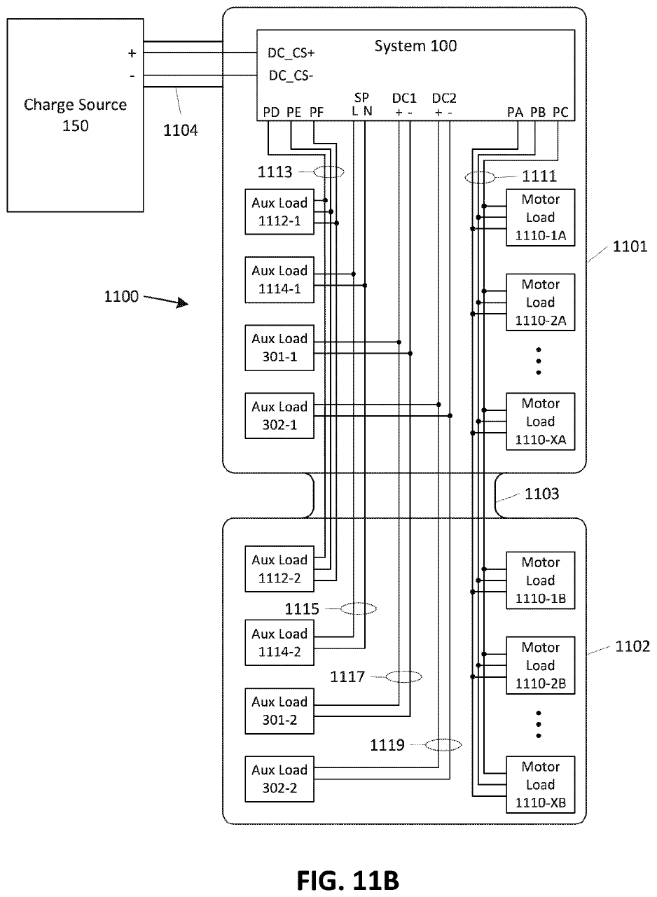

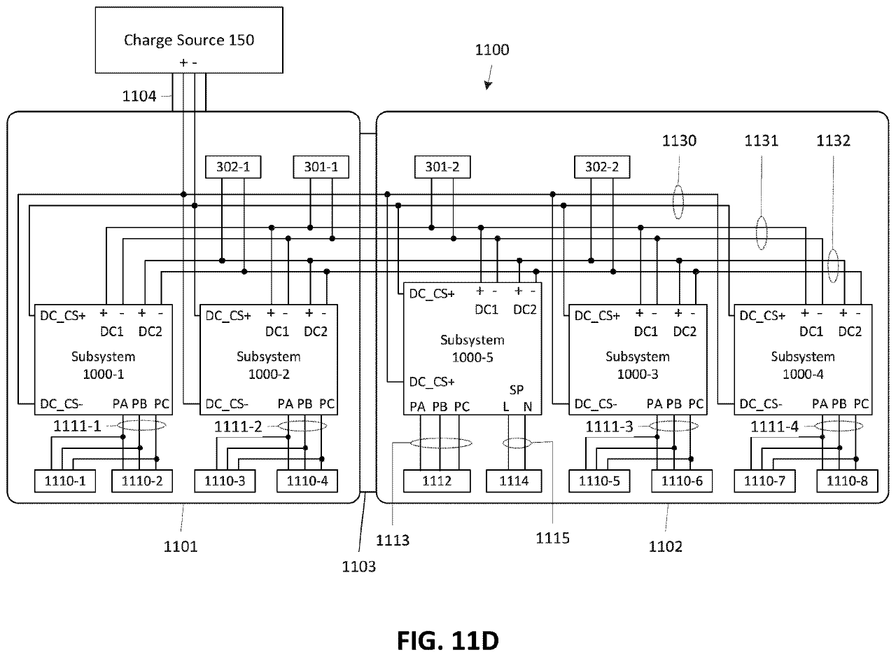

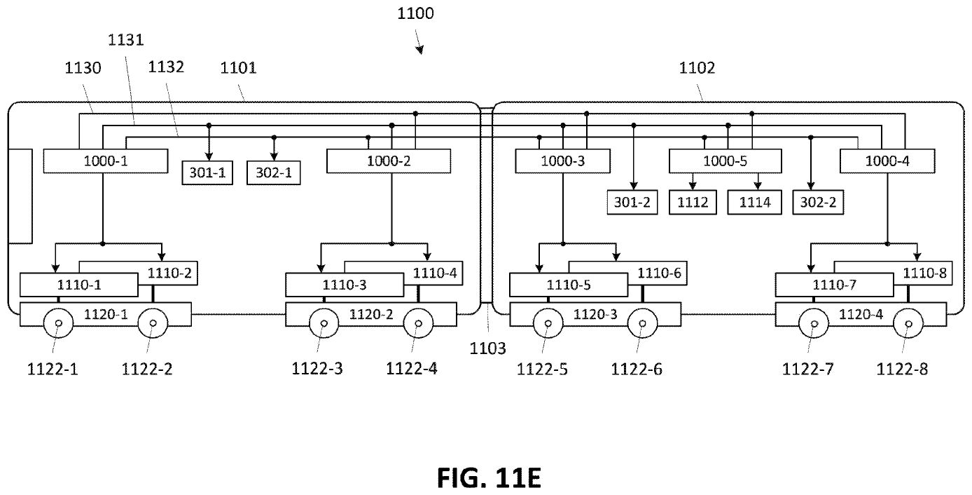

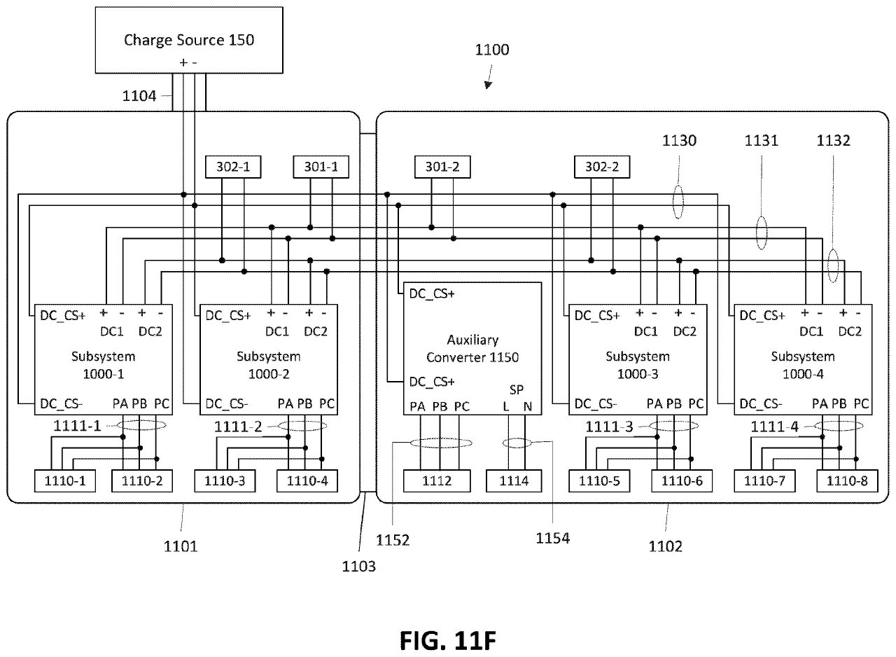

Example embodiments pertaining to modular energy systems 100 used in applications with intermittently available charge sources are described with reference to FIGS. 11A-16. These embodiments can be implemented with all aspects of system 100 described with reference to FIGS. 1A-10F unless stated otherwise or logically implausible. As such, the many variations already described will not be repeated with respect to the following embodiments. These example embodiments are particularly suited for mobile applications, such as electric vehicles that operate on a rail (rail-based EVs) like trains, trams, trolleys, and other rolling stock, where the charge source is intermittently available. The embodiments can be used with other vehicles as well, such as cars, buses, trucks, maritime vehicles, e.g., electric ferries), planes, etc., and even in some stationary applications. Thus, for ease of description the example embodiments will be described in the context of a rail-based EV, particularly an electric tram or train, with the understanding that the embodiments have much wider applicability to other vehicles and applications.

The example embodiments can be implemented in a variety of configurations to store and deliver energy while the electric tram is moving through sections of rail where no charge source is available. FIG. 11A is an illustration depicting a portion of an example route of an electric tram 1100 traveling on rails 1105, where tram 1100 is traveling from a first location Stop-A to a second location Stop-B. A charge source is available within Zone-A surrounding Stop-A, and a charge source is also available within Zone-B surrounding Stop-B. The charge source can be positioned overhead, at ground-level or below ground. When within Zone-A and Zone-B, tram 1100 can extend an electrical contact device, e.g., a pantograph for a catenary, to connect to the charge source and, whether moving or stationary, can receive power for operating the loads of tram 1100 and for charging the energy sources 206 of system 100. Zone-N demarcates the length of rails 1105 between Zone-A and Zone-B where no charge source is available. When traveling through Zone-N, the contact device can be retracted and tram 1100 uses the energy stored within its one or more systems 100 to supply power for all loads within tram 1100.

Tram 1100 can be configured with one or more iterations of system 100, each with its own control system 102, and each iteration of system 100 can supply one or more loads, such as motor loads and auxiliary loads. The tram can have a single iteration of system 100 with one or more subsystems 1000 that supplies power for all loads of all cars. The one or more subsystems 1000 can share one control system 102, e.g., a single MCD 112 for all subsystems 1000, or can have independent control systems 102. The cars can each have one or more subsystems 1000 of system 100 for supplying the loads within that car, or the cars can rely wholly on power supplied by a subsystem 1000 in another car. A combination of approaches can be used where a particular car has a subsystem 1000 for supplying certain loads of that particular car and that particular car can also have other loads that receive power from another subsystem 1000 in a different car.

FIG. 11B is a block diagram depicting an example embodiment of an electric tram 1100 having two cars 1101 and 1102 with an interconnection 1103 therebetween. System 100 is located in first car 1101, which has a retractable conductor 1104 for receiving charge from charge source 150 when conductor 1104 is in contact with source 150. System 100 can be configured to supply high-voltage multiphase power to one or more motors within each car 1101 and 1102. Here, system 100 has multiple arrays (not shown) for providing three-phase power (PA, PB, PC) over lines 1111 to motors 1110-1A through 1110-XA of car 1101, where X can be any integer two or greater. Lines 1111 continue through interconnection 1103 to car 1102 where the three-phase power can be supplied to motors 1110-1B through 1110-XB of car 1102.

System 100 can also be configured to supply multiple voltages for auxiliary loads having different power requirements, including multiphase power, single phase power, and DC power at one or more voltages each. Examples of auxiliary loads can include compressors for HVAC systems, a battery thermal management system (BTMS), onboard electrical networks for powering all automated aspects of tram 1100, and others. Here, system 100 is configured to supply three-phase power (PD, PE, PF) to three-phase auxiliary load 1112-1 over lines 1113, single phase (SP) power (line (L), neutral (N)) to single phase auxiliary load 1114-1 over lines 1115, DC voltage at a first level to auxiliary load 301-1 over lines 1117, and DC voltage at a second level to auxiliary load 302-1 over lines 1119 (see, e.g., power supply for loads 301 and 302 as described with reference to FIGS. 10D and 10E. Lines 1113, 1115, 1117, and 1119 continue through interconnection 1103 to supply similar loads 1112-2, 1114-2, 301-2, and 302-2 within car 1102. Here, supply for the loads within car 1101 is provided in parallel fashion via the same lines for the loads within car 1102. In other embodiments, different lines can be used to supply the various loads within each car 1101 and 1102 in non-parallel fashion depending on the needs of the implementation.

One or more motors 1110, e.g., one, two, three, four, or more, can be secured to or associated with a bogie, and the rail-based vehicle can have multiple, e.g., two or more, such bogies for every car. Placement of system 100 and its subsystems 1000 can be in close proximity to motors 1110 or elsewhere as described herein. FIG. 11C is a side view depicting an example embodiment of tram 1100 with an electrical layout of that described with reference to FIG. 11A. Here, each car includes two bogies 1120 having two motors 1110, each configured to provide motive force for driving an axle 1122. System 100 is physically located in car 1101 and can be placed in a position that would reside above the passenger's heads as shown here or below the passenger's feet or floor in an alternative embodiment. Each car includes auxiliary loads 1112, 1114, 301 and 302. All motors 1110 and auxiliary loads are supplied by system 100 via the arrows shown (individual lines 1111, 1113, 1115, 1117, and 1119 are omitted for clarity.

FIG. 11D is a block diagram depicting another example embodiment of electric tram 1100, but with multiple subsystems 1000. Each subsystem 1000 can be configured as a separate pack with a common housing. In this example, car 1101 includes a first subsystem 1000-1 for supplying power for motors 1110-1 and 1110-2 over a set of lines 1111-1 and a second subsystem 1000-2 for supplying power for motors 1110-3 and 1110-4 over a set of lines 1111-2. Car 1102 includes a third subsystem 1000-3 for supplying power for motors 1110-5 and 1110-6 over a set of lines 1111-3 and a fourth subsystem 1000-4 for supplying power for motors 1110-7 and 1110-8 over a set of lines 1111-4. Car 1102 also includes a fifth subsystem 1000-5 for supplying multiphase and/or single phase power for one or more auxiliary loads. Here, subsystem 1000-5 supplies three-phase power to auxiliary load 1112 over lines 1113 and single phase power to auxiliary load 1114 over lines 1115. Each of subsystems 1000-1 through 1000-5 can be configured to supply DC power for loads 301 and 302 by way of one or more modules 108IC or 108C (see, e.g., FIG. 3C and FIGS. 10A-10F.

Each subsystem 1000 can be connected to sets of shared lines for sharing DC power, and these lines can cross between cars 1101 and 1102 through interconnection 1103. Lines 1130 can carry high-voltage positive and negative DC signals, DC_CS+ and DC_CS−, respectively, from charge source 150, for supplying charge voltage to all of the modules 108 of each system 100 when tram 1100 is connected to a charge source 150. The shared lines can also exchange lower DC voltages for supply to auxiliary loads 301 and 302. Lines 1131 can carry positive and negative DC signals, DC1+ and DC1−, respectively, for supplying a lower DC voltage to auxiliary loads 301. For example, these lines can be similar to the lines interconnecting ports 3 and 4 of IC modules 108IC and 108C as described with reference to FIGS. 3C, 10D, and 10E, and can carry the voltage of the energy sources 206 of the interconnected modules 108. Lines 1132 can carry positive and negative DC signals, DC2+ and DC2−, respectively, for supplying a lower DC voltage to auxiliary loads 302. For example, these lines can be similar to the lines interconnecting ports 5 and 6 of IC modules 108IC and 108C as described with reference to FIGS. 3C, 10D, and 10E, and can carry a regulated stepped down voltage from sources 206.

FIG. 11E is a side view depicting another example embodiment of tram 1100 with an electrical layout of that described with reference to FIG. 11C. Here, each of subsystems 1000-1 through 1000-4 supplies power for two motors 1110 associated with axles 1122 of a bogie 1120. Subsystem 1000-5 in car 1102 supplies power for loads 1112 and 1114, which are also positioned in car 1102, but can be located in other cars as well. Each of subsystems 1000 is connected to shared lines 1130 for charging and energy exchange, as well as lines 1131 for energy exchange and supplying loads 301, and lines 1132 for supplying loads 302. As with the embodiment of FIG. 11B, each of subsystems 1000-1 through 1000-5 can be placed in a position that would reside above the passenger's heads (as shown here) or below the passenger's feet, or elsewhere.

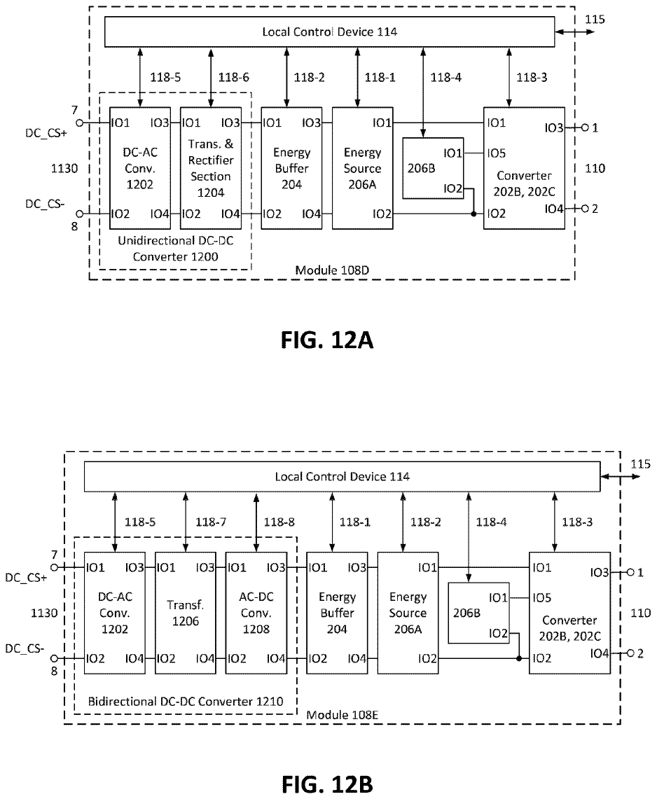

FIG. 11F is a block diagram depicting another example embodiment of electric tram 1100 with multiple subsystems 1000, but with an auxiliary power converter 1150 instead of auxiliary subsystem 1000-5. Auxiliary converter 1150 can convert the high voltage available on DC lines 1130 into single and/or multiphase power for one or more auxiliary loads of tram 1100. In this embodiment, converter 1150 is configured to provide three phase power for three-phase load 1112 over lines 1152 and to provide single phase power for single phase load 1114 over lines 1154. When connected to charge source 150, auxiliary converter 1150 can use the DC voltage provided by source 150 over lines 1130 to power loads 1112 and 1114. As described with reference to FIG. 12B, when not connected to source 150, the other subsystems 1000-1 through 1000-4 can provide the power to auxiliary converter 1150 over lines 1130 by outputting DC voltages from ports 7 and 8 to lines 1130 using bidirectional DC-DC converters 1210. The DC output voltages from each module 108 can be summed on the DC lines 1130 to provide sufficient voltage to power auxiliary converter 1150.

The embodiments of FIGS. 11B-11F are described with respect to tram 1100 having two cars 1101 and 1102, but can be extended to rolling stock having any number of cars (one, three, four, and more), with any combination of subsystems within each car, e.g., supplying one or more motors 1110, one or more loads 1112, one or more loads 1114, one or more loads 301, and/or one or more loads 302.

The embodiments of FIGS. 11D-11F can also include one or more conventional high voltage battery packs connected between lines 1130 (DC_CS+ and DC_CS−) like subsystems 1000. The conventional battery pack can include multiple batteries, e.g., Li ion, or HED capacitors connected in series, and is not configured as a modular cascaded multi-level converter. The conventional battery pack can be used to provide supplementary power for any subsystem 1000 (through the shared DC lines 1130), for auxiliary converter 1150, directly for a motor load 1110 (if connected through an inverter), directly for DC auxiliary loads 301 and 302, e.g., connected through a DC-DC converter), and/or directly for AC auxiliary loads 1112 and/or 1114 (if connected through a DC-AC converter. The conventional battery pack can be charged by charge source 150 through a DC-DC converter interposed in series on lines 1130 between the convention pack and charge source 150. Alternatively, the interposed DC-DC converter can be omitted and the conventional pack can be selectively disconnected from lines 1130 with switches, e.g., contactors, when charge source 150 is connected and, after disconnection of source 150, the battery pack can be reconnected to lines 1130 and charged by one or more subsystems 1000.

Modules 108A-C and 108IC described herein can be used within tram 1100. Additional example embodiments of module configurations are also described. FIG. 12A is a block diagram depicting an example embodiment of module 108D configured for use within system 100 of tram 1100. In all the embodiments described herein module 108D can include any number of energy sources 206, such as one or more batteries, one or more high energy density (HED) capacitors, and/or one or more fuel cells. If multiple batteries are included those batteries can have the same or different electrochemistries as described herein. Similarly, different types of high-energy density capacitors and fuel cells can be used. Each battery can be a single cell or multiple cells connected in series, parallel or a combination thereof to arrive at the desired voltage and current characteristics. As shown in FIG. 12A, module 108 includes a first source 206A and a second source 206B, in the sources can be batteries of different types, e.g., such as an LTO battery and an LFP battery, or one can be a battery and the other can be an HED capacitor, or any other combination as described herein.

Module 108D includes converter 202B or 202C coupled with energy sources 206A and 206B in a manner similar to that described with respect to module 108B of FIG. 3B. Energy source 206A is coupled with energy buffer 204, which in turn is coupled with a unidirectional isolated DC-DC converter 1200. Module 108D includes I/O ports 7 and 8 that connect with the charge source signals DC_CS+ and DC_CS− respectively, via lines 1130. These signals are input to DC-AC converter 1202 of converter 1200 where they are converted to high-frequency AC form and then input to transformer and rectifier section 1204.

Transformer and rectifier section 1204 can include a high-frequency transformer and one phase diode rectifier. The DC voltage on ports 7 and 8 may be a voltage that is lower than the total voltage supplied by the charge source as subsystem 1000 may include many such modules 108 receiving charge simultaneously. Transformer and rectifier section 1204 can modify the voltage of the AC signal from converter 1202, if necessary, and convert the AC signal back into DC form to charge sources 206A and 206B. Section 1204 also provides high-voltage isolation to the other components 202, 204, 206 and 114 of module 108D.

Unidirectionality is provided by virtue of the diode rectifier which permits current to be received from charge source 150 and passed to buffer 204 but does not permit outputting current in the opposite manner. For example, upon braking if the vehicle has an energy recovery system then the current from braking can be transferred back to each module 108 through power connection 110 and routed to either of sources 206A and 206B by way of converter 202B,C. Presence of unidirectional DC-DC isolated converter 1200, e.g., diode rectifier, will prevent that recovered energy from passing through module 108D back to the charge source via lines 1130.

LCD 114 can monitor the status of converter 1200, particularly converter 1202 and section 1204, over data connections 118-5 and 118-6, respectively. As with the other components of module 108E, monitor circuitry for converter 1202 and section 1204 can be included to measure currents, voltages, temperatures, faults, and the like. These connections 118-5 and 118-6 can also supply control signals to control switching of converter 1202 and to control any active elements within section 1204. Isolation of LCD 114 can be maintained by isolation circuitry present on lines 118-5 and 118-6, e.g., isolated gate drivers and isolated sensors.

FIG. 12B is a block diagram depicting an example embodiment of a module 108E. Module 108E is configured similarly to that of module 108D but has a bidirectional DC-DC isolated converter 1210 instead of converter 1200, and can perform bidirectional energy exchange between sources 206 or power connection 110 and ports 7 and 8 connected to lines 1130. Bidirectional converter 1210 can route current from ports 7 and 8 to charge sources 206A and 206B (through converter 202B,C), route current from ports 7 and 8 to power the load (by output from converter 202B,C to ports 1 and 2), route current from sources 206A and/or 206B, with converter 202B,C, to ports 7 and 8 for powering one or more high voltage auxiliary loads via auxiliary converter 1150 (FIG. 11F), and route current from sources 206A and/or 206B via converter 202B,C to ports 7 and 8 for charging other modules 108 of system 100 by way of lines 1130.

Bidirectional converter 1210 is connected between I/O ports 7 and 8 and buffer 204 includes DC-AC converter 1202, connected to transformer 1206, which in turn is connected to AC-DC converter 1208. Converter 1202 can convert the DC voltage at ports 7 and 8 into a high-frequency AC voltage, which transformer 1206 can modify to a lower voltage if needed, and output that modified AC voltage to AC-DC converter 1208, which can convert the AC signal back into DC form for provision to sources 206A, 206B, or module ports 1 and 2. Transformer 1206 can also isolate module components 202, 204, 206, 1208, and 114 from the high voltage at ports 7 and 8. As with the other components of module 108E, monitor circuitry for converter 1202, transformer 1206, and converter 1208 can be included to measure currents, voltages, temperatures, faults, and the like. LCD 114 can monitor the status of converter 1210, particularly converter 1202, transformer 1206, e.g., monitor circuitry or an active component associated therewith), and converter 1208, over data connections 118-5, 118-7, and 118-8, respectively. These connections 118-5 and 118-6 can also supply control signals to control switching of converter 1202 and to control any controllable elements associated with transformer 1206. Isolation of LCD 114 can be maintained by isolation circuitry present on lines 118-5 and 118-6, e.g., isolated gate drivers and isolated sensors.

Furthermore, for electrochemical battery sources 206, the length of the charge pulses applied to sources 206 by AC-DC converter 1208 can be maintained to have a certain length, e.g., less than 5 milliseconds, to promote the occurrence of the electrochemical storage reaction in the cells without the occurrence of significant side reactions that can lead to degradation. The charge methodology can incorporate active feedback from each energy source to ensure that battery degradation, if detected, is mitigated by lowering voltage or pausing the charge routine for that module, or otherwise. Such pulses can be applied at high C rates, e.g., 5 C-15 C and greater, to enable fast charging of the sources 206. The duration and frequency of the charge pulses can be controlled by control system 102. Examples of such techniques that can be used with all embodiments described herein are described in Int'l Appl. No. PCT/US20/35437, titled Advanced Battery Charging on Modular Levels of Energy Storage Systems, which is incorporated by reference herein for all purposes.

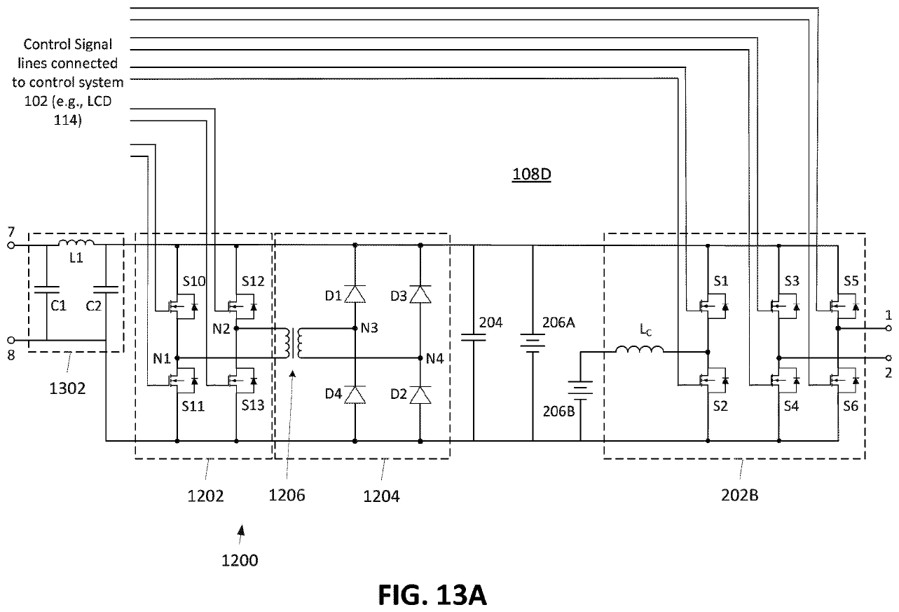

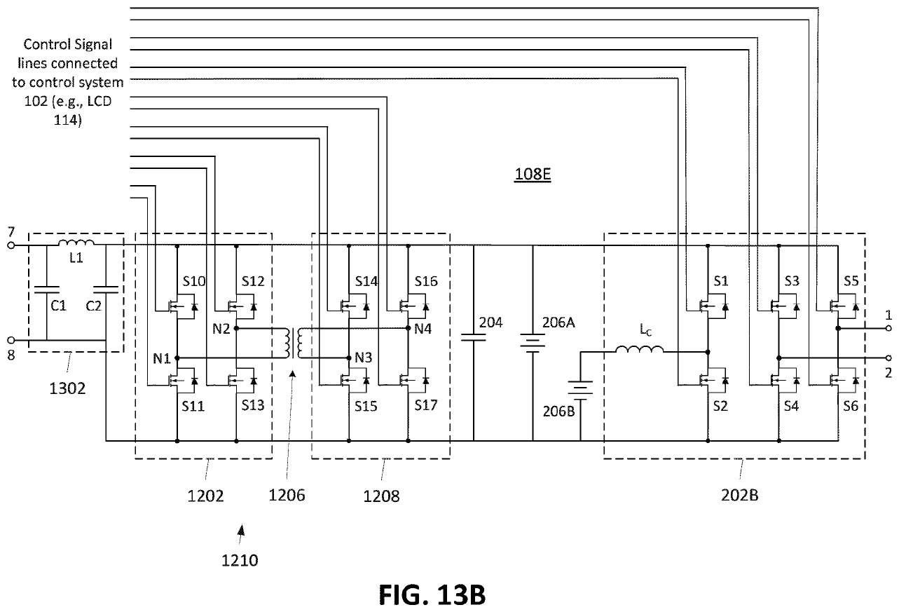

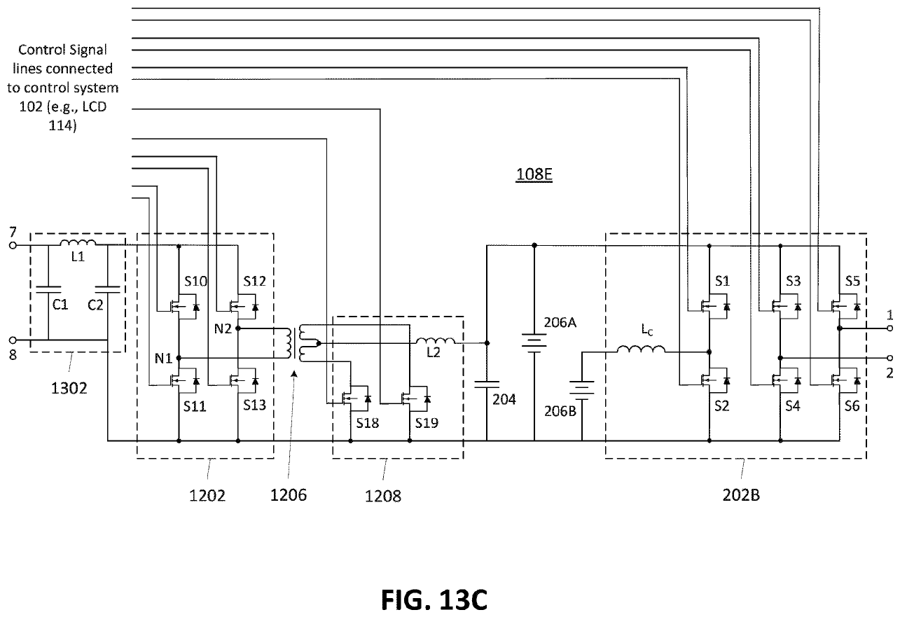

FIG. 13A is a schematic diagram depicting an example embodiment of module 108D. Converter 202B is coupled with secondary source 206B, and in other embodiments can be configured like converter 202C (FIG. 6C). Buffer 204 is configured here as a capacitor. I/O ports 7 and 8 are coupled to an LC filter 1302, which is in turn coupled to bidirectional converter 1210, specifically DC-AC converter 1202, which is configured as a full bridge converter with switches S10, S11, S12, and S13. LC filter 1302 can be a distributed DC filter that can filter harmonics from and to the DC lines 1130, provide a current slowing function if desired, and/or perform other functions. The full bridge outputs from nodes N1 and N2 are connected to a primary winding of transformer 1206 within section 1204. A secondary winding of transformer 1206 is coupled with nodes N3 and N4 of the diode rectifier of section 1204, having diodes D1-D4. The switches of converter 1202 can be semiconductor switches configured as MOSFETs, IGBT's, GaN devices, or others as described herein. LCD 114 or another element of control system 102 can provide the switching signals for control of switches S1-S6 and S10-S13. Along with the other functions described herein, converter 202B can be controlled to independently route current from ports 7 and 8 to source 206B for charging, or to I/O ports 1 and 2 for powering the motor loads 1110.

FIG. 13B is a schematic diagram depicting an example embodiment of module 108E. Converter 202B is coupled with secondary source 206B, and in other embodiments can be configured like converter 202C (FIG. 6C). Buffer 204 is configured as a capacitor. I/O ports 7 and 8 are coupled to an LC filter 1302, which is in turn coupled to bidirectional converter 1210, specifically DC-AC converter 1202, which is configured as a full bridge converter with switches S10, S11, S12, and S13. The full bridge outputs from nodes N1 and N2 are connected to a primary winding of transformer 1206. A secondary winding of transformer 1206 is coupled with nodes N3 and N4 of a second full bridge circuit configured as AC-DC converter 1208, having switches S14, S15, S16, and S17. The switches of converter 1208 can be semiconductor switches configured as MOSFETs, IGBT's, GaN devices, or others as described herein. LCD 114 or another element of control system 102 can provide the switching signals for control of switches S1-S6 and S10-S17. Along with the other functions described herein, converter 202B can be controlled to independently route current from ports 7 and 8 to source 206B for charging, or to I/O ports 1 and 2 for powering the motor loads.

FIG. 13C is a schematic diagram depicting another example embodiment of module 108E, where AC-DC converter 1208 is configured as a push-pull converter with a first terminal of source 206 connected to one side of dual secondary windings of transformer 1206 through an inductor L2, and switches S18 and S19 connected between the opposite side of dual secondary windings and a common node, e.g., node 4, coupled with the opposite terminal of source 206. The push-pull configuration only requires two switches and thus is more cost-effective than a full bridge converter, although the switches have larger voltages applied across them.

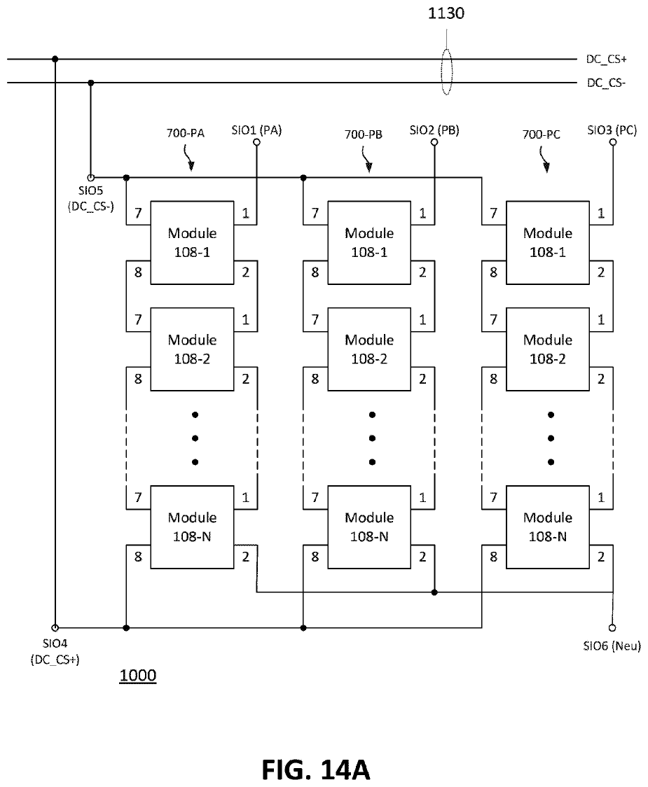

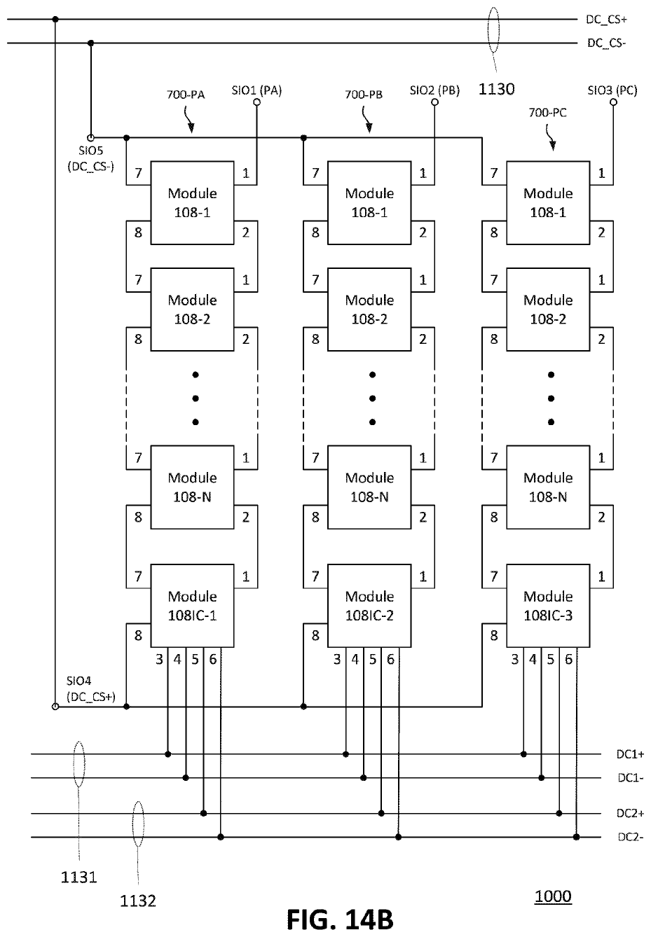

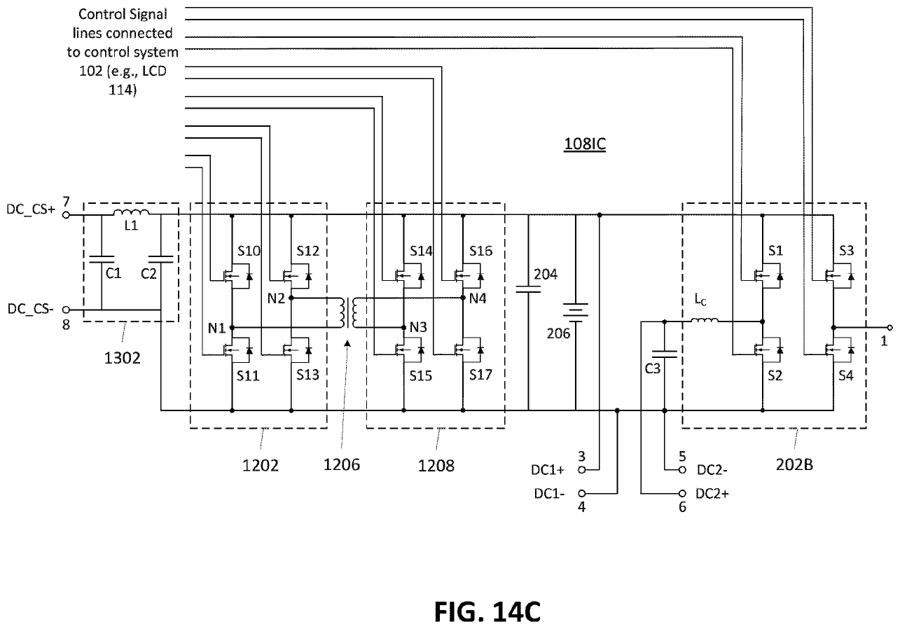

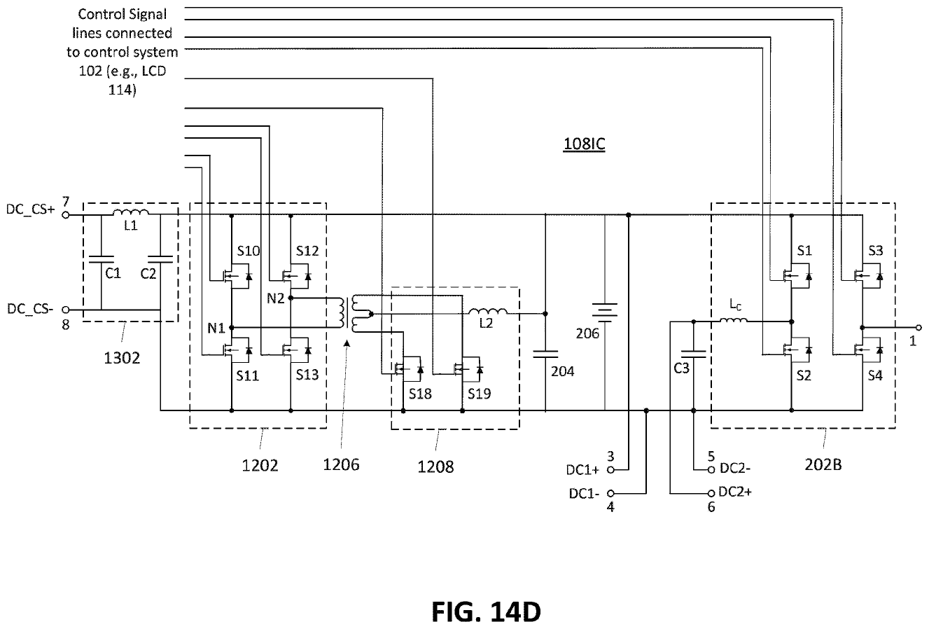

FIG. 14A is a block diagram depicting an example embodiment of subsystem 1000 configured to supply three-phase power for two motors 1110-1 and 1110-2 in parallel. This embodiment includes three serial arrays 700-PA, 700-PB, and 700-PC with modules 108 arranged in cascaded fashion with ports 1 and 2 daisy-chained between modules as described elsewhere herein. Subsystem 1000 has three arrays 700-PA, 700-PB, and 700-PC for supplying three-phase power to one or more loads 1112 by way of system ports SIO1, SIO2, and SIO3. In this embodiment and that of FIG. 14B, each of modules 108 can be configured as module 108D (FIG. 12A) or module 108E (FIGS. 12B, 13A, 13B). A neutral signal is available at SIO6(N) if desired. The DC voltage signals DC_CS+ and DC_CS− supplied from lines 1130 are supplied to subsystem 1000 by system I/O ports SIO4 and SIO5, respectively. Ports 7 and 8 of each of modules 108 are daisy-chained such that the applied charge source voltage is divided across modules 108-1 through 108-N of each array 700. As with other embodiments, subsystem 1000 can be configured with N modules 108 in each array 700, where N can be any integer two or greater.

FIG. 14B is a block diagram depicting another example embodiment of subsystem 1000 configured to supply three-phase power for motors 1110-1 and 1110-2, and also having modules 108IC-1, 108IC-2, and 108IC-3. Modules 108IC can have interconnected energy sources 206 and can be configured for interphase balancing between arrays 700 as described elsewhere herein. Modules 108IC can also be configured to supply DC voltages to lines 1131 and 1132 for one or more auxiliary loads 301 and/or one or more auxiliary loads 302. The example embodiments of FIGS. 14A and 14B can be used as any of the subsystems 1000-1 through 1000-4 as described with reference to FIGS. 11D and 11E, depending on whether each subsystem 1000 is configured to supply power for auxiliary loads and is configured with interphase balancing capability through interconnected modules 108IC.

FIGS. 14C and 14D are schematic diagrams depicting example embodiments of module 108IC configured for use with the embodiment of FIG. 14B. In this embodiment module 108IC is configured with a single switch portion 604 configured to connect IO port 1 to either positive DC voltage of source 206 (port 3) or negative DC voltage of source 206 (port 4). A switch portion 602A regulates and steps down the voltage of source 206 for provision as the auxiliary load voltage for lines 1132. A filter capacitor C3 can be placed across ports 5 and 6. Module 108IC includes bidirectional converter 1210 configured with two full bridge converters similar to that of FIG. 13A. FIG. 14D depicts another embodiment where AC-DC converter 1208 is configured as a push-pull converter similar to the embodiment of FIG. 13B.

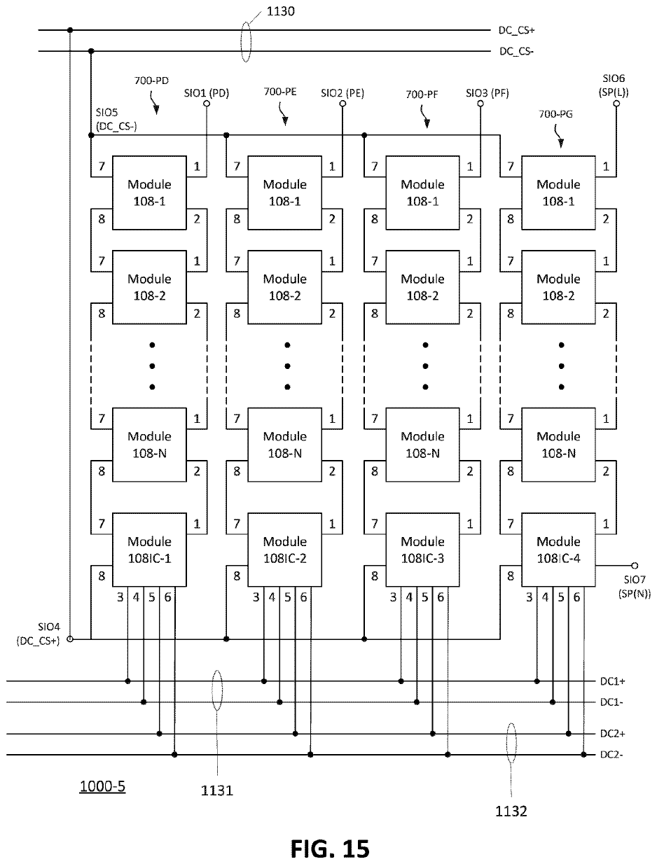

FIG. 15 is a block diagram depicting an example embodiment of subsystem 1000-5 configured to supply multiphase, single phase, and DC power for auxiliary loads of tram 1100. Subsystem 1000-5 has three arrays 700-PD, 700-PE, and 700-PF for supplying three-phase power to one or more loads 1112 by way of system ports SIO1, SIO2, and SIO3. Subsystem 1000-5 has a fourth array 700-PG for supplying single phase power to one or more loads 1114 by way of system outputs SIO6 (SP(L)) and SIO7 (SP(N)). Subsystem 1000-5 can be configured to supply power of as many different phases as necessary through the addition of further arrays 700. A number of modules 108 within each array can be varied depending on the voltage requirements of the load. For example, although all arrays 700 are shown here as having N modules 108, the value of N can differ between arrays. Each of the N modules 108 of each array 700 can be configured like module 108D (FIG. 13A) or module 108E (FIG. 13B).

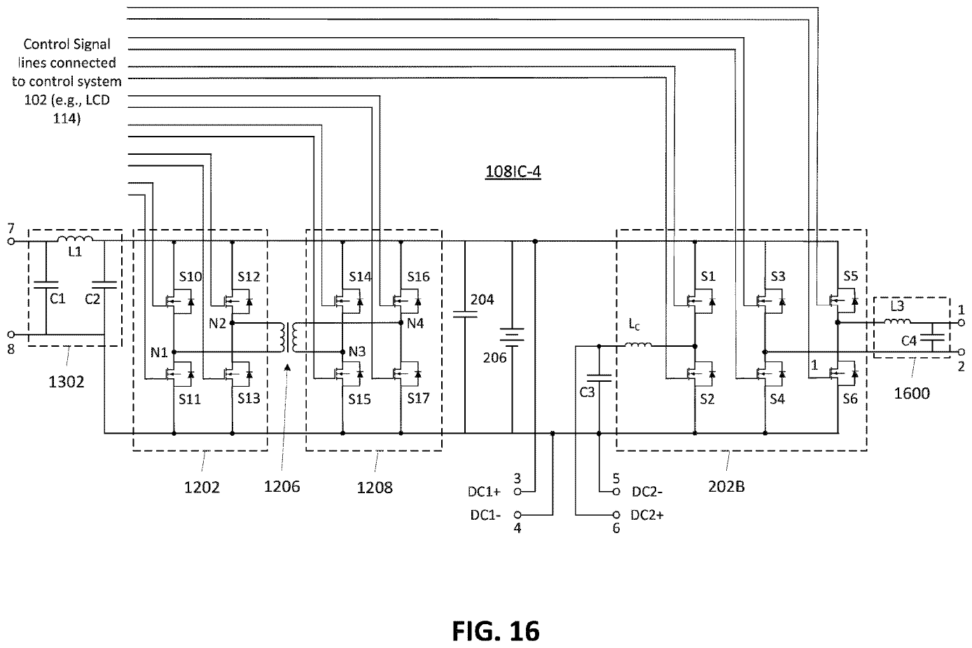

Each array 700 can also include a module 108IC having interconnected sources 206 for energy sharing and interphase balancing. Modules 108IC-1 through 108IC-3 can be configured like the embodiments described with reference to FIGS. 14A and 14B. FIG. 16 is a block diagram depicting an example embodiment of module 108IC-4 for use in single phase array 700-PD. This embodiment is similar to that of FIG. 14A, except module 108IC-4 includes two switch portions 604-1 and 604-2. Portions 604-1 and 604-2 are configured to independently connect IO ports 1 and 2, respectively, to either VDCL+ (port 3) or VDCL− (port 4). I/O port 1 can be connected to port 2 of module 108-N of array 700-PD as shown in FIG. 15. I/O port 2 can serve as a neutral for the power provided by array 700-PD. An LC circuit 1600 can be connected between ports 1 and 2 as shown to provide filtering of harmonics.

In some implementations, a separate subsystem 1000 may not be needed to generate the requisite three-phase and single phase voltages for auxiliary loads. In such embodiments, subsystem 1000-5 can be omitted and an auxiliary power converter can be used to instead generate the three-phase in single phase auxiliary load voltages. This auxiliary converter can be connected to DC charge source lines 1130 and can receive power either from charge source 150 or the other subsystems 1000 when charge source 150 is not connected.

The use of bidirectional converters 1210 in the modules of subsystems 1000-1 through 1000-5 allows those subsystems to supply relatively higher DC voltages across lines 1130, for example in a configuration where a large auxiliary load, such as a battery thermal management system (BTMS), is powered directly from lines 1130. In such an instance the auxiliary load connected across lines 1130 can be powered directly by the charge source when connected to tram 1100 and then can be powered by one or more subsystems 1000 outputting power from sources 206 through bidirectional converters 1210 of each module 108.

The embodiments disclosed herein are not limited to operation with any particular voltage, current, or power. By way of example and for purposes of context, in one sample implementation charge source 150 may provide a voltage of 600-1000V on lines 1130. Each of subsystems 1000-1 through 1000-4 may provide multiphase voltages that are regulated and stabilized by voltage and frequency if required, in those voltages may be 300-1000V depending on the needs of the motors. An example three-phase auxiliary voltage for load 1112 can be 300-500V, regulated and stabilized as needed. An example single phase auxiliary voltage for load 1114 can be 120-240V, regulated and stabilized as needed. Example auxiliary voltages for load 301 can be 48-60V and example auxiliary voltages for load 302 can be 24-30V. Again these are examples only for purposes of context and the voltages that system 100 can provide will vary depending on the needs of the application.

To maintain a balanced overall system, the energy of sources 206 of auxiliary subsystem 1000-5 can be transferred to any of the non-auxiliary subsystems 1000-1 through 1000-4 by way of lines 1131 and the shared interconnection module connections, and this energy can be used either for charging those subsystems 1000-1 through 1000-4 or supply to the motors. Thus energy from auxiliary subsystem 1000-5 can be used to power one or more motors even though not directly connected to those motors, but rather indirectly connected to those motors by way of one or more other subsystems 1000-1 through 1000-4. Similarly, energy recovered through braking can be shared between subsystems 1000-1 through 1000-5 by way of lines 1131 and the shared interconnection module connections.

### Example Embodiments of Current Control for Multiple Sources

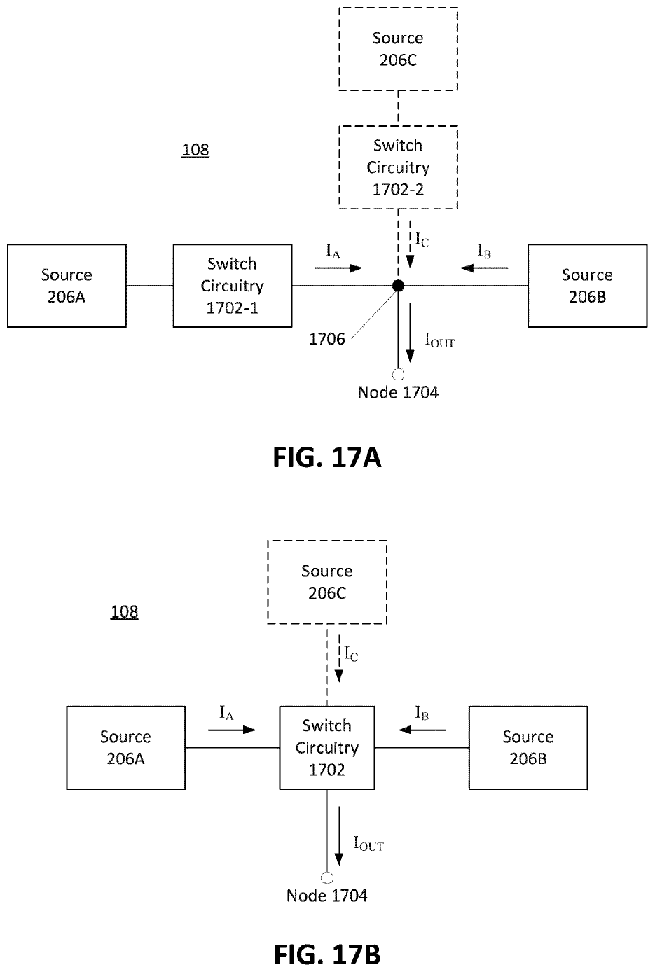

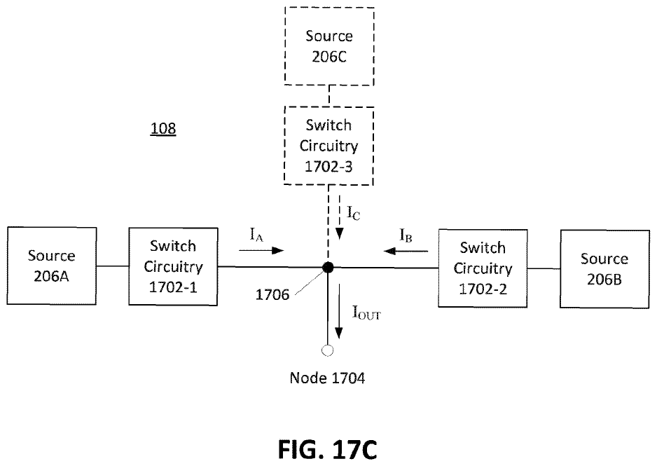

Example embodiments pertaining to the control of systems having multiple discretely controllable energy sources are now described with reference to FIGS. 17A-28D. These embodiments can be implemented with all aspects of system 100 described with reference to FIGS. 1A-16 and elsewhere thus far, unless stated otherwise. As such, many variations of multiple energy source configurations and control are contemplated herein.

The present embodiments can be implemented in systems having two or more energy sources, regardless of whether they are in a cascaded arrangement, provided the sources are discretely controllable such that the power supplied by one source can be controlled, e.g., varied, with respect to the power supplied by at least one other source.

Several example embodiments of different control configurations are described with reference to FIGS. 17A-17C, and these embodiments can represent configurations of a non-cascaded energy storage system, or configurations of one or more modules 108 or subsystems 1000 within a cascaded system 100 such as described with reference to FIGS. 1-10F. In the first example of FIG. 17A, a first energy source 206A is connected to switch circuitry 1702-1 that is, in turn, connected to an output node 1704 having an output current (I_{OUT}) associated with it. The magnitude of I_{OUT} is determined by the load requirements placed on the module or system. A second energy source 206B is also connected to output node 1704 through a shared node 1706. In the second example of FIG. 17B, first and second energy sources 206A and 206B are each connected to switch circuitry 1702 that is, in turn, connected to output node 1704. In the third example of FIG. 17C, first energy source 206A is connected to first switch circuitry 1702-1, which is connected to output node 1704. Second energy source 206B is connected to second switch circuitry 1702-2 which is connected to output node 1704 through shared node 1706. Each embodiment can be implemented with more than two energy sources 206A,B as indicated by the sources 206C and the switch circuitry shown with dashed lines.

In each of the examples of FIGS. 17A-17C, the currents from the sources are discretely controllable such that I_{OUT} is equal to the sum of the currents of each individual source 206: I_{OUT}=I_{A}+I_{B} . . . +I_{N}, where N is the number of sources 206. Current directional arrows are shown for an example where each embodiment is in the discharge state. A source 206 can thus be discretely controllable without dedicated control circuitry assigned specifically to that source, as with source 206B in a two source embodiment like FIG. 17A, where controlled variation of I_{A} for a given I_{OUT} also sets I_{B} (I_{B}=I_{A}−I_{OUT}).

The inclusion of multiple energy sources in a system can provide numerous benefits. Having multiple energy sources of the same class, type and electrical characteristics increases the energy and power capacity of the system or module. Mixing multiple energy sources of different classes, e.g., battery, HED capacitor, fuel cell, different types within each class, e.g., different chemistries, different structural designs, and/or different electrical operating characteristics, e.g., different nominal voltages, capacities, capacitances, maximum power outputs, etc.) also increases the energy and power capacity of the system, subsystem, or module, but in a manner that can provide improvements in other respects where the sources differ. Such differences can be in terms of energy density, power density, cost, lifespan or cyclability, safety, operating range, e.g., voltage, temperature, capacity, and/or charge time, to name a few examples. Thus, source classes, types, and/or electrical characteristics can be mixed in a wide variety of different combinations to achieve superior performance over those aspects in which the sources differ, with such differences being selected to tailor the system for a particular application.

For example, a system or module may have a first energy source of a first class, e.g., an HED capacitor, and a second energy source of a second class, e.g., a battery. By way of another example the system or module may have a first battery source of a first type, e.g., LTO, and a second battery source of a second type, e.g., NMC. In both examples the first source may have a relatively higher power density and a relatively lower energy density, thus making it desirable to utilize the first source more than the second source during operation times requiring high power, while the second source may have a relatively lower power density and relatively higher energy density, thus making utilization of the second source preferred over the first source during operation at lower power levels for prolonged periods of time.

In other embodiments, the system or module can have a renewable energy source, such as a photovoltaic (PV) device, e.g., a solar panel or a wind-harnessing energy device, as a first source instead of using a stored energy source. The second energy source can be a stored energy source such as a battery, e.g., LTO or NMC. The system or module can utilize the first source to a relatively higher degree during times when the renewable energy is available and power requirements are higher, and the second source for meeting relatively lower power requirements but for longer periods of operation, e.g., higher energy density.

Although not limited to such, the following current control embodiments will be described in the context of a cascaded system 100 where one or more modules 108 have multiple discretely controllable energy sources 206.

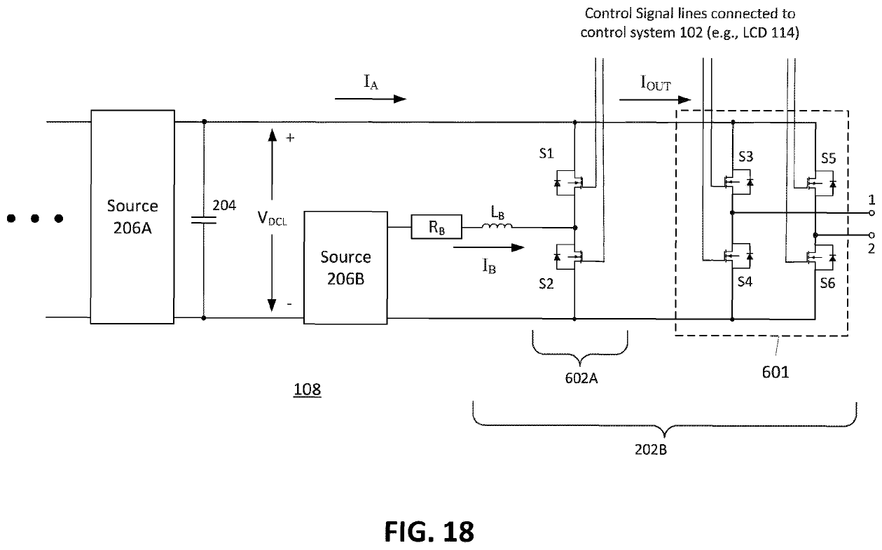

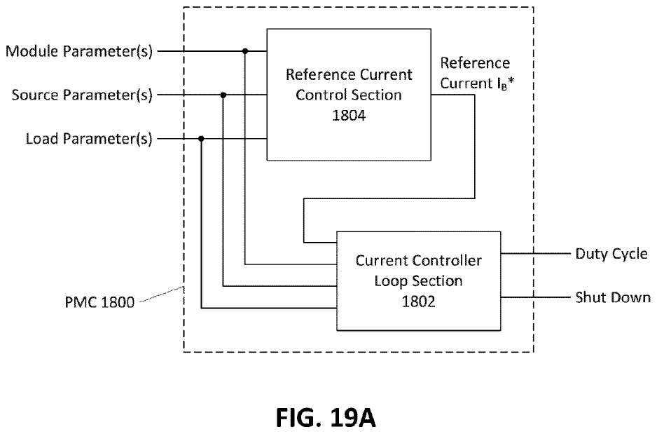

Example embodiments of modules 108 having multiple sources 206 are described with respect to module 108B of FIG. 3B, module 108D of FIGS. 12A and 13A, and module 108E of FIGS. 12B, 13B and 13C. Those embodiments each include sources 206A, 206B, inductor L_{B} and converter 202B, having switch circuitry 601 and 602A, all of which are summarily depicted in the schematic view of FIG. 18. Other elements of these embodiments, e.g., DC-DC converter 1200 or 1210, can be positioned at left of the figure and are omitted for clarity. Also shown is a resistor RB coupled between source 206B and L_{B}. Other converter designs can alternatively be implemented, such as converter 202C.

The current output by source 206A is equivalent to I_{A}, the current output by source 206B is equivalent to I_{B}, and the current output by switch circuitry 602A to switch circuitry 601 is equivalent to I_{OUT}, as described with reference to FIGS. 17A-17C. Control system 102 (not shown) can control the switch circuitry 602A of converter 202B, via switch circuitry control lines, to discretely adjust the current I_{B} supplied by source 206B, which in turn determines the current I_{A} supplied by source 206A.

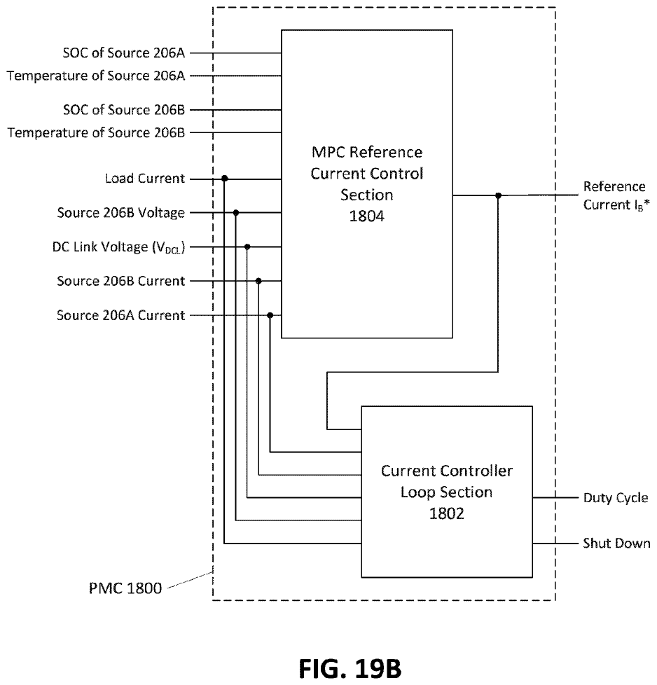

FIG. 19A is a block diagram depicting an example embodiment of a power management controller (PMC) 1800 configured to manage the respective amounts of power or energy supplied by or applied to energy sources 206A and 206B. PMC 1800 can perform this power management task to meet the demands of the load in a manner that concurrently seeks to maintain balance in one or more parameters of sources 206A and 206B, e.g., SOC, T, Q, SOH, V, I. When implemented in a cascaded system 100, PMC 1800 can be used to control relative power utilization between the two or more sources 206 within each module 108. PMC 1800 can be implemented locally with respect to each module 108, e.g., within LCD 114 or as a separate discrete controller), or can be implemented at a higher level in the control hierarchy, e.g., within MCD 112. In both cases PMC 1800 can be used in conjunction with balancing control embodiments described previously herein, e.g., controllers 900 and 950. PMC 1800 can be implemented in hardware, software, e.g., as instructions executed by processing circuitry, or a combination thereof within control system 102. The techniques applied by PMC 1800 can also be utilized outside of a cascaded system topology.

PMC 1800 can be provided with information assessing the present or recent state of module 108 and its sources 206, and the load requirements, and on this basis generate control information that can be used to generate control signals for switch circuitry 602A to discretely control the current (I_{B}) output by source 206B when system 100 is in a discharge state. In this embodiment, PMC 1800 includes a current controller loop section 1802 and a reference current control section 1804. Reference current control section 1804 can generate a reference current I_{B}* based on at least one measured or estimated operating parameter of each source 206 and based on a measured or estimated current or power requirement of the load. Determination of reference current I_{B}* can also be based on whether the load power requirements are relatively constant, e.g., steady-state, or changing, e.g., transient. The generated reference current I_{B}* can be used by current controller loop section 1802, along with information about the present state of module 108, to generate duty cycle information for switch circuitry 602A. This duty cycle information can then be used to generate control signals that drive the individual switches S1 and S2 into on-off states, e.g., S1 is on while S2 is off, and S1 is off while S2 is on, at a rate that sets the actual time average current I_{B} consistent with I_{B}*.

The reference current I_{B}* can be generated such that the at least one measured or estimated operating parameter of each source 206 converges towards a balanced condition if unbalanced, or is maintained in a balanced condition if already balanced, provided that balancing does not prevent achievement of the power output requirements of module 108 at any one time. This operating parameter can be, e.g., one of SOC, temperature, capacity, SOH, voltage, or current of the sources 206A and 206B. Many aspects of balancing are already described herein and likewise apply to these embodiments. At times, as discussed in further detail below, the reference current I_{B}* can be modified by an amplification modifier, which can be used to adjust a rate of convergence of the operating parameter of each source 206. For example, as described below with reference to FIGS. 33-34 below, the amplification modifier can be adjusted based in part on an operating state of a load 101 coupled to system 100.

Since balancing all parameters may not be possible at the same time, e.g., balancing of one parameter may further unbalance another parameter), a combination of balancing any two or more parameters (SOC, T, Q, SOH, V, I) may be applied with priority given to either one depending on the requirements of the application. For example, priority in balancing can be given to SOC over other parameters (T, Q, SOH, V, I), with exceptions made if one of the other parameters (T, Q, SOH, V, I) reaches a severe unbalanced condition outside a threshold.

In some implementations, PMC 1800 can be provided user input via a user terminal 1806. User terminal 1806 is an example of an external device 104. A user terminal 1806 can be in data communication with PMC 1800 such that a user can input control parameters into graphical user interface 1808 of user input terminal 1806 and/or view current control parameters, balance factors, operating parameters of loads, and/or other characteristics of system 100. For example, user terminal 1806 can be communicatively coupled to PMC 1800 via wired or wireless paths or links 1809. In an electric vehicle embodiment, the user terminal 1806 can be implemented as part of a vehicle information display or a separate display. In stationary embodiments, e.g., as part of a charging station, user terminal 1806 can be included in a cabinet or other structure that houses system 100 and include a display that presents graphical user interface 1808.

In electric vehicle and other embodiments, user terminal 1806 can be a remote terminal communicatively coupled to PMC 1800 over a wired or wireless network. For example, user terminal 1806 can be include a cloud-based server that provides graphical user interface 1808 to client devices communicatively coupled to the cloud-based server.

User terminal 1806 can include input controls, e.g., analog or digital knobs, to facilitate a user input of control parameters to PMC 1800. User terminal 1806 can include virtual input controls though graphical user interface 1808 to facilitate a user input of control parameters to PMC 1800. Input control parameters can include, for example, tunable adjustment parameters for adjusting balance factors used in balancing techniques described herein. User input terminal 1806 can be in data communication with PMC 1800 such that a user can input tunable adjustment parameters into graphical user interface 1808 of user input terminal 1806. User input terminal 1806 can include tuning knobs, e.g., analog or digital knobs, to facilitate a user input of tunable adjustment parameters to PMC 1800. User input terminal 1806 can include virtual tuning knobs though graphical user interface 1808 to facilitate a user input of tunable adjustment parameters to PMC 1800. In another example, user input terminal 1806 can include physical user input components, e.g., circular knobs or vertical or horizonal sliders, that enable the user to adjust the tunable adjustment parameters, e.g., by turning a knob or moving sliders with their hands.

### Example Embodiments Balancing SOC and Temperature

Example embodiments are now described where PMC 1800 controls the source currents while balancing SOC and temperature of the two sources 206A and 206B. The aspects of these examples can be applied to other embodiments seeking to balance one, two, three, or more different operating parameters of two or more sources 206.

FIG. 19B is a block diagram depicting another example embodiment of PMC 1800. Here, PMC 1800 is configured to the output currents of sources 206A and 206B while seeking to maintain SOC balance between the sources as well as temperature balance between the sources. Parameters can be provided to PMC 1800, including both of sections 1802 and 1804, that is descriptive of the sources, e.g., voltage of source 206A, voltage of source 206B, current of source 206A, current of source 206B, temperature of source 206A, and temperature of source 206B), descriptive of the module, e.g., the DC-link voltage V_{DCL}), and descriptive of the load, e.g., load current or power. Reference current control section 1804 can use these parameters to generate reference current I_{B}* and output that to current controller loop section 1802, which in turn can generate the duty cycle information (DB). PMC 1800 can also optionally output I_{B}*, e.g., as shown here, to other devices or aspects of control system 102, such as for data logging or performance monitoring purposes. A duty cycle of 50% corresponds to a time average current of zero from source 206B, while duty cycles greater than 50% and lower than 50% correspond average net discharge and charge depending on convention. For example, a duty cycle increasing from 50% can correspond to an increasing proportion of I_{OUT} that is supplied by I_{B}, and a decreasing proportion of a I_{OUT} that is supplied by I_{A}. The duty cycle information can be used to generate control signals for switch circuitry 602A by the same device as that having PMC 1800 or a different device. Section 1802 can also generate a termination or shut down signal to cease operation of switch circuitry 602A.

Current controller loop section 1802 can be configured according to various control architectures. In this embodiment, section 1802 is configured with a model predictive control (MPC) architecture that exhibits a fast response and can compensate for errors in the measured parameters. In another embodiment section 1802 can be implemented as a proportional-integral (PI) or proportional-integral-derivative (PID) controller.

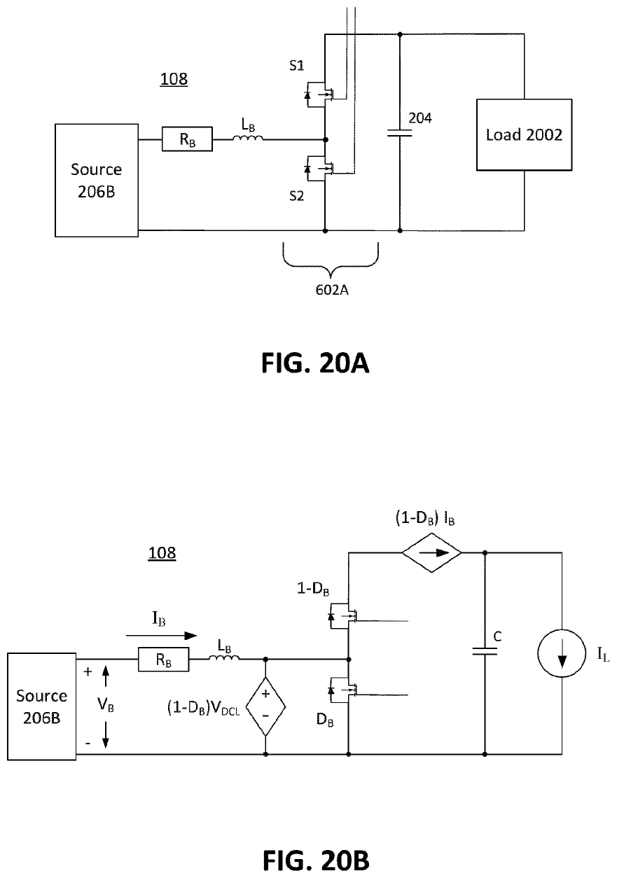

FIG. 20A is a schematic diagram depicting portions of module 108 passing current from and to source 206B. For simplification the switch circuitry 601 portion of converter 202 is lumped together and modeled as part of the load 2002. FIG. 20B is a time average model of FIG. 20A. Using this time average model, the voltage of source 206B can be expressed as (1):

$${V}_{B} = {R}_{B} {I}_{B} + {L}_{B} ( \frac{{dI}_{B}}{dt} ) + ( 1 - {D}_{B} ) {V}_{DCL} \qquad ( 1 )$$

The voltage of source 206B (VB), the current from source 206B (I_{B}), and the DC-link voltage (V_{DCL}) are measured at each sampling instant j and this information is provided to PMC 1800. Taking of this measurement can be coordinated by PMC 1800, e.g., controlling monitor circuitry 208, or another element of control system 102.

The variations of VB and V_{DCL} typically occur slower in time than variations in I_{B}. In the time domain, V_{B} [j+1] and V_{DCL} [j+1] are assumed to be equal to their measured values at the jth sampling instant. Using the Euler approximation, the variables can be expressed as (2), where T_{S}=1/f_{SF}, with f_{SF} being the sampling frequency which can be equal to the switching frequency of switch circuitry 601 of converter 202:

$$\frac{{dI}_{B}}{dt} = \frac{{I}_{B} [ j + 1 ] - {I}_{B} [ j ]}{{T}_{S}} \qquad ( 2 )$$

Using these equations to satisfy I_{B} [j+1]=I_{B}*, D_{B} can be expressed as (3):

$${D}_{B} [ j ] = 1 + \frac{{R}_{B} {I}_{B} [ j ] + ( {I}_{B} * - {I}_{B} [ j ] ) {L}_{B} {f}_{SF} - {V}_{B}}{{V}_{DCL}} \qquad ( 3 )$$

The reference current I_{B}* can be calculated by reference current control section 1804 and provided to section 1802 as described below. Determination of D_{B} [j] can be performed by current controller loop section 1802 and this information can be used to produce the drive signals for switching circuitry 602A, which in turn will set the actual current I_{B}.

The power of source 206B (P_{B}) in an environment, e.g., module, with two sources can be expressed as shown in (4), where balancing of N parameters concurrently is desired:

$${P}_{B} = [ 0.5 + {K}_{R 1} ( R {1}_{B} - R {1}_{AVE} ) + {K}_{R 2} ( R {2}_{B} - R {2}_{AVE} ) … + {K}_{RN} ( {RN}_{B} - {RN}_{AVE} ) ] * {P}_{L} \qquad ( 4 )$$

where R1 is a first parameter being balanced, K_{R1} is a balance factor for the first parameter, R1_{B} is the value of the first parameter for source 206B, R1_{AVE} is the average value of R1 for the two sources, R2 is a second parameter being balanced, K_{R2} is a balance factor for the second parameter, R2_{B} is the value of the second parameter for source 206B, R2_{AVE} is the average value of R2 for the two sources, and so forth for the N parameters, where R^{N} is an Nth parameter being balanced, K_{RN} is a balance factor for the Nth parameter, RNB is the value of the Nth parameter for source 206B, and RN_{AVE} is the average value of RN for the two sources. The sign (+/−) of each balancing term, e.g., K_{R1}(R_{1B}−R_{1AVE}), can be selected based on whether that balancing term should tend to increase or decrease current of source 206B to rectify a particular imbalance.

Equation 4 can be tailored specifically for the example where SOC and temperature are concurrently balanced, as shown in Equation 5:

$${P}_{B} = [ 0.5 + {K}_{SOC} ( {SOC}_{B} - {SOC}_{AVE} ) - {K}_{Temp} ( {T}_{B} - {T}_{AVE} ) ] * {P}_{L} \qquad ( 5 )$$

where P_{L} is the power demanded or supplied by the load 2002, SOC_{B} is the state of charge of source 206B, SOC_{AVE} is the average state of charge of sources 206A and 206B, TB is the temperature of source 206B, T_{AVE} is the average temperature of sources 206A and 206B, K_{SOC} is a balancing factor, e.g., also referred to herein as a “balance factor”, for SOC, and K_{Temp} is a balancing factor for temperature. The value of P_{L} can be provided to PMC 1800 by control system 102 or an external control device 104, e.g., a motor or demand controller. SOC and temperature values can be measured via one or more sensors or measurement circuits, or estimated using an estimation function or algorithm, e.g., SOC can be determined through use of Coulomb counting. The balance factors, e.g., K_{SOC} and K_{Temp}, can be determined in a number of different ways as will be described.

Reference current control section 1804 can utilize Equation 5 to determine the desired reference power PB of source 206B, and from this the desired reference current I_{B}*, which can be used in turn by section 1802 to determine the duty cycle DB. For this example, Equation 5 can be used to select a desired current of source 206B that, along with the current of source 206A according to I_{A}=I_{OUT}−I_{B}, will meet the present requirements of the load 2002, while concurrently considering the present SOC and temperature of each of sources 206A and 206B, and adjusting the relative current of each source to: cause the sources to maintain balance in SOC and temperature, to cause the sources to converge towards a balanced target value, e.g., a target value for a balanced condition, for SOC and/or temperature, or to minimize divergence of the sources away from a balanced target value for SOC and/or temperature. At times, it may be desirable to control the relative current of each source 206 based in part of a rate of convergence of the operating parameters, e.g., SOC or temperature, of the source 206 towards a target value.

There may be conditions or limitations that render it undesirable to seek balance while controlling the current. PMC 1800 may detect or consider such conditions or limitations and, in response, control current without applying balancing rules. For example, PMC 1800 can control the current without violation of maximum charge or discharge current thresholds for each of sources 206. One of the sources may reach its maximum current requiring the difference to be made up by the other source even though that source is lower in SOC or higher in temperature. Other examples may be specific to the specific operating configuration of system 100. For example, in an embodiment where source 206B has a relatively higher power density than source 206A, it may be desirable to utilize source 206B primarily or exclusively to meet the load demands in times of transient or higher than normal current, which may cause the sources to diverge from a balanced condition. When the transient condition concludes, continued operation of PMC 1800 will cause the sources to converge towards a balanced condition. In another example, it may be desirable under certain load conditions, e.g., operating conditions of a motor coupled to the system, to adjust a rate of balancing, e.g., a rate of convergence, of the source 206. This may occur within certain ranges of speed and/or torque values of the motor, e.g., high speed and/or high torque conditions, where an amount of current control that is available to seek balance is small and where seeking to balance the outputs of the sources may lead to unstable operating conditions of system. Further discussion of adjusting the relative current of each source 206 in accordance with a rate of convergence is found with reference to FIGS. 33-34.

The balance factors K_{SOC} and K_{Temp} control how gainively an imbalance in SOC and temperature are addressed, e.g., a relatively higher balance factor corresponds to a relatively higher disparity between source output currents. PMC 1800 can reference the SOC value of both sources, identify which has the lower SOC value, and utilize this SOC value to select or determine K_{SOC}. Similarly, PMC 1800 can reference the temperature of both sources, identify which has the lower temperature, and utilize this temperature value to select or determine K_{Temp}.

While a single constant value can be used as a balance factor for a range of SOC and temperature values, the use of variable balance factors enables the system to compensate for imbalances differently depending on the source conditions, e.g., SOC and temperature, or conditions of other elements of the module or system, e.g., cooling system load), or conditions of elements coupled to the system, e.g., a motor or other load coupled to the system. For example, as states of charge decrease, it can be desirable to likewise decrease the SOC balance factor K_{SOC} in order to maintain operating margins in available energy. Similarly, as battery temperatures increase, it can be desirable to likewise increase the temperature balance factor K_{Temp} in order to stay within the battery's operating range.

Referring back to (5), a positive value for the term (+K_{SOC}(SOC_{B}−SOC_{AVE})) indicates an unbalanced condition with source 206B having a higher SOC than source 206A, and will tend to increase current from source 206B to balance the SOC values. A negative value for the subsequent term (−K_{Temp}(T_{B}−T_{AVE})) indicates an unbalanced condition with source 206B having a higher temperature than source 206A, and will tend to decrease current from source 206B. The relative values of the terms depend on the value of the balance factor and the magnitude of the difference between source 206B's value and the average. Thus the variable balance factor linked to the actual SOC and temperature of one or both sources allows PMC 1800 to prioritize balancing of one parameter over the other. For example, if sources 206A and 206B have comparable differences in SOC and temperature, with SOC in a moderate range and temperatures in a relatively high range, then PMC 1800 will prioritize balancing of temperature over SOC through execution of Equation 5.

The balance factors can be one or more discrete values stored in memory in the form of a data structure, e.g., one or more arrays or lookup tables, expressed in or accessible by the program instructions of control system 102, e.g., PMC 1800. The balance factors can also, or alternatively, be represented as one or more algorithmic functions expressed in the program instructions of control system 102, e.g., PMC 1800. For certain values of SOC or temperature, it may be desirable to use a discrete value for the balance factor whereas for different values of SOC or temperature it may be desirable to use in algorithmic function, thus both approaches can be used in a single embodiment. The balance factors can alternatively be implemented in hardware or combination of software and hardware.

The balance factors can be predetermined, such as through experimentation or modeling, prior to use in a real-world setting. The balance factors, once determined or set, can be adjusted or iterated for purposes of enhancement. For example, control system 102 can utilize a machine learning algorithm to identify more efficient or effective balance factors as system 100 is used, and can adjust the stored balance factors, whether in discrete-value form or algorithmic form, to achieve superior performance during the next iterative use of system 100.

In many embodiments different balance factors can be used depending on whether the system is presently in a state of charging or discharging. For discharge scenarios, In some implementations the SOC balance factor magnitudes can increase with increasing SOC percentage and the temperature balance factor magnitudes can increase with increasing temperature. For charge scenarios, In some implementations the SOC balance factor magnitudes can decrease with increasing SOC percentage and the temperature balance factor magnitudes can decrease with increasing temperature.

Several examples of balance factors are described with respect to Tables 1A, 1B, 2A, and 2B. These examples are appropriate for either or both charge and discharge scenarios. Table 1A presents an embodiment where each SOC value, e.g., 0-99%, has a discrete balance factor numeric value, e.g., x1, x2, x3, . . . x99, associated with it. In this embodiment there is also a minimum SOC, e.g., 4%, and maximum SOC, e.g., 96%, that represent optional thresholds below and above which no balancing occurs, and do not have corresponding balance factors. Table 1B presents an embodiment where temperature values within the combined thermal operating range of the sources, e.g., −20 C to 60 C, have discrete balance factor values, e.g., y1, y2, y3, . . . y60, associated with them. In this example, no balancing is performed for operating temperatures of 0 C and below and thus balancing factors are not necessary. Different and more or less granular ranges of SOC and temperature can be used. The actual numeric values used for the balancing factors can be selected based on the needs of the particular system configuration and application.

TABLE 1A

| SOC (%) | 0 | 1 | 2 | 3 | 4 | 5 | 6 | • | • | • | 94 | 95 | 96 | 97 | 98 | 99 |
|---|---|---|---|---|---|---|---|---|---|---|---|---|---|---|---|---|
| K_{SOC} | — | — | — | — | x1 | x2 | x3 | • | • | • | x91 | x92 | x93 | — | — | — |

TABLE 1B

| Temp (C.) | −20 | −19 | −18 | • | • | • | 0 | 1 | 2 | 3 | • | • | • | 58 | 59 | 60 |
|---|---|---|---|---|---|---|---|---|---|---|---|---|---|---|---|---|
| K_{Temp} | — | — | — | • | • | • | — | y1 | y2 | y3 | • | • | • | y58 | y59 | y60 |

In another embodiment, all or part of the range of states of charge can have balance factors expressed as or correlating to a mathematical function, e.g., a linear or nonlinear function. The same is true for all or part of the range of temperatures. Tables 2A and 2B show examples where different ranges of SOC and temperature, respectively, are expressed as different mathematical functions FS1-FS5 and FT1-FT3, respectively. For example the differing functions may have different slopes such that the balance factors increase with SOC and temperature. In this example the SOC values are separated into five ranges between SOCmin and SOCmax and the temperature values are separated into three ranges.

TABLE 2A

| | SOC (%) | | | | |
|---|---|---|---|---|---|
| | | | | | 81 to 95 |
| | 5 (SOCmin) to 20 | 21 to 40 | 41 to 60 | 61 to 80 | (SOCmax) |
| K_{SOC} | FS1 | FS2 | FS3 | FS4 | FS5 |

| Temperature (C.) | −20 (Tmin) to 10 | 11 to 30 | 31 to 60 (Tmax) |
|---|---|---|---|
| K_{Temp} | FT1 | FT2 | FT3 |

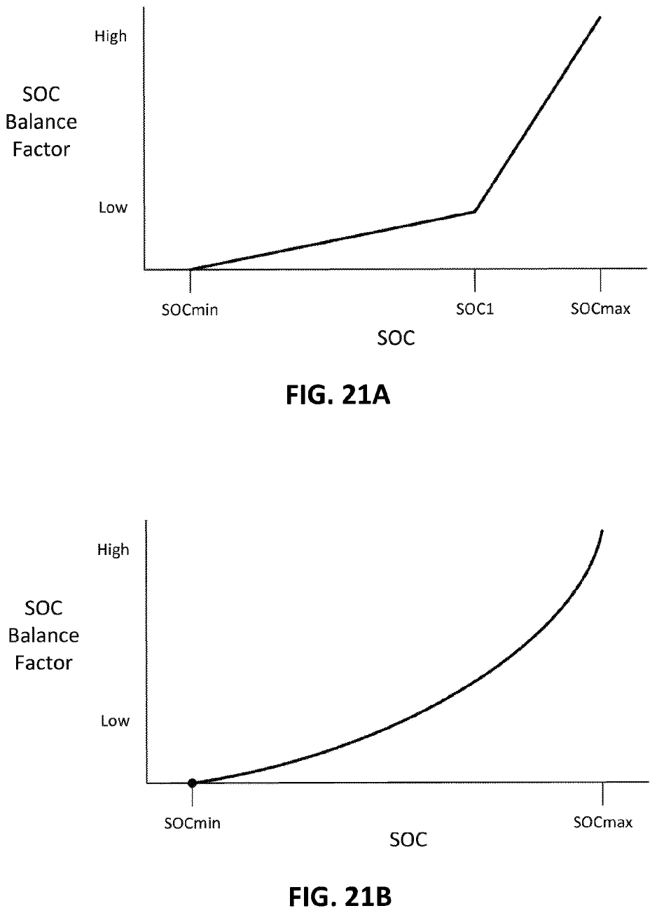

FIGS. 21A-21B are graphs depicting example embodiments of a relationship between SOC values and SOC balance factors. In the graph of FIG. 21A, the SOC values are subdivided into two ranges: Range1 from SOCmin to SOC1 and Range2 from SOC1 to SOCmax. Each range has a linear relationship with the corresponding SOC balance factors. The slopes of the linear relationships of each range can be selected based on the needs of the application, as can the values of SOCmin, SOCmax, SOC1, e.g., 40%, 50%, 60%), and other inter-range thresholds. In the graph of FIG. 21B, the entire range of SOC values, e.g., 0-99%, as a nonlinear relationship with the SOC balance factors. These example embodiments can likewise be implemented with respect to temperature or another operating parameter.

In some implementations a relatively small variation exists from one balance factor to the next so as to minimize the possibility of current spikes. For example, the balance factor values or functions can be set such that a balance factor, e.g., x1, for a first SOC or temperature measurement (or estimation), e.g., 25% SOC or 35 degrees C., does not vary by more than a threshold from a balance factor, e.g., x1+/−threshold, of an adjacent SOC or temperature measurement, e.g., 24% and 26% for SOC, 34 C and 36 C for temperature. The threshold can be determined based on the needs of the application. In some implementations, the threshold is 5% or less, and in other embodiments the threshold is 2% or less, and in still other embodiments the threshold is 1% or less.

As described above, these embodiments can be executed within control system 102 by, e.g., reference to the balance factors stored as one or more discrete values, mathematical functions, or combinations thereof.

### Further Control Embodiments

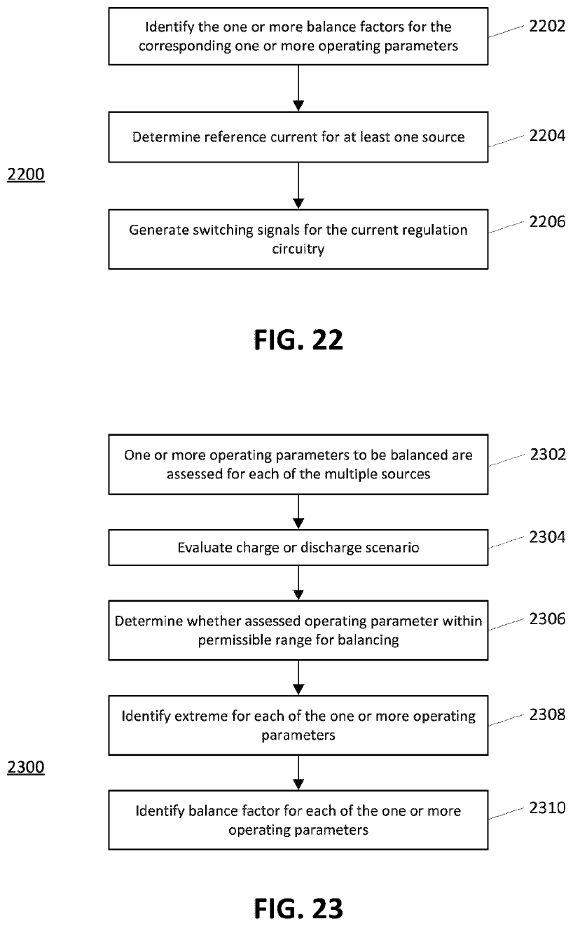

Example embodiments of methods related to the control of current and multiple source applications are described with reference to FIGS. 22-34. These methods can be implemented by PMC 1800 and/or another portion of control system 102. These methods will be described with reference to flow diagrams indicating a particular order of steps, however the steps in many cases can be performed in different orders or concurrently based on the needs of the application.

FIG. 22 is a flow diagram depicting an example embodiment of a method 2200 of controlling current in a multiple source environment, such as for a module 108 in a cascaded system 100. This embodiment can be applied to balance one or more operating parameters of the multiple sources, e.g., SOC, temperature, voltage, current, SOH, or others. At 2202, the one or more balance factors for the corresponding one or more operating parameters are identified by reference to a recent or present state of the sources. As described earlier, this can include reference to one or more data structures, e.g., a data array, a lookup table, or others), performance of a mathematical function to calculate the balance factor, or any combination thereof. For example, in the embodiment where both SOC and temperature are balanced, balance factors K_{SOC} and K_{Temp} can be identified during this step.

At 2204, a reference current (I*) is determined for at least one of the multiple sources depending on controller design and the number of sources being balanced, as described with reference to FIGS. 17A-17C. Determination of the reference current (I*) can be performed based on the identified one or more balance factors of step 2202, and the power or current requirement of the load or loads, which can be, e.g., determined, e.g., estimated or predicted, by control system 102, determined by an external control device 104, e.g., a vehicular ECU or MCU, and then reported to control system 102, or measured directly if the measurement time delays are within the margins of the overall system. Equations 4 and 5 are examples of those that can be used.

At 2206, switching signals for the current regulation circuitry, e.g., portion 602A, are generated to set the output current of the one or more sources being discretely controlled based on the reference current I* and the current state of the sources, e.g., source voltages. The reference current can be used to determine a desired duty cycle of the switching circuitry, such as by reference to Equation 3, which can then be translated to the switching signals and output to the switch circuitry.

FIG. 23 is a flow diagram depicting an example embodiment of a method 2300 of identifying one or more balance factors. Method 2300 can be performed, for example, in the execution of step 2202 of method 2200 of FIG. 22. A separate balance factor can be identified for each operating parameter, e.g., SOC, temperature, being balanced. At 2302, the one or more operating parameters are assessed for each of the multiple sources. This can be performed by measuring the operating parameter directly, e.g., use of a temperature sensor to measure source temperature, or indirectly, e.g., for SOC. This can also or alternatively be performed by use of an algorithm that predicts or estimates the present state of the operating parameter based on one or more prior measurements.

At 2304, PMC 1800 can evaluate whether a net discharge or a net charge scenario exists for example by evaluating the polarity of the load current or by receiving an indication of a discharge or charge scenario from control system 102 or an external control device. Operation in a discharge scenario may require the use of different thresholds (step 2304) or balance factors (2308) as compared to those selected for a charge scenario. Step 2303 can be performed at this or different times in the sequence of this and other embodiments.

At 2306, it is determined whether the assessed operating parameter is within a threshold or permissible range for balancing. For example, an SOC level of 1-3% may be too low for SOC balancing, or a temperature of 60 C may be too high for temperature balancing. PMC 1800 can make this determination for each of the relevant operating parameters and exit the balance factor selection routine if one such parameter is outside of the threshold or permissible range for balancing. If within the permissible range(s), then PMC 1800 can proceed to the next step. In some implementations, the determination at step 2306 is omitted and the balance factors are set such that when the assessed parameter is in a range where balancing is less desirable, or not desirable, then the balance factor in that range will be a constant, e.g., with a value that is relatively low (or zero), thus minimizing the impact of imbalance in that parameter in the overall balancing scheme performed by PMC 1800.

At 2308, the extreme, e.g., greatest or lowest, value for each assessed operating parameter is identified for use in selecting the balance factor for that operating parameter. For example with respect to SOC, the lowest SOC level of the assessed SOC levels of the multiple sources can be used in identifying the SOC balance factor K_{SOC} to be used. An example with respect to temperature, the highest temperature level of the assessed temperature levels of the multiple sources can be used in identifying the temperature balance factor K_{Temp} to be used. At 2310, the balance factor is identified, e.g., selected or calculated, for each operating parameter being balanced. This can be performed in accordance with any of the examples described herein. The identified one or more balance factors can then be passed or output to the function and/or hardware responsible for determining the reference current.

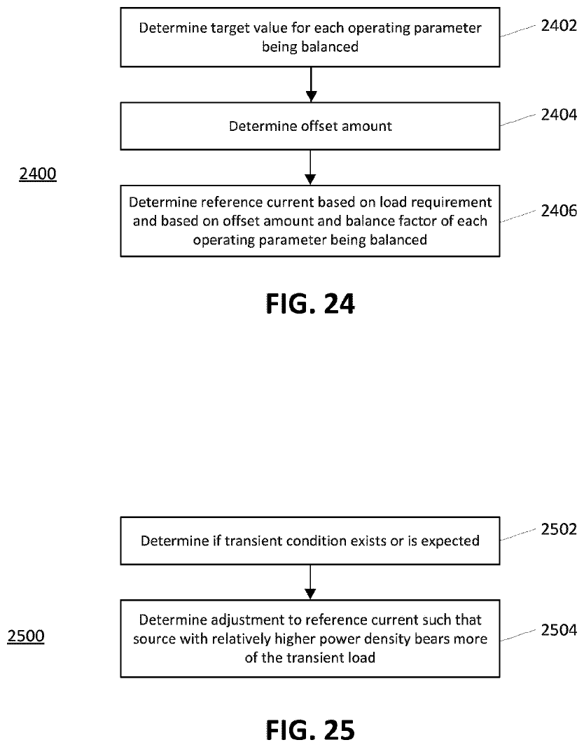

FIG. 24 is a flow diagram depicting an example embodiment of a method 2400 of determining a reference current. Method 2400 can be performed, for example, in the execution of step 2204 of method 2200 (FIG. 22) for any number of operating parameters being balanced. At 2402, for each operating parameter being balanced, a target value for that operating parameter is determined. The target value can be, in many embodiments, the value of the operating parameter that will be used as a target for all of the sources. PMC 1800 can manage charging or discharging of the sources such that the sources tend or migrate towards that target value in subsequent operation. This target value can be determined iteratively for each new reference current value, or can be determined at a less frequent interval depending on, e.g., processing load. The target value can be a central tendency value taking into account the present state of each of the multiple sources. For example the target value can be an average of the present state of the operating parameter across all of the sources being balanced, e.g., see, for example, R1_{AVE}, R2_{AVE}, and RN_{AVE} of Equation 4 and SOC_{AVE} and T_{AVE} of Equation 5, or the target value can be a median of the present state of the operating parameter across all the sources being balanced. Other techniques can be used to determine the target value, such as predictive techniques that are configured to anticipate future values of the operating parameter and/or future power or current requirements for the load.

At 2404 the target value is compared to the present value of that operating parameter. The present value can be directly measured, determined based on measurements of other values, e.g., determination of SOC based on measured voltages or charge counting), or otherwise estimated or calculated. The difference between the target value and the present value is an indication of the amount of offset that the source presently has from the operating goal.

At 2406 the reference current I* can be determined based on the power or current requirements of the load, as well as the offset amount and balance factor for each operating parameter being balanced. see, e.g., Equations 4 and 5. The balance factor can vary based on the magnitude of the operating parameter, e.g., the balance factor can scale with the operating parameter. As stated, the power or current requirements of the load can be reported to PMC 1800 by control system 102 or an external control source, can be predicted or estimated by control system 102, can be measured by system 100, and/or any combination thereof. Steps 2404 and 2406 need not be executed separately and can be combined such as through execution of Equation 4 or 5.

In some implementations where sources of different power densities are utilized, it may be desirable to increase current supplied by the source with relatively greater power density to meet rapidly changing, or transient, discharge demands by the load. The embodiments described herein can be modified to detect a transient condition and adjust current control based thereon.

FIG. 25 is a flow diagram depicting an example embodiment of a method 2500 of adjusting reference current for a transient condition. At 2502, it is determined whether a transient condition exists or is anticipated. This determination can occur by analyzing power or current requirements of the load to assess whether the rate of change exceeds a threshold value indicating a transient condition, or by a prediction of the same. In some implementations a filter can be applied to detect a transient. Other time domain and frequency domain techniques for the identification of transient conditions are known to those of ordinary skill in the art and can be utilized here.

If a transient condition is detected, then at 2504 PMC 1800 can determine an adjustment to the reference current to cause the higher power density source to contribute relatively more current to meet the load requirements. PMC 1800 can utilize a gain factor that sets the proportion of transient current to be applied by the higher power density source. The gain factor can set such that, for example in a two source module, the higher power density source supplies between 51% and 100% of the transient current above the steady-state current supplied by both sources. This adjustment can be applied as part of the reference current determination step 2204 of method 2200 or step 2406 of method 2400, such that the reference current I* determined by the system and utilized for generating the switching signals accounts for the transient condition.

In many embodiments, it is desirable to evaluate the processed output or input currents of each source to ensure that PMC 1800 does not exceed a maximum current output or input to each source. The embodiments described herein can be modified to monitor for maximum current violations and adjust the reference current accordingly.

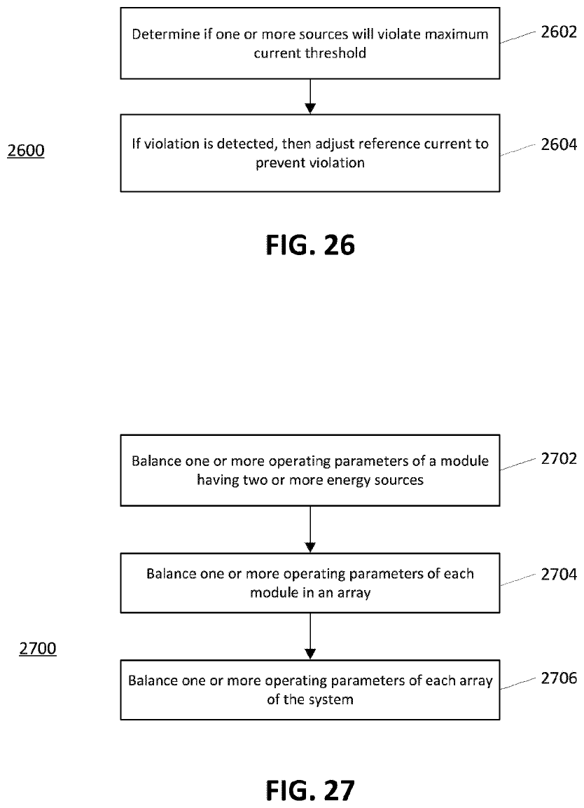

FIG. 26 is a flow diagram depicting an example embodiment of a method 2600 of adjusting reference current so as not to exceed a maximum current threshold for a source. At 2602, it is determined whether the reference current determination process will result in a reference current that causes one or more sources to violate a maximum current threshold. If such a violation is detected, then at 2604 PMC 1800 can adjust the reference current to prevent such violation from occurring. For example, if it is determined that source 206A will exceed a maximum current threshold, e.g., 200 amps), then the overage amount can be reallocated to the reference current for source 206B. This adjustment can be applied as part of the reference current determination step 2204 of method 2200 or step 2406 of method 2400, such that the reference current I* determined by the system and utilized for generating the switching signals does not cause a maximum current violation.

In embodiments where current is adjusted on the basis of a transient condition, e.g., method 2500, and/or the basis of a maximum current violation, e.g., method 2600), such adjustments may prevent the sources from converging towards a balanced condition, or may prevent the sources from maintaining a balanced condition. In these embodiments, control system 102 is configured to override or ignore the balancing target temporarily, and to revert to balancing as soon as possible conditions permit, such as a return to steady-state conditions or operation within maximum current thresholds.

The embodiments described herein can be used in a cascaded system 100 having one or more different arrays 700 each having two or more modules 108. System 100 can be arranged in a manner that permits inter-array balancing with IC modules 108IC, e.g., FIGS. 10A, 10C, 10D, 10F, or without IC modules 108IC, e.g., FIGS. 7A-7C. Regardless of the arrangement, control system 102 can be configured to balance operating parameters of all sources 206 of system 100 in a hierarchical manner. For example, control system 102 can balance one or more operating parameters of two or more sources within a module 108, while concurrently balancing one or more operating parameters of those sources with sources of one or more other modules within the same array 700. Control system 102 can further balance one or more operating parameters of the sources of that array 700 with sources of one or more other arrays 700, if configured for that functions such as with the inclusion of IC modules 108IC. Control system 102 can perform this balancing for every source 206 within all of the arrays 700, or for only a subset of sources if desired.

Control system 102 can perform balancing for the same one or more operating parameters for all sources, or can balance a first one or more operating parameters for a first subset of sources while balancing a second one or more operating parameters for a second subset of sources. For example, control system 102 can balance SOC and temperature for all sources 206 of an array 700, and can balance SOC for all arrays 700 but not temperature. Thus numerous different balancing combinations can be configured in accordance with the present subject matter.

FIG. 27 is a flow diagram depicting an example embodiment of a method 2700 of balancing one or more operating parameters in a cascaded system 100 having at least two arrays 700 each having two or more modules 108, where each of the two or more modules 108 have at least two energy sources 206A and 206B. At 2702, PMC 1800 balances one or more operating parameters, e.g., SOC, temperature, voltage, SOH, etc., for the sources 206A and 206B of an individual module 108, such that the one or more parameters of the sources 206A and 206B of that individual module 108 tend to converge. For example, PMC 1800 may be executed by or within the LCD 114 of that module 108, and step 2702 can be performed by each PMC 1800 in system 100 for the sources 206A and 206B assigned to that PMC 1800. This intramodule source balancing can be performed in accordance with the embodiments described herein with reference to FIGS. 17A-26.

At 2704, control system 102 can balance one or more operating parameters of the sources of each module 108 of a particular array 700 corresponding to a particular phase. This intraphase balancing of step 2704 can be performed by adjustment of modulation indexes like that described with respect to array controller 900 of FIG. 9A. Step 2704 can be performed separately for each array 700 within system 100. The one or more operating parameters balanced in step 2704 can be the same or different than those balanced in step 2702. If the same one or more operating parameters are balanced, then control system 102 will manage the power of all modules, or the balanced subset of modules, of a particular array 700 to seek balance in those parameters.

If system 100 is configured to perform interphase balancing, then at 2706, control system 102 can balance one or more operating parameters of the sources of different arrays 700. This interphase balancing of step 2706 can be performed by injecting common mode to the phases, e.g., neutral point shifting, or through the use of interconnection modules or through both, as described herein. The one or more operating parameters balanced in step 2706 can be the same or different than those balanced in steps 2704 and 2702. If the same one or more operating parameters are balanced, then control system 102 will manage the power of all modules, or the balanced subset of modules, of all arrays 700 to seek balance in those parameters.

### Simulation Results

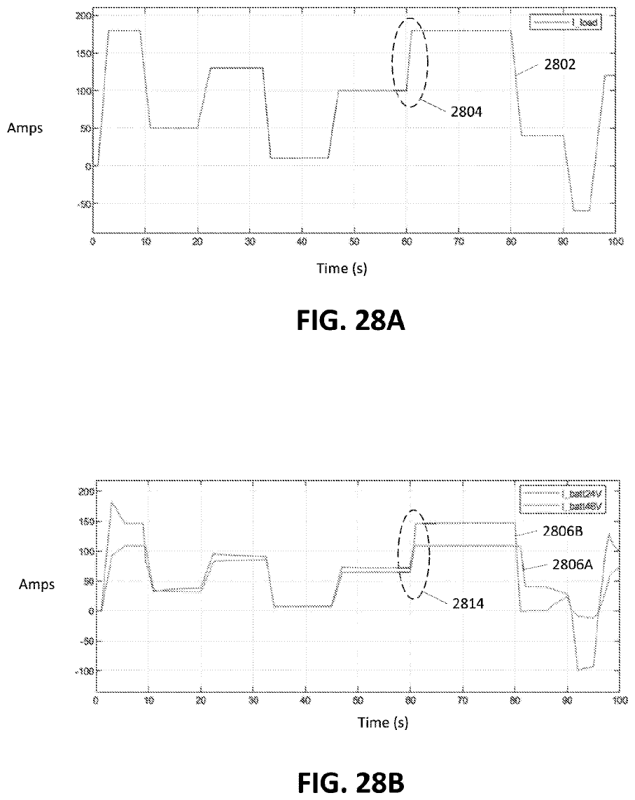

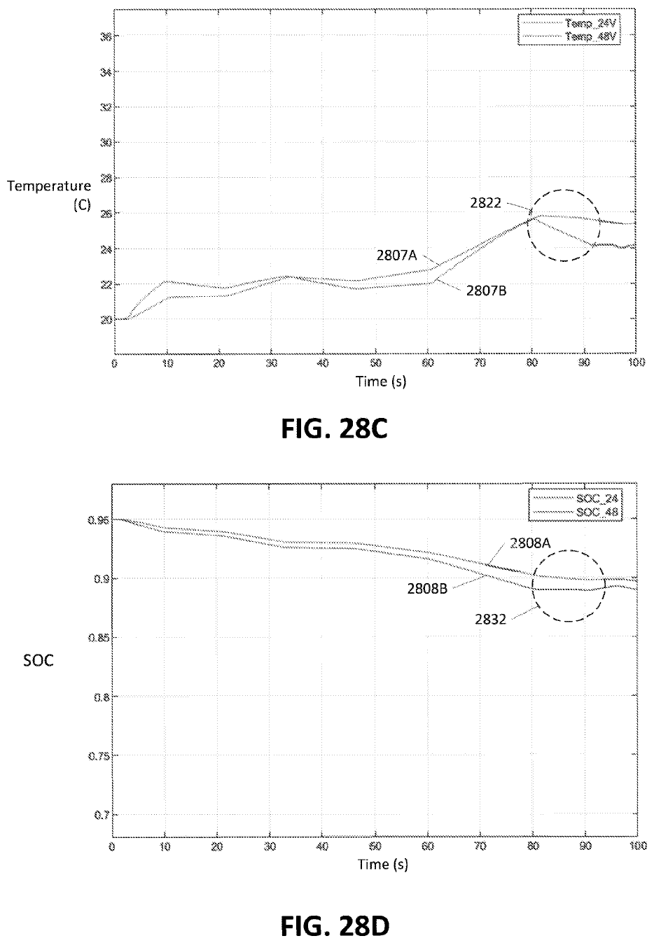

FIGS. 28A-28D are graphs related to a simulation that was performed for an example embodiment of an electric tram having two battery sources 206A and 206B, where source 206A has a higher nominal voltage (48V) than source 206B (24V), but source 206B has a relatively higher power density (LTO) than source 206A (NMC). FIG. 28A depicts an example load current demand profile over a 100 seconds of a given route, where the load current 2802 varies between steady-state and transient, e.g., near vertical sloped line 2804, conditions.

FIG. 28B depicts the output current 2806A for source 206A and the output current 2806B for source 206B as the simulation was performed in accordance with the current control embodiments described herein. Transient responses are shown in region 2814 corresponding to the transient condition 2804 in load current 2802. FIG. 28C depicts the temperature 2807A of source 206A and the temperature 2807B of source 206B and FIG. 28D depicts the SOC 2808A of source 206A and the SOC 2808B of source 206B over the 100 seconds of the route.

As can be seen the temperature of both sources remains relatively balanced over the entire 100 seconds, as does the SOC of both sources. The maximum temperature variation between sources is less than 2° C., and the maximum variation in SOC is less than 2%. While the SOC and temperature values remain close, it is not required that the SOC values converge towards each other at the same time as the temperature values are converging towards each other in order for the system to maintain a balanced state. As noted in regions 2822 (FIG. 28C) and 2832 (FIG. 28D), one parameter may be converging, e.g., SOC, while the other is diverging, e.g., temperature, across a particular span of time or distance. Such conditions can occur until the divergence of one parameter becomes severe enough that the current control embodiments described herein shift the balancing focus from the converging parameter towards that diverging parameter in order to maintain overall balance. Thus, the embodiments described herein perform balancing in a continuous iterative manner, repeatedly reassessing the offset of the present values of the parameters from each other, or from a target value, and adjusting the current of each source accordingly to ensure that no one parameter becomes too greatly disparate, with certain exceptions, such as to avoid maximum current violations and during times of transient load demand.

### Further Control Embodiments Using Tunable Balancing

Tunable balancing techniques can be used to balance operating properties, e.g., SOC, T, Q, SOH, V, or I, of modules 108 or components thereof of a system 100 concurrently with normal system operation. As used herein, any reference to the operating parameters of modules 108 can include the operating parameters of the modules 108 and/or the operating parameters of individual components of the modules 108. For example, the balancing techniques described herein can be used to balance the SOC of one or more sources 206 of modules 108, a combined SOC of multiple sources 206 of each module 108, the temperature of the modules 108, the temperature of the sources 206, the temperature of buffers 204, the output voltage of modules 108, the output current of modules 108, and/or other operating parameters.

The tunable balancing techniques allow for the adjustment of the rate or speed at which operating parameters are balanced between modules 108 and/or for the adjustment of relative importance of multiple operating parameters that are being balanced between modules 108. The tunable balancing techniques can be implemented by MCD 112, LCD 114, PMC 1800, and/or another portion of a control system 102. For example, in systems 100 that include modules 108 with multiple sources 206, PMC 1800 can balance sources 206 as described herein, e.g., with reference to FIGS. 19A-28D, using tunable balance factors described below in place of or in addition to balance factors described above. For example, PMC 1800 can control output current of modules 108 using tunable balance factors.

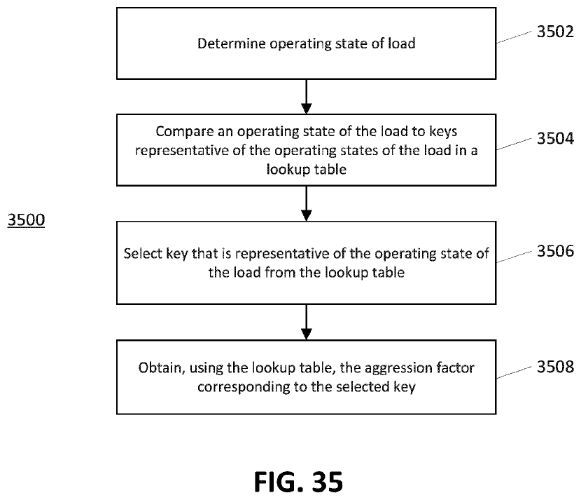

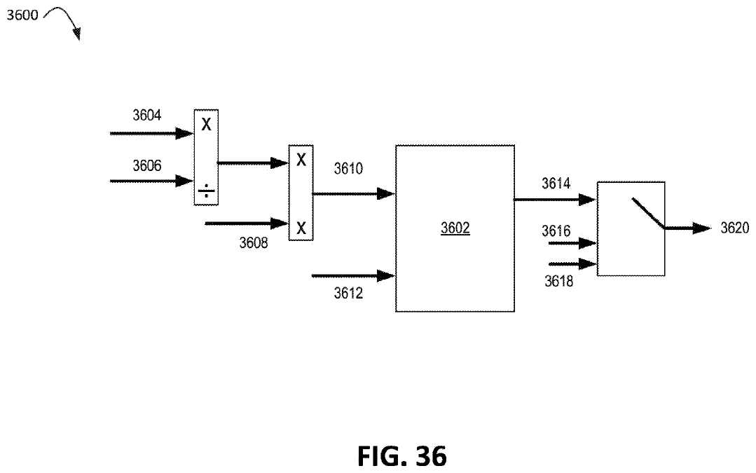

Tunable balancing techniques can be used to balance operating parameters of modules 108 in a multi-phase cascaded system 100 or any other implementation of system 100 described in this document. The described techniques do not affect system operation, e.g., do not affect an applied load or a charging or discharging state of modules 108. In other words, the operating parameters of multiple modules 108 can be balanced with little or no impact on normal operation of modules 108 or the overall system 100 but can improve the long-term performance of the modules 108, e.g., extend a lifetime of the modules 108. For example, the balancing techniques can be performed without reducing the amount of power provided to a load 101 and without interrupting power to the load 101. The rate of balancing can optionally be adjusted using an amplification modifier, as described below, to prevent balancing techniques from impacting normal operation of sources or the overall system 100. Selection of an amplification modifier is discussed in further detail, for example, with reference to FIGS. 35 and 36 below. Tunable balancing techniques can use one or more tunable adjustment parameters to adjust a rate of convergence of a balancing process, e.g., a rate of convergence of operating parameters to a balanced target value, and/or a relative importance of different operating parameters being balanced. Advantageously, the tunable balancing techniques can be implemented without the use of additional electronic and/or control systems that are not otherwise used to control normal system operation.

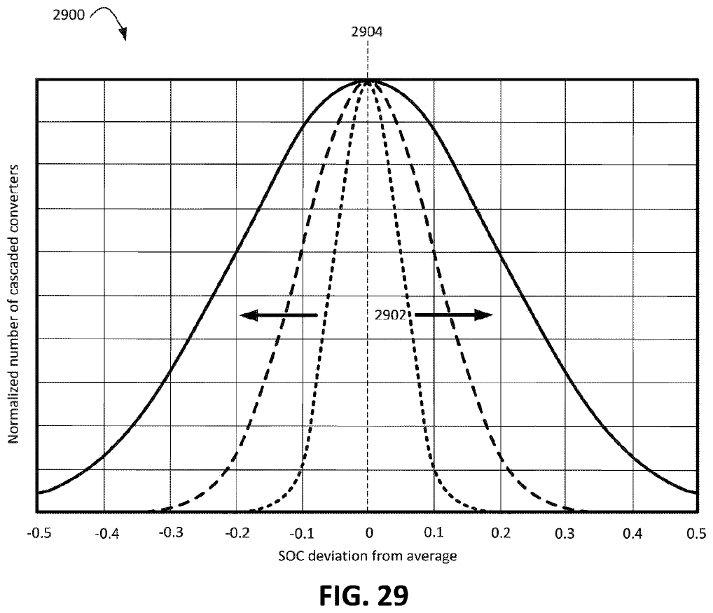

The tunable balancing techniques described with reference to FIGS. 29A-36 can be used in a cascaded system 100 having one or more arrays 700 each having two or more modules 108. System 100 can be arranged in a manner that permits inter-array balancing with IC modules 108IC, e.g., as illustrated in FIGS. 10A, 10C, 10D, 10F, or without IC modules 108IC, e.g., as illustrated in FIGS. 7A-7C. Regardless of the arrangement, operating parameters of every module 108 of system 100 can be balanced with respect to all others. For example, one or more operating parameters of two or more sources 206 within a module 108 can be balanced, while one or more operating parameters of those sources 206 are concurrently balanced with sources 206 of one or more other modules 108 within the same array 700. Additionally, one or more operating parameters of two or more arrays 700 of a system 100 can be balanced with respect to each other array 700. Balancing operations described herein with respect to balancing of operating parameters of respective modules 108 of an array 700 can be applied similarly to balancing of operating parameters of respective arrays 700 of a system 100. Similarly, balancing operations described herein with respect to balancing operating parameters of sources 206 within an array 700 of system 100 can be applied similarly to balancing operating parameters of modules 108 within an array 700 of system 100.

In many cases, one or more operating parameters of modules 108 of system 100 can drift over time. The one or more operating parameters of a module 108 can drift relative to balanced target values of the respective operating parameters of other modules 108. For example, a balanced target value for an operating parameter can be an average value for the operating parameter across all or a portion of modules 108 of system 100. In another example, a balanced target value for an operating parameter can be an average value for the operating parameter of all modules 108 of an array 700 of modules 108 within system 100. For example, operating parameters of a source 206 can drift relative other sources 206 in a same module 108, relative to other sources 206 in a same array 700, and/or relative to other sources 206 in a same system 100, e.g., but in a different array 700. For example, a SOCᵢ of a source 206 can drift from a balanced target SOC value, e.g., an average SOC, SOC_{avg}, determined for two or more sources 206 of system 100. Drift of one or more operating parameters of sources 206 over time can result in deviation between the respective operating parameters of sources 206 of system 100, and can negatively affect source lifetime and/or operational system reliability.

In some implementations, maintaining or improving long-term performance of system 100 can be performed by adjusting, e.g., minimizing, deviations of one or more operating parameters of modules 108 relative to balanced target values of the one or more operating parameters of modules 108 using tunable balancing techniques. In some implementations, the balancing techniques are performed concurrently with normal system operation. Balancing techniques can be performed dynamically, where tunable balance factor(s) utilized in the balancing techniques can be variable, e.g., tunable by a user, a component of system 100, or an external component communicatively coupled to system 100. For example, tunable balance factor(s) can be variable in response to performance of system 100 and/or demands of load 101. In a particular example, a three-phase modular energy system 100, e.g., as depicted in FIGS. 10D and 10F, can implement methods for balancing sources 206 while maintaining properties of load 101, e.g., a primary load and/or auxiliary loads 301, 302, fixed. For example, modules 108 can be balanced while maintaining a motor's torque and currents fixed, or while increasing a motor's torque and currents, or while decreasing a motor's torque and currents.

The methods for balancing modules 108 can be performed independent of a sign of respective torque(s) of motors, e.g., motors of an electric vehicle. The modules 108 being balanced, or the arrays 700 being balanced, can be in any number of 2, 3, 4, or more different packs of an electric vehicle, supplying any number of 2, 3, 4, or more different motors. In other words, a balancing of modules 108 in an array 700 of modules 108 can be performed in based on the operation of the motor, e.g., an operating state of the motor. Example motor-aware source balancing techniques are described below with reference to FIGS. 33-34.

In some implementations, the balancing techniques include adjusting a relative importance of different operating parameters being balanced. For example, a priority for balancing SOC of sources 206 can be higher than a priority for balancing SOH or temperature of sources 206, where a higher priority results in a more aggressive, i.e., faster, balancing of the operating parameter than a lower priority. Under different operating conditions for a system 100, balancing modules 108 can include different ranked priorities for balancing operating parameters of modules 108. For example, a relative importance of SOC of a source 206 may be higher than an importance of temperature of source 206. At times, relative importance of different operating parameters being balanced can be time-varying depending, for example, on performance requirements for modules 108, e.g., based on load 101. In some implementations, one or more operating parameters may be interconnected such that balancing a first operating parameter may affect at least one other operating parameter of a module 108. For example, balancing SOC of sources 206 can affect temperatures of sources 206.

Control system 102 can be configured to adjust or tune the balancing rate and/or balancing parameter priority upon one or more conditions. The system can have two or more different balance factors for adjusting the rate at which a particular operating parameter is balanced, where each different balance factor is implemented depending on whether one or more conditions of the system have been met, e.g., a first balance factor for a first condition or state of the system, and a second balance factor for a second condition or state of the system. Similarly, the system can have two or more different balance factors for adjusting the priority at which operating parameters are balanced, where each different balance factor is implemented depending on whether one or more conditions of the system have been met, e.g., a first priority modifier for a first condition or state of the system, and a second priority modifier for a second condition or state of the system. For example, if the imbalance, e.g., in SOC, temperature, or SOH) between sources 206 exceeds a threshold, control system 102 can increase the rate of balancing and conversely, if the imbalance is within a threshold, control system 102 can decrease the rate of balancing. Similarly, if a first parameter, e.g., SOC, temperature, SOH, is relatively more out of balance, e.g., by percentage, than a second parameter, e.g., a different one of SOC, temperature, SOH), then system 102 can adjust a priority of balancing to balance the relatively more out of balance first parameter first or faster than the second parameter. Control system 102 thus has at least two degrees of freedom by which to adjust balancing.

The condition upon which control system 102 can be programmed to adjust balancing rate and/or priority of balancing, or conditions upon which such adjustment is further contingent, can vary and further can be contingent on other conditions, such as the existence or absence of sufficient energy, e.g., SOC, within system 100 to permit more balancing adjustment. Examples of the aforementioned conditions for balancing include: a degree of difference between relative balance of two or more parameters, e.g., SOC, temperature, or SOH, of energy sources 206, e.g., measured individually or assessed across the group), a degree of difference in a parameter, e.g., SOC, temperature, SOH, across all or a subset of all sources 206, a condition of relatively increased demand of load 101, either actual or predicted, or decreased demand of load 101, either actual or predicted, compared to a prior time or reference state, the occurrence of a fault or removal of a fault within system 100, e.g., such as a fault requiring bypass of a module 108), the age of one or more energy sources 206 within system 100, e.g., an average age being greater than or less than a threshold), the capacity of one or more energy sources 206 within system 100, e.g., the average capacity being greater than or less than a threshold), the SOH of one or more sources 206 within system 100, e.g., the average SOH being greater than or less than a threshold), an ambient temperature of system 100 exceeding or being lesser than a threshold temperature, loss or reconnection of a power supply grid coupled with system 100, transition of system 100 from a charging to a discharging state, e.g., actual or predicted, or transition of system 100 from a discharging to a charging state, e.g., actual or predicted, or for EV and mobility applications the entrance of system 100 into a driving state conducive to increased or decreased balancing rate, such as indication by global positioning system (GPS) and/or an automated maps application that the EV is entering a particular driving condition or state, e.g., a period of highway driving having relatively less transient demands than a period of city street driving having relatively more transient demands (and the reverse), or a period of driving in inclement weather.

In some implementations, balancing techniques are applied to multi-phase systems, e.g., three-phase cascaded modular energy system(s) 100 as described with reference to FIGS. 10D and 10F. System 100 can provide multi-phase power, e.g., two-phase, three-phase, four-phase, five-phase, six-phase, etc., to load 101 by use of multiple arrays 700, where each array can generate an AC output signal having a different phase angle. Example calculations are described where one, two, three, or more different operating parameters of two or more modules of one or more arrays 700 are balanced using respective balance factor(s), kᵢ. A total output voltage for each phase of multi-phase system 100 can be expressed as (6):

$${v}_{a} = {\sum }_{i = 1}^{N} {v}_{ac , i} \qquad ( 6 )$$

where vₐ is a voltage setpoint for load 101, e.g., produced by main motor control functions for an electric motor, v_{ac,i} is an output ac-voltage for the i^{th} module 108 in array 700 for the phase, and Nis a number of modules 108 in array 700 for the phase.

An AC output of each module 108 of an array 700 can be expressed as (7):

$${v}_{a c , i} = {k}_{i} \frac{{v}_{a}}{N} \qquad ( 7 )$$

where kᵢ is a balance factor for an i^{th} module 108 of array 700.

As described herein, modules 108 can be balanced with respect to other modules, e.g., with respect to other modules 108, in an array 700, which can be referred to as intra-array or intraphase balancing, and different arrays 700 can be balanced with respect to each other, which can be referred to as interarray or interphase balancing. Arrays 700 of different subsystems can also be balanced with respect to each other. Control system 102 can simultaneously perform any combination of intraphase balancing, interphase balancing, utilization of multiple energy sources 206 within a module 108, active filtering, and auxiliary load supply.

In some implementations, when all modules 108 of system 100 that are being balanced have identical operating parameter(s) that are being balanced, the balance factor, ki, for each modules 108 is equal to one (1.0). For example, when modules 108 of system 100 have identical operating parameters and therefore a balance factor of 1, the resultant AC output voltages, v_{ac,i}, of modules 108 are equal.

In some implementations, one or more operating properties of a module 108 may differ from a balanced target value, e.g., average value, for multiple modules 108 of system 100. For example, SOC of one or more of the sources 206 of the modules 108 can be different from an average SOC of sources 206, SOC_{avg}, for system 100. Balance factor(s), kᵢ, can be utilized to reduce deviation(s) of one or more operating parameters of modules 108 from balanced target values.

For instance, for a module 108 in an x^{th} position of an array 700, a SOCₓ of a source 206 of the module 108 can have a deviation from an average SOC_{avg} of sources 206 of all modules 108 within array 700 of system 100. Balance factor(s) can be utilized to adjust the amount of energy, e.g., current, output by the module 108 in the x^{th} position. For example, reducing the output current of the x^{th} module 108 in array 700 with respect to each other module 108 in array 700 can be accomplished by adjusting a balance factor kx for module x. In some implementations, lower balance factors, e.g., less than 1, result in less output current from a module 108 and higher balance factors, e.g., greater than 1, result in higher output current from a module 108. For example, control system 102 can adjust the modulation index Mi for a module 108 using the balance factor(s) for the module 108. In a particular example, control system 102 can increase the modulation index Mi for a module 108 with an increase in a balance factor for the module 108 and decrease the modulation index Mi for a module 108 with a decrease in the balance factor for the module 108. These increases and decreases in the modulation index Mi can be proportional to the balance factor or otherwise based on the balance factor.

In some implementations, a balance factor, ki, for a module 108 can be determined by dividing an operating parameter value for module 108 by a balanced target value for the operating parameter. The operating parameter value can be a most recent measured or otherwise obtained value of the operating parameter for the module 108. The balanced target value can be the average of the operating parameter across all modules 108 being balanced together, e.g., all modules 108 of system 100, all modules 108 of an array 700, or all sources 206 of a module 108. For example, calculating a balance factor, kᵢ, for source i using an SOCᵢ value can be expressed as (8):

$${k}_{i} = \frac{{SOC}_{i}}{{SOC}_{a v g}} \qquad ( 8 )$$

where SOCi is the operating parameter value for SOC for the module 108 and SOC_{avg} is the average SOC of all modules 108 being balanced. Because initial differences in SOC between sources 206 are usually small, using Equation 8 can result in balance factors that are very close to one, which means that the rate of balancing may be slow for some applications. In some applications, it is advantageous to decrease a time required to balance operating parameters of modules 108. Tunable balancing techniques can include adjusting the magnitude in the deviations between operating parameters of sources 206 while preserving a requested voltage setpoint, e.g., v_{ac,i}, in order to increase a rate at which operating parameters of sources 206 are balanced. In other words, the techniques can include amplifying the observed deviations between an operating parameter of a module 108 and the balanced target value such that the balance factor is also increased resulting in more aggressive and faster balancing.

In some implementations, an amount of amplification can be adjusted, e.g., tuned, by control system 102 an external control system 104, or another component. For example, external control unit 104 can include, or be operatively coupled to, a user input terminal 1806. User input terminal 1806 can be configured to allow a user to input control parameters, e.g., tunable adjustment parameters for tuning balancing techniques described herein.

The tunable adjustment parameters can be input through graphical user interface 1808, as described herein. Tunable adjustment parameters can include prioritization schemes indicative of a relative importance of balancing each operating parameter with respect to each other operating parameter. For example, prioritization schemes can include a relative importance of balancing each operating parameter with respect to each other operating parameter, e.g., priority modifiers as described herein. The tunable adjustment parameters for the prioritization schemes can include priority modifiers, as described below. Tunable adjustment parameters can include a requested rate of balancing for modules 108, e.g., a speed at which the operating parameters of modules 108 are balanced with respect to each other. The tunable adjustment parameters for adjusting the rate of balancing can include amplification modifiers. For example, a rate of balancing for modules can be controlled by use of one or more amplification modifier(s), such as those described herein.

Differences in operating parameters of modules 108 can be modeled as normally distributed about a central tendency, e.g., a mean or a median, within a threshold, e.g., a percentage, fraction, or number of standard deviations. For example, a first normal distribution of a SOC_{i,1} of a source 206 with respect to a mean SOC_{avg} and a standard deviation σ₁, can be transformed into a second normal distribution SOC_{i,2} with a same mean SOC_{avg}, but a different standard deviation 62 using (9):

$${SOC}_{i , 2} = {SOC}_{i , 1} \times \frac{{σ}_{2}}{{σ}_{1}} + {SOC}_{a v g} \times ( 1 - \frac{{σ}_{2}}{{σ}_{1}} ) \qquad ( 9 )$$

where the subscript “i” refers to the i^{th} module 108 that is being balanced, and the subscripts “1” and “2” refer to the real distribution and modified distribution, respectively. In other words, a real distribution of operating parameter SOC of an i^{th} module 198, SOC_{i,1}, can be transformed to a modified distribution of operating parameter SOC for the i^{th} module 108, SOC_{i,2}, utilizing Equation 9 or other scaling equation. A ratio of a second standard deviation σ₂ of modified distribution SOC_{i,2} to a first standard deviation σ₁ of real distribution SOC_{i,1} can be utilized as an amplification modifer of a balancing function. The ratio

$$\frac{{σ}_{2}}{{σ}_{1}}$$

can be utilized to adjust the magnitude of deviations between operating parameters for a module 108 and the balanced target values for the operating parameters, while maintaining a mean SOC_{avg}, fixed. Adjusting ratio

$$\frac{{σ}_{2}}{{σ}_{1}}$$

can adjust a difference in the SOC values such that a speed of response, e.g., a rate of balancing, can be adjusted. For example, increasing an amplification modifier, e.g., the ratio

$$\frac{{σ}_{2}}{{σ}_{1}} ,$$

as used in Equation 9 can increase deviations between an observed value and the balanced target value and therefore increase a speed of balancing such that sources 206 approach the balanced target value to a greater degree over a period of time as compared to a non-adjusted amplification modifier.

In some implementations, a user can provide the amplification modifier, e.g., as a numerical value, using user terminal 1806. In this way, the user does not have to calculate distributions between operating parameters or a ratio of the standard deviations. Instead, a user can provide an increased amplification modifier for an operating parameter to increase a rate at which PMC 1800 balances the operating parameter across modules 108. Similarly, a user can provide a decreased amplification modifier for an operating parameter to decrease a rate at which PMC 1800 balances the operating parameter across modules 108. The user-specified amplification modifier can be used in place of the ratio

$$\frac{{σ}_{2}}{{σ}_{1}}$$

in Equation 9 to determine SOC_{i,2}, which can be used in place of SOC_{i,1} when determining the balance factor for the operating parameter for the module 108, as described in more detail below.

Control system 102 can generate a modified distribution for each operating parameter that is balanced between sources 206 using a corresponding amplification modifier. The amplification modifier can be the same or different for the multiple operating parameters.

The modified distribution for an operating parameter can be utilized to compute tunable balance factor(s) ki instead of the real distribution. This enables the speed of balancing for the operating parameter to be adjusted by adjusting the amplification modifier, which results in adjusted deviations between observed operating parameters and average operating parameters, which in turn results in adjusted balancing speed.

FIG. 29 depicts a plot 2900 of example amplifying operation parameter deviations by transformation of SOC value distributions from an average SOC value that is normalized for a number of modules 108 of system 100. As depicted, a full-width half maximum (FWHM) of the distributions increases, e.g., as indicated by arrows 2902, with increasing amplifications of deviations from an average SOC 2904 while preserving a mean value, SOC_{avg}.

The balancing process for system 100 can be performed while modules 108 are in a charging or in a discharging state. The system can balance the modules 108 in either state with the result that modules 108 are not idling or waiting while the balancing is being performed. The system can balance the modules 108 while all of the modules 108 are in the same state, e.g., either charging or discharging, or in situations in which one or more of the modules 108 are charging and one or more of the modules 108 are discharging. In other words, based on a value of the amplification modifier, e.g., ratio

$$\frac{{σ}_{2}}{{σ}_{1}} ,$$

for the one or more phases of system 100, at least one module 108 of the system 100 can be in a charging state and at least one module 108 can be in a discharging state during a balancing process. Depending on a charging state or a discharging state of a module 108, operational parameter(s) of module 108 can be adjusted such that tunable balance factor(s) result in expected balancing behavior.

A normalized temperature property can be generated by dividing real, i.e., measured, temperatures by a base temperature value, e.g., a maximum allowable battery temperature. A summary of balancing factor calculations for operating parameters SOC, normalized temperature, and SOH for a module 108 are depicted in Table 2. Similar equations can be used for other operating parameters. As an example, to generate an equation for a different operating parameter using the equations for SOC, the modified distribution SOC_{i,2} can be replaced with the modified distribution for the different operating parameter and SOC_{avg} can be replaced with the average value of the operating parameter across the modules 108 being balanced. The tunable balance factor calculations shown in Table 2 utilize modified distributions obtained by applying an amplification modifier, e.g., similar to the modified distribution SOC_{i, 2} described herein. Similarly, the subscript “i” refers to the i^{th} module or source that is being balanced, subscript “2” refers to the modified distribution, and the subscript “avg” refers to a target balanced operating parameter, e.g., an average, value for the modules or sources being balanced.

TABLE 2

| Battery properties | Charging | Discharging |
|---|---|---|
| SOC_{i,1} | ${k}_{i , SOC} = \frac{{SOC}_{i , 2}}{{SOC}_{avg}}$ | ${k}_{i , SOC} = \frac{( 1 - {SOC}_{i , 2} )}{( 1 - {SOC}_{avg} )}$ |
| T_{normal,i,1} | ${k}_{i , Temp} = \frac{{T}_{normal , i , 2}}{{T}_{normal , avg}}$ | ${k}_{i , Temp} = \frac{( 1 - {T}_{normal , i , 2} )}{( 1 - {T}_{normal , avg} )}$ |
| SOH_{i,1} | ${k}_{i , SOH} = \frac{{SOH}_{i , 2}}{{SOH}_{avg}}$ | ${k}_{i , SOH} = \frac{( 1 - {SOH}_{i , 2} )}{( 1 - {SOH}_{avg} )}$ |

In Table 2, k_{i,Temp} is the balance factor for temperature, k_{i,SOH} is the balance factor for SOH, T_{normal,i,2} is the modified, normalized distribution for temperature, T_{normal,avg} is the average temperature of the modules 108 being balanced, SOH,_{i,2} is the modified, normalized distribution for SOH, and SOH_{avg} is the average SOH of the modules 108 being balanced.

In some implementations, a direction of power flow (P_{direction}) e.g., charging or discharging states, for a module 108 of a multi-phase cascaded module energy system 100 is determined by a sign of a power calculation for array 700 as expressed in (10):

$$\{ \begin{matrix}P = \frac{1}{N} ( {\sum }_{i = 1}^{N} {v}_{a c , i} {i}_{i} ) \\ {P}_{direction} = 1 if P > {P}_{m i n} \\ {P}_{direction} = 0 if P < - {P}_{m i n} , P = 0\end{matrix} \qquad ( 10 )$$

In Equation 10, v_{ac,i} is an output AC-voltage for i^{th} module 108, ii is an output current for i^{th} module 108, and N is a number of modules 108 being balanced in an array 700 or system 100. Using (10), a direction of power flow for a source 206 of system 100 can be determined by a sign of a power calculation for the source 206. In some implementations, system 100 can use hysteresis to prevent rapid changes between the direction of power flow of a module 108. Based on the determined sign, the appropriate equation from Table 2 is used to determine the balance factor(s) for the module 108. In instances in which P=0, the flow of power (P_{direction}) is zero, i.e., no power is flowing such that the system is neither in a charging or discharging state.

Some implementations use priority modifiers during operating parameter balancing to adjust a relative importance, e.g., a prioritization or weight, of tunable balance factors, e.g., those shown in Table 2. Priority modifiers can be applied to tunable balance factors corresponding to respective operating parameters, e.g., SOC, temperature, and SOH. Priority modifiers may be represented by p_{SOC}, p_{T}, p_{SOH}, where p_{SOC} is the priority modifier for SOC, pr is the priority modifier for temperature, and p_{SOH} is the priority modifier for SOH. Priority modifiers can be adjusted dynamically to adjust an importance, and therefore rate of balancing, of each balancing factor with respect to each other balancing factor. As a result, adjusting priority modifiers can adjust a relative importance and relative rate of balancing each operating parameter with respect to each other operating parameter. Priority modifiers can be adjusted automatically by a component of system 100, or by an external component communicatively coupled to system 100 using a control feedback loop that alters the priority modifiers, e.g., in response to operating state of system 100 and/or one or more loads 101 coupled to the system 100. For example, priority modifiers can be varied automatically in response to performance of system 100 and/or demands or operation of load 101. In other words, the system can select to adjust a priority of SOC, temperature, and SOH with respect to each other operating parameter. In one example, the system can select to prioritize balancing the operating parameter that includes a largest deviation from an average value amongst the modules 108. Priority modifiers can be adjusted semi-automatically or manually, e.g., by a user using user input terminal 1806, as described above. Equation 11 provides an example calculation for a refined tunable balance factor k_{i,f}, for each module 108 that is determined utilizing priority modifiers:

$${k}_{i , f} = \frac{{p}_{SOC}}{{p}_{SOC} + {p}_{T} + {p}_{S O H}} {k}_{i , SOC} + \frac{{p}_{T}}{{p}_{SOC} + {p}_{T} + {p}_{S O H}} {k}_{i , Temp} + \frac{{p}_{SOH}}{{p}_{SOC} + {p}_{T} + {p}_{S O H}} {k}_{i , SOH} \qquad ( 11 )$$

where the refined tunable balance factor kif is an overall tunable balance factor used to adjust an output, e.g., output current, of a module 108. For example, control system 102 can adjust the output current of a module 108 by adjusting the switching signals for the converter 202 of the module 108, e.g., by adjustment of a modulation index Mi for the module 108 using the overall tunable balance factor, as described herein. The refined tunable balance factor k_{i,f} for a module 108 can be substituted for ki in Equation 7 to determine the output voltage v_{ac,i} of the module 108. Adjusting relative values of priority modifiers p_{SOC}, p_{T}, p_{SOH} with respect to each other adjusts the relative importance, e.g., prioritization or weight, of the corresponding tunable balance factor, kₓ. For example, increasing a relative value of p_{SOC} with respect to pr and p_{SOH} increases an importance, e.g., prioritization or weight, of k_{i,SOC} relative to k_{i,Temp} and k_{i,SOH}. Although Equation 11 includes balance factors for SOC, temperature, and SOH, balance factors and corresponding priority modifiers for any combination of operating parameters can be used to determine the overall tunable balance factor. In such equations, each balance factor, e.g., k_{i,soc}, is multiplied by a ratio of the priority modifier, e.g., p_{SOC}, for the balance factor and a sum of the priority modifiers, e.g., ps_{OC}+p_{T}+p_{SOH}, for all balance factors, e.g., k_{i,SOC}, k_{i,temp}, and kᵢ,soh, used to determine the overall tunable balance factor.

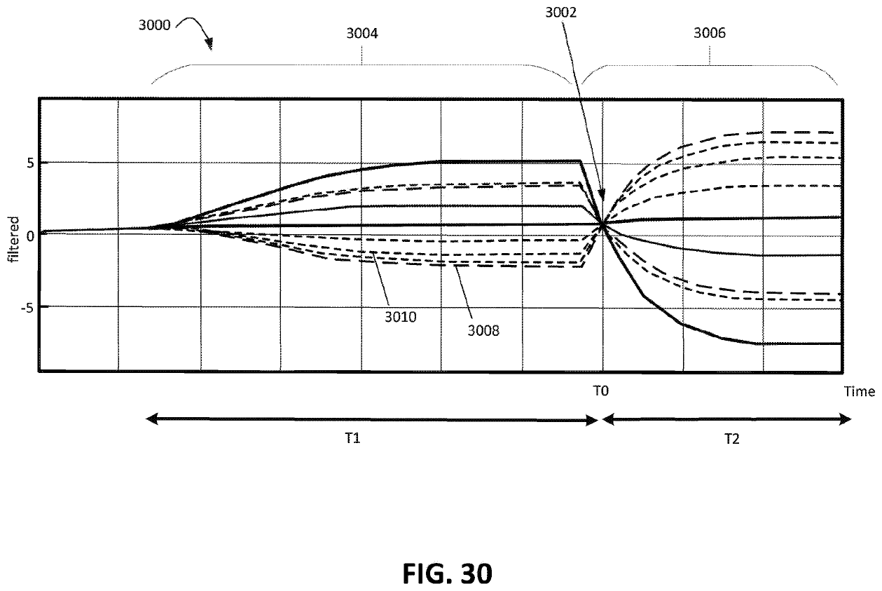

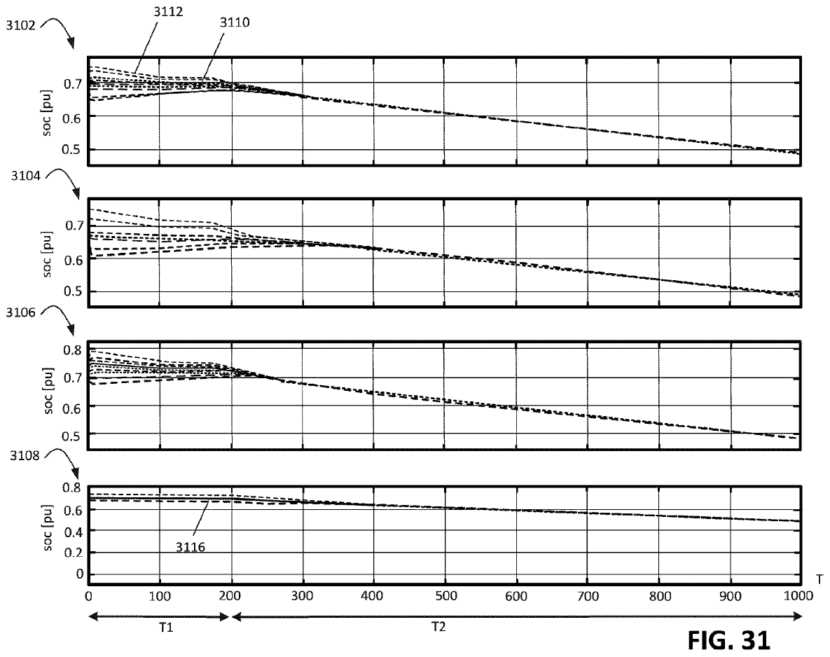

The system adjusts the tunable balance factor(s) of respective modules 108 in real-time, e.g., in response to changes in operating parameters of the modules 108 and average values of the operating parameters across the modules 108, to converge the operating parameters of modules 108 of system 100. FIGS. 30 and 31 illustrate example plots depicting behavior of a three-phase modular energy system 100 over a period of time in which variable tunable balance factors are applied to modules 108 and the corresponding SOC values of modules 108 for the respective plots of phases 3102, 3104, 3106 depicted in FIG. 31.

FIG. 30 is a plot 3000 of example of a balance factor for each respective modules 108 of system 100 over a period of time during which charging and discharging of sources 206 of system 100 takes place. Each curve depicted in plot 3000, e.g., curves 3008, 3010, represents a balance factor value for a respective module 108 over time, e.g., as the source(s) 206 of the module charge and/or discharge. An inversion point 3002 corresponds to a switch from a charging state 3004 to a discharging state 3006 at a time TO. The inversion point 3002 corresponds to a switch in respective signs of the tunable balance factors, e.g., as shown in Table 2 above. Although depicted in FIG. 30 as modules 108 switching from charging to discharging states at a same time, e.g., inversion point 3002, one or more modules 108 can be switched from charging to discharging or vice versa at different points in time, i.e., having different inflection points.

During a first period of time T1, the modules 108 are in a charging state, and the plot 3000 illustrates deviation of the balance factor for each of the respective modules 108 of system 100, e.g., as performance of modules 108 deviate from a balanced target, e.g., an average, performance. Though depicted in FIG. 30 as a transition of the system 100 from a charging state 3004 to a discharging state 3006, the system 100 can additionally or alternatively transition from a discharging state to a charging state and back to a discharging state. Although depicted in FIG. 30 as a single cycle between charging to discharging states, the evolution of balance factor values of the modules 108 depicted in plot 3000 can be applied to two or more cycles of a system 100 between charging and discharging states.

FIG. 31 illustrates plots of example SOC values for modules 108 in respective phases and an average SOC for a three-phase modular energy system 100 over a period of time. The period of time includes a first period of time T1 corresponding to a charging state of modules 108 and a second period of time T2 corresponding to a discharging state. Plots 3102, 3104, 3106 depict SOC values for modules 108 corresponding to each phase, e.g., phase A, B, and C, of a three-phase modular energy system 100, where each curve, e.g., curves 3110, 3112, in plots 3102, 3104, 3106 represents an SOC value over time for a respective module 108 in each of the phases. Plot 3108 depicts curves, e.g., curve 3114, representing average SOC values over time, SOC_{avg}, corresponding to an average SOC for modules 108 in all phases A, B, and C of a three-phase modular energy system 100. As depicted, SOC values for sources 206 in each phase A, B, and C converge during first time period T1 and second time period T2, such that deviations of SOC values for sources in each of the phases A, B, and C, respectively, decrease over time until the SOC values for modules 108 in respective phases are approximately equal. Additionally, balanced target values, e.g., average values, for SOC for each phase A, B, and C converge over time until the SOC balanced target values are approximately equal. Though depicted in FIG. 31 as a charging state transitioning to a discharging state, the system 100 can additionally or alternatively transition from a discharging state to a charging state and back to a discharging state. The methods described herein can be applied to the SOC values for respective phases A, B, and C of a three-phase modular energy system 100 to converge the SOC values to the respective phases over two or more charging and discharging cycles.

Additionally, though described in FIGS. 29-31 in terms of the of SOC operating parameter, the examples given in FIGS. 29-31 can be applied to other operating parameters, e.g., to temperature and SOH values. For example, a tunable balance factor can be applied to a module 108 to converge temperature values for the module 108 with respect to an average temperature value of the modules 108 of system 100, during charging and discharging states of the module 108.

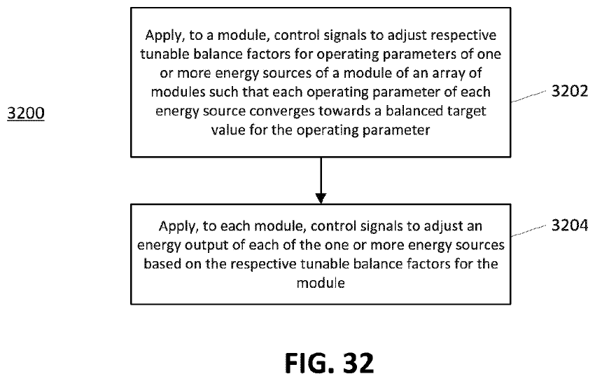

FIG. 32 is a flow diagram depicting an example method 3200 of controlling outputs of modules 108 in a system 100 using tunable balancing factors. For example, the method 3200 can be applied to any embodiment of system 100 described herein, such as for one or more arrays 700 of modules 108 in a cascaded system 100, where each module 108 includes one or more sources 206. For example, one or more operating parameters of two or more sources 206 within a module 108 can be balanced, while one or more operating parameters of those sources 206 are concurrently balanced with sources 206 of one or more other modules 108 within the same array 700. Additionally, one or more operating parameters of one or more arrays 700 of a system 100 can be balanced with respect to each other array 700. The method of FIG. 32 can be applied to balance operating parameters, e.g., SOC, temperature, voltage, current, SOH, or others, of modules 108 having multiple sources 206. The method 3200 can be performed by control system 102, e.g., by MCD 112, LCD 114, PMC 1800, and/or another portion of control system 102.

At step 3202, the control system 102 applies control signals to adjust respective tunable balance factors for operating parameters of one or modules 108 of one or more arrays 700 of modules 108 such that each operating parameter of each module 108 converges towards a balanced target value for the operating parameter. In some implementations, controlling the respective tunable balance factors for the operating parameters includes controlling respective tunable balance factors for two or more, e.g., two, three, four, or more, operating parameters.

The tunable balance factor for module 108 can be adjusted in response to a deviation of the operating parameter corresponding to the tunable balance factor from the balanced target value for the operating parameter. In some implementations, the balanced target value is an average value for the operating parameter over all modules 108 being balanced, e.g., all modules 108 of an array 700. Tunable balance factors can be controlled dependent on a charging or discharging state of the one or more energy sources 206, e.g., as described herein with reference to Table 2.

At times, the tunable balance factors can be tuned, e.g., in real-time, to adjust a rate of convergence of at least one operating parameter towards to a corresponding balanced target value, e.g., to increase a rate of convergence. The rate of convergence can be adjusted by adjusting an amplification of respective deviations of the at least one operating parameter from the balanced target value, e.g., by adjusting an amplification modifier. At times, tunable balance factors for corresponding operating parameters can be ranked, e.g., in real-time, by an importance of balancing each operating parameter of the operating parameters of the one or more energy sources 206 of the modules 108 in an array 700, for example, based on a charging/discharging state of sources 206, in response to a load powered by system 100, and/or based on a user-provided tunable adjustment parameters. The importance of balancing each operating parameter can be adjusted by adjusting a priority of respective tunable balance factors, where adjusting the importance can include adjusting a weight corresponding to the priority of the respective tunable balance factors. Weighted tunable balance factors for corresponding operating parameters can be utilized to generate a refined, e.g., overall, balance factor which can be applied to modify an energy, e.g., current, output of the energy source(s) 206 of a module 108.

At step 3204, the control system 102 applies control signals to each module to adjust an energy output for the one or more sources 206 of each module 108 being balanced based on the respective tunable balance factors for the module. In some implementations, controlling energy outputs for the one or more sources 206 of each module 108 includes balancing the modules 108 with respect to other modules 108 in an array 700, e.g., intra-array or intraphase balancing, as described herein.

Controlling energy outputs based on respective tunable balance factors can include controlling a duty cycle of switch circuitry within each module 108 and/or controlling converter circuitry of each module 108 according to a pulse width modulation technique. Controlling energy output of a module 108 based on respective tunable balance factors for the module 108 can include determining reference currents for an energy source 206 of the one or more energy sources 206 based on demand values of a load 101 and generating switching signals for switch circuitry coupled to the energy source 206 based on the reference currents. In some implementations, controlling energy outputs can include controlling energy outputs for two or more arrays 700 with respect to each other, e.g., interarray or interphase balancing, as described herein. Control system 102 can simultaneously perform any combination of intraphase balancing, interphase balancing, utilization of multiple energy sources within a module, active filtering, and auxiliary load supply.

Tunable balance factors, amplification modifiers, and/or priority modifiers can be provided to deployed electric vehicles. For example, a remote computer system, e.g., a cloud-based platform, can determine the tunable balance factors, amplification modifiers, and/or priority modifiers for electric vehicles using the techniques described herein and provide these factors and/or modifiers to the electric vehicles, e.g., using wireless communications between the remote computer system and the electric vehicles. The electric vehicles can provide the data used in determining the factors and/or modifiers to the remote computer system and receive the factors and/or modifiers from the remote computer system.

A balancing of modules having a higher SOC with modules having a lower SOC can include increasing an amount of current conducted by the modules having a higher SOC. In such cases, increasing the amount of current conducted can be done by adjusting a gain factor to adjust a modulation index for modules having a higher SOC.

FIG. 33 is a flow diagram depicting an example method 3300 of controlling outputs of modules 108 in a system 100 using tunable balancing factors. For example, the method 3200 can be applied to any implementation of system 100 described herein, such as one or more arrays 700 of modules 108 in a cascaded system 100, where each module 108 includes one or more sources 206. For example, one or more operating parameters of two or more sources 206 within a module 108 can be balanced while one or more operating parameters of those sources 206 are concurrently balanced with sources 206 of one or more other modules 108 within the same array 700. Additionally, one or more operating parameters of two or more arrays 700 of a system 100 can be balanced with respect to each other array 700. The method described with reference to FIG. 33 can be applied to balance operating parameters, e.g., SOC, temperature, voltage, current, or SOH, of modules 108 having multiple sources 206. The method 3300 can be performed by control system 102, e.g., by MCD 112, LCD 114, PMC 1800, and/or another portion of control system 102.

At step 3302, tunable adjustment factors are obtained. The tunable adjustment parameters can include an amplification modifier for each operating parameter being balanced and/or a priority modifier for each operating parameter being balanced. As described above, these tunable adjustment factors can be obtained from a user terminal, e.g., user input terminal 1806, an external control device 104, or determined by control system 102.

At step 3304, operating parameters of modules 108 are obtained. As described above, control system 102 can receive or determine the operating parameters for modules 108. For example, MCD 112 can receive operating parameters from LCDs 114.

At step 3306, balance factors are determined for modules 108. Control system 102 can determine, for each module 108, an overall tunable balance factor. For example, control system 102 can determine, as the overall tunable balance factor for each module 108, a refined tunable balance factor kif using Equation 11, above.

Control system 102 can determine a modified value of each operating parameter for each module 108 using the amplification modifier for the operating parameter. For example, control system 102 can determine the modified value SOC_{i,2} of the SOC for each module 108 using Equation 9 above. In Equation 9, the ratio

$$\frac{{σ}_{2}}{{σ}_{1}}$$

represents the amplification modifier. Control system 102 can determine the modified value of each other operating parameter using a similar equation substituting the operating parameter for SOC and using the amplification modifier for the operating parameter. The amplification modifiers for the operating parameters can be the same or different.

Control system 102 can determine, for each module 108, a tunable balance factor for each operating parameter being balanced. For example, control system 102 can use the equations of Table 2 and Equation 10 to determine the tunable balance factors for the operating parameters using the modified values of the operating parameters.

Control system 102 can determine, for each module 108, the overall tunable balance factor using the tunable balance factors for the operating parameters for the module 108. For example, control system 102 can determine the overall tunable balance factor for the module using Equation 11, the tunable balance factors for the module 108, and the priority modifiers for the operating parameters.

At step 3308, the energy outputs of modules 108 are controlled using the balance factors. Control system 102 can adjust the energy output of each module 108 using the overall tunable balance factor for the module 108. For example, control system 102 can determine the modulation index Mi for each module 108 based on the overall tunable balance factors for the module 108 as described above, e.g., with reference to FIGS. 9A-9B. The modulation indexes Mi are used along with a reference signal to control the switching signals of converters 202 of modules 108 to adjust the output energy of modules 108, as described above.

Control system 102 can perform methods 3200 or 3300 continuously or intermittently to balance operating parameters of modules 108 while the modules 108 are providing power to one or more loads 101. As the operating parameters of modules 108 change and/or the tunable adjustment factors change, control system 102 can update the balance factors and therefore the output of modules 108 to continue balancing the operating parameters based on the present values of the operating parameters and tunable adjustment factors.

### Further Control Embodiments Using Load-Sensitive Balancing

In some implementations, the rate of convergence of operating parameters to their balanced target values can be modified by adjusting an amplification modifier. Generally, an amplification modifier can be selected by control system 102 to adjust an upper limit of the modulation index Mi available to converge the operating parameter of each module 108 towards a balanced target value to avoid a saturation of the modulation index Mi where the system is destabilized in situations where the modulation index Mi of one or more modules 108 is high, e.g., where the system is already outputting a high voltage as compared to the maximum output voltage of the system.

For example, when a load 101 is requesting a large amount of power from system 100, the output power of modules 108 of system 100 may be high, e.g., above a threshold or within a threshold of a maximum output power. Increasing the modulation index Mi of a module 108 at this high output level, e.g., to balance with one or more modules 108 having a lower SOC, can result in unstable operation of the module 108 and/or over overall system 100. An example of unstable operation of the system 100 is an overmodulation of one or more phases of the system, which can lead to unbalanced phase voltages and increases in a torque ripple at the output of the system 100. As a result, the system experiences increased stress and associated losses on the overall system 100, e.g., on the control-side of the system.

As described with reference to Equation 9, ratio

$$( \frac{{σ}_{2}}{{σ}_{1}} )$$

can be utilized as an amplification modifier of a balancing function. Adjusting ratio

$$\frac{{σ}_{2}}{{σ}_{1}}$$

can adjust a difference in the values of the operating parameters relative to their balanced target values such that a speed of response, e.g., a rate of balancing or rate of convergence, can be adjusted. Additionally, or in the alternative, the rate of convergence can be modified by a second amplification modifier, e.g., an “aggression factor” γ, which can be used to adjust the rate of convergence based on the operating state of a load 101, e.g., an electric vehicle motor, coupled to system 100. As described in more detail below, the aggression factor γ can be used in addition to the amplification modifier described above, or in place of the amplification modifier.

Control system 100 can use the aggression factor γ to decrease the rate of convergence when load 101 is operating at a high level and/or to increase the rate of convergence when the load 101 is not operating at a high level. This enables balancing of the operating parameters of modules 108 of system 100 without negatively affecting operation of load 101. For example, by decreasing the aggression factor γ during high output states, the resultant modulation indexes are not increased for balancing when the outputs of modules 108 are high. By increasing the aggression factor γ during lower output states, the resultant modulation indexes Mi can be increased to increase the rate of convergence when such an increase would not negatively affect the operation of load 101.

In some implementations, control system 102 can select a first amplification modifier γ having a first value in response to determining a first operating state of load 101 and a second, different value in response to determining a second operating state of load 101. For example, control system 102 can set a first amplification modifier γ value, e.g., a low value, in response to determining a high speed/high torque operating state of a motor, e.g., the electric vehicle is accelerating or driving uphill. In other words, control system 102 can de-prioritize balancing the operating parameter, e.g., SOC, of the modules 108 in response to determining that the motor is operating in a high voltage, e.g., high power-demand, mode. In another example, control system 102 can set a second amplification modifier γ value, e.g., a high value, in response to determining a low speed/low torque operating state of the motor, e.g., the electric vehicle is cruising or coming to a stop. In other words, control system 102 can prioritize balancing the operating parameter, e.g., SOC, of the modules 108 in response to determining the motor is operating a low voltage, e.g., low power-demand mode.

FIG. 34 is a flow diagram of an example method 3400 of controlling outputs of modules 108 in a system 100 using amplification modifiers. The method 3400 can be applied to any implementation of system 100 described herein, such as for one or more arrays 700 of modules 108 in a cascaded system 100, where each module 108 includes one or more sources 206. For example, one or more operating parameters of two or more sources 206 within a module 108 can be balanced while one or more operating parameters of those sources 206 are concurrently balanced with sources 206 of one or more other modules 108 within the same array 700. Additionally, one or more operating parameters of two or more arrays 700 of a system 100 can be balanced with respect to each other array 700. The method described with reference to FIG. 34 can be applied to balance operating parameters, e.g., SOC, temperature, voltage, current, or SOH, of modules 108 having multiple sources 206.

At step 3402, data indicating an operating state (“operating state data”) of a load 101 coupled to energy system 100 is obtained. In general, operating state data for a load 101 can include any data indicative of the present operation of load 101, such as status information described above, current mode of operation, sensor data, voltage, current, and/or power setpoints, future operating modes or setpoints, and/or other data depending on the type of load 101. The operating state data can be received from an external control device 104 that controls load 101, or otherwise obtained by control system 102.

Load 101 can be a motor 101, e.g., an electric vehicle motor, that is controlled by a vehicular ECU or MCU that is communicatively coupled to control system 102, e.g., as an external control device 104 coupled to MCD 112. In such examples, this external control device 104 can provide, to MCD 112, the operating state data for the motor. The operating state data for a motor can include data representing a present speed value and/or a present torque value of the motor. The operating state data for a motor or other load 101 can include a reference voltage that represents a setpoint voltage for the motor or other load 101, reference current that represents a setpoint current for the motor or other load 101, and/or power voltage that represents a setpoint power for the motor or other load 101.

At step 3404, an aggression factor γ is determined based on the operating state data. As described below with reference to FIG. 35, control system 102 can select the aggression factor γ from a lookup table or other data structure based on the operating state data. For example, control system 102 can determine an operating state of load 101 based on the operating state data and obtain, from the lookup table, the aggression factor γ corresponding to the operating state. In other examples, control system 102 can determine the aggression factor based on a combination of the operating state data and data that represents the maximum output of system 100.

At step 3406, balance factors for modules 108 are determined using the aggression factor γ. Aggression factor γ can be calibrated for different operating states of the system 100. Feedback to the system 100, e.g., in the form of modulation index, torque, and/or speed of a motor, can be used to specify an aggression factor value reflective of the operating state of the system 100 as indicated by the feedback. In some implementations, control system 102 can use the aggression factor γ as the amplification modifier to determine the balance factors for modules 108. For example, control system 102 can determine the balance factors using Equations 9 and 11 and the equations of Table 2, e.g., as described in steps 3302-3304 of FIG. 33), where the ratio

$$( \frac{{σ}_{2}}{{σ}_{1}} )$$

in Equation 9 is replaced with the aggression factor γ. In some implementations, control system 102 can use the aggression factor γ as an additional parameter when determining the balance factors. For example, control system 102 can scale each balance factor by multiplying the balance factor by the aggression factor γ. In this example, the pre-scaled balance factor for each module 108 can be determined using any technique described herein.

As described above, adjusting the balance factors for modules 108 can adjust the rate of convergence of the operating parameters of the modules 108. In this example, the rate of convergence is adjusted based on the operating state of a load 101 using an amplification modifier γ that is based at least on the operating state of the load 101.

At step 3408, the energy outputs of modules 108 are controlled using the balance factors. Control system 102 can adjust the energy output of each module 108 using the balance factor, e.g., an overall tunable balance factor, for the module 108. For example, control system 102 can determine the modulation index Mi for each module 108 based on the balance factor(s) for the module 108 as described above, e.g., with reference to FIGS. 9A-9B. The modulation indexes Mi are used along with a reference signal to control the switching signals of converters 202 of modules 108 to adjust the output energy of modules 108, as described above.

FIG. 35 is a flow diagram of an example method 3500 for determining an aggression factor γ. An example data flow 3600 for the method 3500 is depicted in FIG. 36, and described in further below. Though described here as determining one aggression factor, e.g., for one phase and therefore one array 700 of the system 100, the method 3500 is applicable to each array 700 of a multi-phase system. In such cases, control system 102 determines an aggression factor γ value for each array 700 of the system 100, and the aggression factor γ for each array 700 can be the same or different. As described above, each aggression factor γ for an array 700 is used to determine balance factors for modules 108 in the array 700 to adjust a rate of convergence of the operating parameters of the modules 108 towards a target balanced value.

The system can use a lookup table, e.g., look up table 3602, data array, or other data structure to determine, from operating states of a load 101, values of aggression factors, to define how the system should prioritize converging the operating parameters toward respective balanced target values. The lookup table can be generated based on a calibration process to specify aggression factors corresponding to different operating states of the load 101. The lookup table can include key value pairs, where the keys are the operating states and the values are the corresponding aggression factors γ. For each operating state, the lookup table includes a corresponding aggression factor γ for use when the load 101 is determined to be in that operating state.

At step 3502, an operating state of a load 101 is determined. The operating states of a load 101 can be one of multiple operating states ranging from a lowest operating state in which the power requirements of load 101 are lowest relative to the maximum output of system 100 to a highest operating state in which the power requirements of load 101 are highest relative to the maximum output of system 100. In some implementations, control system 102 can assign load 101 to one of the operating states based at least in part on operating state data and/or data that represents the maximum output of system 100. For example, control system 100 can assign a motor to an output state based on the speed value and/or the torque value of the motor, and/or the reference voltage, and/or the DC-link voltage (V_{DCL}) of system 100.

The DC-link voltage of the system 100 can represent the maximum output of system 100. The DC-link voltage can be determined based on the voltage levels of sources 206 of modules 108 in each array 700. In a three-phase system, the DC-link voltage can be the minimum of (i) the total DC-link voltage of array 700-PA for phase A plus the total DC-link voltage of array 700-PB for phase B, (ii) the total DC-link voltage of array 700-PA for phase A plus the total DC-link voltage of array 700-PC for phase C, or (iii) the total DC-link voltage of array 700-PB for phase B plus the total DC-link voltage of array 700-PC for phase C.

In some implementations, the operating state of the motor is based on a reference voltage that represents a setpoint voltage for a motor and the DC-link voltage. This combination of data represents the target output of system 100 for powering the motor and the maximum output of system 100, which represents how much leeway there is for increasing the output of modules 108 of balancing purposes. In a particular example, control system 102 can receive the reference voltage as a direct-quadrature voltage (Vdq). Control system 102 can use this reference voltage to determine the reference signal for modules 108. Control system 102 can also use this reference voltage to determine a voltage constraint tracking (VCT) factor. As depicted in FIG. 36, an example VCT factor can be determined as a ratio of the reference voltage 3604 and the amplitude of the DC-link voltage 3606 is multiplied by the modulation index 3608 to obtain a VCT factor 3610. Control system 102 can compute the VCT factor as a ratio of the reference voltage V_{dq} and the amplitude of the DC-link voltage, V_{DCL} and multiplied by a modulation index Mi, e.g., as expressed in Equation 12:

$$VCT = ( \frac{{V}_{d q}}{{V}_{D C L}} ) Mi \qquad ( 12 )$$

In this example, a respective modulation index Mi is obtained for each phase. For example, in a three-phase system, a respective Mi_A for a phase A, Mi_B for a phase B, and Mi_C for a phase C of a system including three phases can be obtained. Control system 102 can determine the operating state of the motor based on the VCT factor, e.g., as computed using Equation 12, and a torque value for the motor, e.g., torque value 3612 of FIG. 36. A different VCT factor is calculated for each phase, e.g., VCT_A, VCT_B, and VCT_C, which is used in combination with the torque value of the motor to obtain a corresponding key in the lookup table 3602 for each phase of the system. In this example, each key in the lookup table, e.g., lookup table 3602, can include a VCT factor and a torque value or a range of VCT factors and a range of torque values.

The operating state of a motor can be defined within ranges of operation, e.g., ranges of torque values and/or ranges of speed values, where each range defines an aspect of the operating state. For example, each operating state can correspond to a respective pre-defined range of torque values and/or a pre-defined range of speed values. In this example, each key of the lookup table can include a range of torque values and a range of speed values. Control system can determine the operating state of the motor by comparing a present torque value and a present speed value of the operating state data to the respective ranges.

An operating state of the motor can be defined in part by a mode of operation, for example, constant power mode, e.g., a field weakening mode, or a constant torque mode. In this example, the keys of the lookup table can include the various modes of the motor.

A speed value and/or a torque value for a motor indicates how the motor is drawing power from the system, e.g., discharging/charging the energy sources 206 of the modules 108 of the system 100 coupled to the motor. These values can be used to select aggression factors that will adjust a rate of convergence of the operating parameter without resulting in an instability operation of the system.

At step 3504, the operating state of the load 101 is compared to keys in the lookup table. Comparing the operating state of the load 101 can include comparing data indicative of the operating state, e.g., speed value, torque value, and/or VCT factor of a motor, to the keys of the lookup table, e.g., without mapping these values to actual states. Comparing the operating state of the motor can include comparing direct or indirect measurements of the operating state of the motor, e.g., a VCT factor and/or a torque value, to the keys of the lookup table. Comparing the operating state of a load 101 can include comparing the operating state to the keys of the lookup table.

At step 3506, the key representative of the operating state of the load is selected. For example, control system can select a key that most closely matches the operating state or operating state data based on the comparison. In some implementations, corresponding keys for each phase of the phases of the system can be the same key or include two or more different keys representative of each phase of the system.

At step 3508, the aggression factor corresponding to the selected key is obtained. For example, control system 102 can extract the aggression factor, e.g., aggression factor 3614 of FIG. 36, from the lookup table and use the aggression factor to determine balance factors, e.g., balance factors 3620, as described above with reference to FIG. 34. Each phase of the system is assigned a respective aggression factor, which can be a same or different value from at least one other aggression factor for another phase of the system.

In some implementations, as depicted in FIG. 36, data flow 3600 can include an option to turn balancing on/off, e.g., using a ‘switch’ 3616, where the system 100 can selectively implement balancing of the operating parameters of the modules 108 by adjusting an input value 3618 to the switch 3616. In some implementations, the input value 3618 is a user-input or default value to selectively implement the aggression factor to adjust a balancing of the operational parameters for modules 108. The system can implement the respective aggression factors 3614 for each corresponding phase, or other factors described herein to determine the balance factors to apply to modules 108 of each phase.

FIG. 36 depicts an example data flow for determining balance factors. Though depicted as a single data flow, the data flow 3600 is applicable to determine balance factors for each phase of a system, and where each data flow for a corresponding phase will output respective balance factor(s) 3620 for the phase. The control system, e.g., control system 102, receives information related to an operating state of a load coupled to a system, e.g., load 101 coupled to system 100. The information related to the operating state includes a reference voltage (V_{dq}) 3604 and the amplitude of the DC-link voltage (V_{DCL}) 3606, as well as a torque value 3612 for the load 101. The control system receives a modulation index (Mi) 3608 for the system, where the system receives a modulation index corresponding to each phase of the system, e.g., a respective modulation index for each of a three-phase system. The control system divides the reference voltage 3604 by the amplitude of the DC-link voltage 3606 and multiplies by the modulation index 3608 to obtain the VCT voltage 3610, e.g., as described with reference to Equation 12. The system uses the VCT value 3610 and the torque value 3612 to obtain a key reference value in a look up table 3602, the key reference value corresponding to an aggression factor 3614. The system can optionally turn on/off the balancing of the modules 108 by turning on/off a switch 3616 based on an input value 3618. Balance factor(s) 3620 are calculated from the aggression factor, e.g., as described with reference to FIG. 34 above.

Various innovative aspects of the present subject matter are set forth below, in view of, and/or in supplementation to, the implementations described thus far, with the emphasis here being on the interrelation and interchangeability of the following embodiments. In other words, an emphasis is on the fact that each feature of the embodiments can be combined with each and every other feature unless explicitly stated or taught otherwise.

In many embodiments, a method of controlling currents of an energy storage system including an array of modules, where each module includes one or more energy sources, and where the methods include controlling, for each module, a tunable balance factor for an operating parameter of the one or more energy sources of the module such that each operating parameter of each energy source converges towards a balanced target value for the operating parameter, and controlling, for each module, energy outputs of each of the one or more energy sources based on the respective tunable balance factors for the module.

In some embodiments, the balanced target value for each operating parameter includes a central tendency value of the operating parameter across all energy sources of the array of modules.

In some embodiments, controlling, for each module, the tunable balance factor for the operating parameter of the one or more energy sources of the module includes controlling respective tunable balance factors for the operating parameter of the one or more energy sources of the module.

In some embodiments, controlling, for each module, the respective tunable balance factors for the operating parameter of the one or more energy sources of the module includes adjusting at least one tunable balance factor for the module in response to a deviation of the operating parameter corresponding to the at least one tunable balance factor from the balanced target value for the operating parameter.

In some embodiments, controlling, for each module, the respective tunable balance factors for the operating parameter of the one or more energy sources of the module includes adjusting a rate of convergence of the operating parameter for the one or more energy sources of each module with respect to the balanced target value of the at least one operating parameter.

In some embodiments, adjusting the rate of convergence of the operating parameter includes adjusting an amplification of respective deviations of the operating parameter from the balanced target value of the operating parameter for the one or more energy sources of each module.

In some embodiments, controlling, for each module, the respective tunable balance factors for the operating parameter of the one or more energy sources of the module includes: controlling, for each module, the respective tunable balance factors for two or more operating parameters of the one or more energy sources of the module, where controlling the tunable balance factors includes adjusting an importance of each operating parameter with respect to each other operating parameter by adjusting a priority of each tunable balance factor with respect to each other tunable balance factor.

In some embodiments, adjusting the priority of each tunable balance factor with respect to each other tunable balance factor includes adjusting a weight for each tunable balance factor based on the priority of the tunable balance factors, and applying, to each respective tunable balance factor, the weight for the tunable balance factor to generate weighted tunable balance factors.

In some embodiments, the methods further include determining, from the weighted tunable balance factors, a refined balance factor for controlling the energy output of the energy sources of the module, where controlling energy outputs of each of the one or more energy sources of the module includes controlling the energy outputs based on the refined balance factor.

In some embodiments, adjusting the importance of each operating parameter with respect to each other operating parameter includes adjusting the priority of respective tunable balance factors in real-time during normal operation of the array of modules.

In some embodiments, adjusting the importance of each operating parameter with respect to each other operating parameter includes adjusting the priority of respective tunable balance factors in response to charging or discharging states of the modules.

In some embodiments, adjusting the importance of each operating parameter with respect to each other operating parameter includes adjusting the priority of respective tunable balance factors in response to a load powered by the energy storage system.

In some embodiments, adjusting the importance of each operating parameter with respect to each other operating parameter includes adjusting the priority of respective tunable balance factors based on tunable adjustment parameters received from a user terminal.

In some embodiments, the operating parameter includes state of charge, temperature, voltage, current, and state of health, state of energy, or state of power.

In some embodiments, controlling, for each module, the respective tunable balance factors for the operating parameter of the one or more energy sources of the module further includes: generating, for the operating parameter, the respective tunable balance factor by determining, a normalized distribution for the operating parameter, generating, from the normalized distribution for the operating parameter, a modified normalized distribution for the operating parameter, and generating the tunable balance factor as a ratio between the modified normalized distribution for the operating parameter and the balanced target value of the operating parameter.

In some embodiments, the tunable normalized distribution includes a tunable amplification parameter, and where adjusting the tunable amplification parameter adjusts a rate of convergence for the operating parameter.

In some embodiments, controlling, for the module, tunable balance factors for the one or more energy sources includes: generating prioritized tunable balance factors, where the prioritized tunable balance factors include an importance of each tunable balance factor with respect to each other tunable balance factor, and applying the prioritized tunable balance factor to control respective energy outputs for the sources of the module.

In some embodiments, controlling, for the module, tunable balance factor for the operating parameter of the one or more energy sources includes adjusting a rate of convergence and/or importance of each operating parameter with respect to each other operating parameter based in part on an occurrence of one or more conditions.

In some embodiments, the occurrence of the one or more conditions includes a deviation of an operating parameter from the balanced target value for the operating exceeding a threshold deviation.

In some embodiments, the occurrence of the one or more conditions includes a first deviation of a first operating parameter from the balanced target value for first the operating parameter being larger than a second deviation of a second operating parameter from the balanced target value for the second operating parameter.

In some embodiments, the one or more conditions includes a sufficient amount of energy in the energy storage system to perform balancing operations.

In some embodiments, the array of modules is a first array of modules, and the energy storage system further includes a second array of modules, each module of the second array of modules including one or more energy sources, and where the methods further includes: controlling, for each array of the first array and the second array, respective tunable balance factors for the operating parameter of the one or more energy sources of the array such that the operating parameter of each energy source converges towards a balanced target value for the operating parameter of the first array and the second array, and controlling, for each array of the first array and the second array, energy outputs of each of the one or more energy sources based on the respective tunable balance factors for the first array and the second array.

In some embodiments, controlling, for each module, energy outputs of each of the one or more energy sources of the module based on the respective tunable balance factors for the module includes controlling a duty cycle of switch circuitry within each module.

In some embodiments, controlling, for each module, energy outputs of each energy source of the one or more energy sources based on the respective tunable balance factors for the module includes: determining reference currents for the energy source based on demand values of a load, and generating switching signals for switch circuitry coupled to the energy source based on the reference currents.

In some embodiments, controlling, for each module, energy outputs of each of the one or more energy sources based on the respective tunable balance factors for the module includes controlling converter circuitry of each module of the array of modules according to a pulse width modulation technique.

In some embodiments, the methods further include adjusting a modulation index for each module of the array of modules.

In many embodiments, an energy storage system includes a control system and an array of modules, where each module includes one or more energy sources, the control system configured to: assess, for the one or more energy sources of the array of modules, respective deviations of operating parameters from balanced target values of the operating parameters, generate, for each of the operating parameters, respective tunable balance factors, and apply, to the one or more energy sources of the array of modules, the respective tunable balance factors to converge the operating parameters to the balanced target values of the operating parameters.

In many embodiments, an electric vehicle includes a modular energy system controllable to supply power to a load of the electric vehicle, where the modular energy system is configured in accordance with any of the features recited herein.

In many embodiments, a method of controlling outputs of an energy storage system including one or more arrays of modules, where each module includes one or more energy sources, the method including: obtaining operating state data representing an operating state of a load coupled to the energy storage system, and controlling, based on the operating state data, a rate of convergence of one or more operating parameters of the one or more arrays of modules towards a respective target value for each of the one or more operating parameters, including: determining, based at least on the operating state data, an aggression factor, and controlling, for each module of the one or more arrays of modules and using the aggression factor, energy outputs of the one or more energy sources of the module to converge the one or more operating parameters toward the target value for the operating parameter.

In some embodiments, the load is a motor.

In some embodiments, obtaining the operating state data includes obtaining at least one of a present speed value or a present torque value of the motor.

In some embodiments, obtaining the operating state data includes obtaining a reference voltage from a motor controller.

In some embodiments, determining the aggression factor includes: determining a voltage constraint tracking (VCT) factor based on the reference voltage and a DC-link voltage of the energy storage system, and determining the aggression factor based on the VCT factor and a torque value for the motor.

In some embodiments, the operating state includes either a first operating state representing a constant power mode of the motor or a second operating state representing a constant torque mode of the motor.

In some embodiments, the first operating state includes a field weakening mode of the motor.

In some embodiments, the one or more operating parameters include state of charge, temperature, voltage, current, state of health, state of energy, or state of power.

In some embodiments, determining the aggression factor includes comparing the operating state data of the load to keys for operating states of the load in a lookup table, selecting a key representative of the operating state of the load, and obtaining, from the lookup table, the aggression factor corresponding to the selected key.

In some embodiments, controlling, for each module and using the aggression factor, energy outputs of the one or more energy sources of the module to converge the one or more operating parameters toward the target value for the operating parameter includes determining one or more balance factors for each module based on the aggression factor, and controlling the energy outputs of each module using the one or more balance factors for the module.

In some embodiments, controlling the energy outputs of each module using the one or more balance factors for each module includes: determining a modulation index for each module using the one or more balance factors for the module, determining a modulated reference signal for each module based on a reference signal and the modulation index for the module, and controlling switch circuitry of each module using the modulated reference signal for the module.

In some embodiments, controlling the switch circuitry of each module includes controlling the switch circuitry using the modulated reference signal and a pulse width modulation technique.

In some embodiments, the one or more operating parameters include multiple operating parameters. Determining one or more balance factors for each module based on the aggression factor includes determining, for each module, a respective balance factor for each of the multiple operating parameters and controlling the energy outputs of each module using the one or more balance factors for the module includes controlling the energy outputs of each module using the balance factors for the module.

In some embodiments, determining the one or more balance factors for each module based on the aggression factor includes determining an overall tunable balance factor for each module using the one or more balance factors for the module, and controlling the energy outputs of each module using the one or more balance factors for the module comprises controlling the energy outputs of each module using the overall tunable balance factor for the module.

In some embodiments, the overall tunable balance factor for each module is based on the one or more balance factors for the module and one or more tunable adjustment parameters.

In some embodiments, the one or more tunable adjustment parameters include an amplification modifier for each operating parameter, a priority modifier for each operating parameter, or both.

In some embodiments, controlling, based on the operating state data, a rate of convergence of one or more operating parameters of the modules towards a respective balanced target value for each of the one or more operating parameters includes converging each of the one or more operating parameters of the modules toward a same value for the operating parameter.

In some embodiments, the target value for each operating parameter includes a central tendency value of a present state of the operating parameter for each module of the one or more arrays of modules.

In some embodiments, the one or more arrays of modules include a first array of modules and a second array of modules, each module of the second array of modules including one or more energy sources, and the method further includes: controlling, for each array of the first array and the second array, a rate of convergence of the operating parameter of the one or more modules of the array such that the operating parameter of each module converges towards a respective balanced target value for the operating parameter of the first array and the second array, and controlling, for each array of the first array and the second array, energy outputs of each of the one or more energy sources based on the rate of convergence for the first array and the second array.

In some embodiments, controlling, for each module of the one or more arrays of modules and using the aggression factor, energy outputs of the one or more energy sources of the module to converge the one or more operating parameters toward the balanced target value for the operating parameter includes controlling a duty cycle of switch circuitry within each module.

In some embodiments, controlling, for each module, energy outputs of each of the one or more energy sources includes controlling converter circuitry of each module of the array of modules according to a pulse width modulation technique.

In some embodiments, the method further includes adjusting a modulation index for each module of the array of modules.

In many embodiments, an energy storage system includes a control system and one or more arrays of modules, where each module comprises one or more energy sources, the control system configured to: obtain operating state data representing an operating state of a load coupled to the energy storage system, and control, based on the operating state data, a rate of convergence of one or more operating parameters of the one or more arrays of modules towards a respective balanced target value for each of the one or more operating parameters, including: determining, based at least on the operating state data, an aggression factor, and controlling, for each module of the one or more arrays of modules and using the aggression factor, energy outputs of the one or more energy sources of the module to converge the one or more operating parameters toward the balanced target value for the operating parameter.

In many embodiments, an energy storage system includes one or more arrays of modules, where each module includes one or more energy sources, and a control system configured to perform the operations of any of the features recited herein.

In the aforementioned embodiments, the control system can include processing circuitry and non-transitory memory on which is stored a plurality of instructions that, when executed by the processing circuitry, cause the control system to perform its functions.

A module can be configured to work in conjunction with other modules of similar size, function, and physical arrangement, e.g., location of electrical terminals, connectors, etc., Modules having the same function and energy source(s) can be configured identical, e.g., size and physical arrangement, to all other modules within the same system, e.g., rack or pack), while modules having different functions or energy source(s) may vary in size and physical arrangement. While each module may be physically removable and replaceable with respect to the other modules of the system, e.g., like wheels on a car, or blades in an information technology (IT) blade server, such is not required. For example, a system may be packaged in a common housing that does not permit removal and replacement any one module, without disassembly of the system as a whole. However, any and all embodiments herein can be configured such that each module is removable and replaceable with respect to the other modules in a convenient fashion, such as without disassembly of the system.

The term “output” is used herein in a broad sense, and does not preclude functioning in a bidirectional manner as both an output and an input. Similarly, the term “input” is used herein in a broad sense, and does not preclude functioning in a bidirectional manner as both an input and an output.

The terms “terminal” and “port” are used herein in a broad sense, can be either unidirectional or bidirectional, can be an input or an output, and do not require a specific physical or mechanical structure, such as a female or male configuration.

The term “nominal voltage” is a commonly used metric to describe a battery cell, and is provided by the manufacturer, e.g., by marking on the cell or in a datasheet. Nominal voltage often refers to the average voltage a battery cell outputs when charged, and can be used to describe the voltage of entities incorporating battery cells, such as battery modules and subsystems and systems of the present subject matter.

The term “C rate” is a commonly used metric to describe the discharge current divided by the theoretical current draw under which the battery would deliver its nominal rated capacity in one hour.

Different reference number notations are used herein. These notations are used to facilitate the description of the present subject matter and do not limit the scope of that subject matter. Some figures show multiple instances of the same or similar elements. Those elements may be appended with a number or a letter in a “−X” format, e.g., 123-1, 123-2, or 123-PA. This −X format does not imply that the elements must be configured identically in each instance, but is rather used to facilitate differentiation when referencing the elements in the figures. Reference to a genus number without the −X appendix, e.g., 123, broadly refers to all instances of the element within the genus.

Processing circuitry can include one or more processors, microprocessors, controllers, and/or microcontrollers, each of which can be or can be part of a discrete or stand-alone chip or distributed amongst, and a portion of, a number of different chips. Any type of processing circuitry can be implemented, such as, but not limited to, personal computing architectures, e.g., such as used in desktop PCs, laptops, tablets, etc., field programmable gate array (FPGA) architectures, proprietary architectures, custom architectures, and others. Processing circuitry can be an application specific integrated circuit (ASIC), an application specific standard part (ASSP), or all or a part of a system-on-ship (SoC). Processing circuitry can include a digital signal processor, which can be implemented in hardware and/or software. Processing circuitry can execute software instructions stored on memory that cause processing circuitry to take a host of different actions and control other components.

Processing circuitry can also perform other software and/or hardware routines. For example, processing circuitry can interface with communication circuitry and perform analog-to-digital conversions, encoding and decoding, other digital signal processing, multimedia functions, conversion of data into a format, e.g., in-phase and quadrature, suitable for provision to communication circuitry, and/or can cause communication circuitry to transmit the data (wired or wirelessly.

Any and all communication signals described herein can be communicated wirelessly except where noted or logically implausible. Communication circuitry can be included for wireless communication. The communication circuitry can be implemented as one or more chips and/or components, e.g., transmitter, receiver, transceiver, and/or other communication circuitry, that perform wireless communications over links under the appropriate protocol, e.g., Wi-Fi, Bluetooth, Bluetooth Low Energy, Near Field Communication (NFC), Radio Frequency Identification (RFID), proprietary protocols, and others. One or more other antennas can be included with communication circuitry as needed to operate with the various protocols and circuits. In some implementations, communication circuitry can share antenna for transmission over links. RF communication circuitry can include a transmitter and a receiver, e.g., integrated as a transceiver, and associated encoder logic.

Processing circuitry can also be adapted to execute the operating system and any software applications, and perform those other functions not related to the processing of communications transmitted and received.

Instructions to be executed by or implemented in processing circuitry for carrying out operations in accordance with the described subject matter may be written in any combination of one or more languages, including computer and programming languages. A non-exhaustive list of examples includes hardware description languages (HDLs), SystemC, C, C++, C#, Objective-C, Matlab, Simulink, System Verilog, System VHDL, Handel-C, Python, Java, JavaScript, Ruby, HTML, Smalltalk, Transact-SQL, XML, PHP, Golang (Go), “R” language, and Swift, to name a few.

Memory, storage, and/or computer readable media can be shared by one or more of the various functional units present, or can be distributed amongst two or more of them, e.g., as separate memories present within different chips. Memory can also reside in a separate chip of its own.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory. The terms “non-transitory” and “tangible” as used herein, are intended to describe memory, storage, and/or computer readable media excluding propagating electromagnetic signals, but are not intended to limit the type of memory, storage, and/or computer readable media in terms of the persistency of storage or otherwise. For example, “non-transitory” and/or “tangible” memory, storage, and/or computer readable media encompasses volatile and non-volatile media such as random access media, e.g., RAM, SRAM, DRAM, FRAM, etc.), read-only media, e.g., ROM, PROM, EPROM, EEPROM, flash, etc., and combinations thereof, e.g., hybrid RAM and ROM, NVRAM, etc., and variants thereof.

It should be noted that all features, elements, components, functions, and steps described with respect to any embodiment described herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A method of controlling currents of an energy storage system comprising an array of modules, wherein each module comprises one or more energy sources, the method comprising:
controlling, for each module, a tunable balance factor for an operating parameter of the one or more energy sources of the module such that each operating parameter of each energy source converges towards a balanced target value for the operating parameter; and
controlling, for each module, energy outputs of each of the one or more energy sources based on the respective tunable balance factor for the module.

2. The method of claim 1, wherein the balanced target value for each operating parameter comprises a central tendency value of the operating parameter across all energy sources of the array of modules.

3. The method of claim 1 or 2, wherein controlling, for each module, the tunable balance factor for the operating parameter of the one or more energy sources of the module comprises controlling respective tunable balance factors for the operating parameter of the one or more energy sources of the module.

4. The method of any one of claims 1-3, wherein controlling, for each module, the respective tunable balance factors for the operating parameter of the one or more energy sources of the module comprises adjusting at least one tunable balance factor for the module in response to a deviation of the operating parameter corresponding to the at least one tunable balance factor from the balanced target value for the operating parameter.

5. The method of any one of claims 1-4, wherein controlling, for each module, the respective tunable balance factors for the operating parameter of the one or more energy sources of the module comprises adjusting a rate of convergence of the operating parameter for the one or more energy sources of each module with respect to the balanced target value of the at least one operating parameter.

6. The method of claim 5, wherein adjusting the rate of convergence of the operating parameter comprises adjusting an amplification of respective deviations of the operating parameter from the balanced target value of the operating parameter for the one or more energy sources of each module.

7. The method of any one of claims 1-6, wherein controlling, for each module, the respective tunable balance factors for the operating parameter of the one or more energy sources of the module comprises:
controlling, for each module, the respective tunable balance factors for two or more operating parameters of the one or more energy sources of the module,
wherein controlling the tunable balance factors comprises adjusting an importance of each operating parameter with respect to each other operating parameter by adjusting a priority of each tunable balance factor with respect to each other tunable balance factor.

8. The method of claim 7, wherein adjusting the priority of each tunable balance factor with respect to each other tunable balance factor comprises:
adjusting a weight for each tunable balance factor based on the priority of the tunable balance factors; and
applying, to each respective tunable balance factor, the weight for the tunable balance factor to generate weighted tunable balance factors.

9. The method of claim 8, further comprising determining, from the weighted tunable balance factors, a refined balance factor for controlling the energy output of the energy sources of the module, wherein controlling energy outputs of each of the one or more energy sources of the module comprises controlling the energy outputs based on the refined balance factor.

10. The method of claim 7, wherein adjusting the importance of each operating parameter with respect to each other operating parameter comprises adjusting the priority of respective tunable balance factors in real-time during normal operation of the array of modules.

11. The method of claim 7, wherein adjusting the importance of each operating parameter with respect to each other operating parameter comprises adjusting the priority of respective tunable balance factors in response to charging or discharging states of the modules.

12. The method of claim 7, wherein adjusting the importance of each operating parameter with respect to each other operating parameter comprises adjusting the priority of respective tunable balance factors in response to a load powered by the energy storage system.

13. The method of claim 7, wherein adjusting the importance of each operating parameter with respect to each other operating parameter comprises adjusting the priority of respective tunable balance factors based on tunable adjustment parameters received from a user terminal.

14. The method of any one of claims 1-13, wherein the operating parameter comprises state of charge, temperature, voltage, current, and state of health, state of energy, or state of power.

15. The method of any one of claims 1-14, wherein controlling, for each module, the respective tunable balance factors for the operating parameter of the one or more energy sources of the module further comprises:
generating, for the operating parameter, the respective tunable balance factor by determining, a normalized distribution for the operating parameter;
generating, from the normalized distribution for the operating parameter, a modified normalized distribution for the operating parameter; and
generating the tunable balance factor as a ratio between the modified normalized distribution for the operating parameter and the balanced target value of the operating parameter.

16. The method of claim 15, wherein the normalized distribution comprises a tunable amplification parameter, and wherein adjusting the tunable amplification parameter adjusts a rate of convergence for the operating parameter.

17. The method of any one of claims 7-16, wherein controlling, for the module, tunable balance factors for the one or more energy sources comprises:
generating prioritized tunable balance factors, wherein the prioritized tunable balance factors include an importance of each tunable balance factor with respect to each other tunable balance factor; and
applying the prioritized tunable balance factor to control respective energy outputs for the sources of the module.

18. The method of any one of claims 7-17, wherein controlling, for the module, tunable balance factor for the operating parameter of the one or more energy sources comprises adjusting a rate of convergence and/or importance of each operating parameter with respect to each other operating parameter based in part on an occurrence of one or more conditions.

19. The method of claim 18, wherein the occurrence of the one or more conditions comprises a deviation of an operating parameter from the balanced target value for the operating exceeding a threshold deviation.

20. The method of claim 18 or 19, wherein the occurrence of the one or more conditions comprises a first deviation of a first operating parameter from the balanced target value for first the operating parameter being larger than a second deviation of a second operating parameter from the balanced target value for the second operating parameter.

21. The method of any one of claims 18-20, wherein the one or more conditions comprises a sufficient amount of energy in the energy storage system to perform balancing operations.

22. The method of any one of claims 1-21, wherein the array of modules is a first array of modules, and the energy storage system further comprises a second array of modules, each module of the second array of modules comprising one or more energy sources, and wherein the methods further comprises:
controlling, for each array of the first array and the second array,
respective tunable balance factors for the operating parameter of the one or more energy sources of the array such that the operating parameter of each energy source converges towards a balanced target value for the operating parameter of the first array and the second array; and
controlling, for each array of the first array and the second array, energy outputs of each of the one or more energy sources based on the respective tunable balance factors for the first array and the second array.

23. The method of any one of claims 1-21, wherein controlling, for each module, energy outputs of each of the one or more energy sources of the module based on the respective tunable balance factor for the module comprises controlling a duty cycle of switch circuitry within each module.

24. The method of any one of claims 1-21, wherein controlling, for each module, energy outputs of each energy source of the one or more energy sources based on the respective tunable balance factor for the module comprises:
determining reference currents for the energy source based on demand values of a load; and
generating switching signals for switch circuitry coupled to the energy source based on the reference currents.

25. The method of any one of claims 1-21, wherein controlling, for each module, energy outputs of each of the one or more energy sources based on the respective tunable balance factors for the module comprises controlling converter circuitry of each module of the array of modules according to a pulse width modulation technique.

26. The method of claim 25, further comprising adjusting a modulation index for each module of the array of modules.

27. An energy storage system comprising a control system and an array of modules, wherein each module comprises one or more energy sources, the control system configured to:
assess, for the one or more energy sources of the array of modules, respective deviations of operating parameters from balanced target values of the operating parameters;
generate, for each of the operating parameters, respective tunable balance factors; and
apply, to the one or more energy sources of the array of modules, the respective tunable balance factors to converge the operating parameters to the balanced target values of the operating parameters.

28. An electric vehicle, comprising:
a modular energy system controllable to supply power to a load of the electric vehicle, wherein the modular energy system is configured in accordance with any of claims 1-26.

29. A method of controlling outputs of an energy storage system comprising one or more arrays of modules, wherein each module comprises one or more energy sources, the method comprising:
obtaining operating state data representing an operating state of a load coupled to the energy storage system; and
controlling, based on the operating state data, a rate of convergence of one or more operating parameters of the one or more arrays of modules towards a respective target value for each of the one or more operating parameters, comprising:
determining, based at least on the operating state data, an aggression factor; and
controlling, for each module of the one or more arrays of modules and using the aggression factor, energy outputs of the one or more energy sources of the module to converge the one or more operating parameters toward the target value for the operating parameter.

30. The method of claim 29, wherein the load comprises a motor.

31. The method of claim 30, wherein obtaining the operating state data comprises obtaining at least one of a present speed value or a present torque value of the motor.

32. The method of claim 30 or 31, wherein obtaining the operating state data comprises obtaining a reference voltage from a motor controller.

33. The method of claim 32, wherein determining the aggression factor comprises:
determining a voltage constraint tracking (VCT) factor based on the reference voltage and a DC-link voltage of the energy storage system; and
determining the aggression factor based on the VCT factor and a torque value for the motor.

34. The method of any one of claims 30-33, wherein the operating state comprises either a first operating state representing a constant power mode of the motor or a second operating state representing a constant torque mode of the motor.

35. The method of claim 34, wherein the first operating state comprises a field weakening mode of the motor.

36. The method of any one of claims 29-35, wherein the one or more operating parameters comprise state of charge, temperature, voltage, current, state of health, state of energy, or state of power.

37. The method of any one of claims 29-36, wherein determining the aggression factor comprises:
comparing the operating state data of the load to keys for operating states of the load in a lookup table;
selecting a key representative of the operating state of the load; and
obtaining, from the lookup table, the aggression factor corresponding to the selected key.

38. The method of any one of claims 29-37, wherein controlling, for each module and using the aggression factor, energy outputs of the one or more energy sources of the module to converge the one or more operating parameters toward the target value for the operating parameter comprises:
determining one or more balance factors for each module based on the aggression factor; and
controlling the energy outputs of each module using the one or more balance factors for the module.

39. The method of claim 38, wherein controlling the energy outputs of each module using the one or more balance factors for each module comprises:
determining a modulation index for each module using the one or more balance factors for the module;
determining a modulated reference signal for each module based on a reference signal and the modulation index for the module; and
controlling switch circuitry of each module using the modulated reference signal for the module.

40. The method of claim 39, wherein controlling the switch circuitry of each module comprises controlling the switch circuitry using the modulated reference signal and a pulse width modulation technique.

41. The method of any one of claims 38-40, wherein:
the one or more operating parameters comprise multiple operating parameters;
determining one or more balance factors for each module based on the aggression factor comprises determining, for each module, a respective balance factor for each of the multiple operating parameters; and
controlling the energy outputs of each module using the one or more balance factors for the module comprises controlling the energy outputs of each module using the balance factors for the module.

42. The method of claim 41, wherein:
determining the one or more balance factors for each module based on the aggression factor comprises determining an overall tunable balance factor for each module using the one or more balance factors for the module; and
controlling the energy outputs of each module using the one or more balance factors for the module comprises controlling the energy outputs of each module using the overall tunable balance factor for the module.

43. The method of claim 42, wherein the overall tunable balance factor for each module is based on the one or more balance factors for the module and one or more tunable adjustment parameters.

44. The method of claim 43, wherein the one or more tunable adjustment parameters comprise an amplification modifier for each operating parameter, a priority modifier for each operating parameter, or both.

45. The method of any one of claims 29-44, wherein controlling, based on the operating state data, a rate of convergence of one or more operating parameters of the modules towards a respective balanced target value for each of the one or more operating parameters comprises converging each of the one or more operating parameters of the modules toward a same value for the operating parameter.

46. The method of claim 41, wherein the target value for each operating parameter comprises a central tendency value of a present state of the operating parameter for each module of the one or more arrays of modules.

47. The method of any one of claims 29-46, wherein the one or more arrays of modules comprise a first array of modules and a second array of modules, each module of the second array of modules comprising one or more energy sources, and
wherein the method further comprises:
controlling, for each array of the first array and the second array, a rate of convergence of the operating parameter of the one or more modules of the array such that the operating parameter of each module converges towards a respective balanced target value for the operating parameter of the first array and the second array; and
controlling, for each array of the first array and the second array, energy outputs of each of the one or more energy sources based on the rate of convergence for the first array and the second array.

48. The method of any one of claims 29-47, wherein controlling, for each module of the one or more arrays of modules and using the aggression factor, energy outputs of the one or more energy sources of the module to converge the one or more operating parameters toward the balanced target value for the operating parameter comprises controlling a duty cycle of switch circuitry within each module.

49. The method of any one of claims 29-48, wherein controlling, for each module, energy outputs of each of the one or more energy sources comprises controlling converter circuitry of each module of the array of modules according to a pulse width modulation technique.

50. The method of claim 49, further comprising adjusting a modulation index for each module of the array of modules.

51. An energy storage system comprising a control system and one or more arrays of modules, wherein each module comprises one or more energy sources, the control system configured to:
obtain operating state data representing an operating state of a load coupled to the energy storage system; and
control, based on the operating state data, a rate of convergence of one or more operating parameters of the one or more arrays of modules towards a respective balanced target value for each of the one or more operating parameters, comprising:
determining, based at least on the operating state data, an aggression factor; and
controlling, for each module of the one or more arrays of modules and using the aggression factor, energy outputs of the one or more energy sources of the module to converge the one or more operating parameters toward the balanced target value for the operating parameter.

52. An electric vehicle, comprising:
a modular energy system controllable to supply power to a load of the electric vehicle, wherein the modular energy system is configured in accordance with any of claims 29-51.

53. An energy storage system, comprising:
one or more arrays of modules, wherein each module comprises one or more energy sources; and
a control system configured to perform the operations of any of claims 29-51.
